(19) United States
(12) Patent Application Publication
(10) Pub. No.: US 2005/0216294 A1
(43) Pub. Date: Sep. 29, 2005

(54) Cargo tracking system and method

(76) Inventor: Paul David Eyre Labow, Philadelphia, PA (US)

Correspondence Address: Thomas J. McWilliams;REED SMITH LLP, 2500 One Liberty Place, 1650 Market Street, Philadelphia, PA, 19103-7301, US

(21) Appl. No.: 11/019,968

(22) Filed: Dec. 22, 2004

Related U.S. Application Data
(60) Provisional application No. 60/582,585, filed on Dec. 22, 2003.

(51) Int. Cl. G06F 17/60

(52) U.S. Cl. 705/1

(57) ABSTRACT

A system of tracking a flow of goods through commerce, and a method of managing a goods tracking system. Computer software is associated with a computer-readable medium that provides a graphical user interface. Also included is at least one database, wherein at least one information item associated with at least one of the goods is relationally present in the at least one database. Further, at least one computerized device is capable of entering and accessing the at least one information item in the at least one database via the graphical user interface over a communicatively connected network in real time. The communicative connected network may also includes at least one wireless connection.

### RELATED APPLICATION

This application claims priority of U.S. Patent Application Ser. No. 60/582,585, filed Dec. 22, 2003, the entire disclosure of which is incorporated by reference herein as if being set forth in its entirety.

### FIELD OF THE INVENTION

This invention relates to a networked software platform, and, more specifically, to a system and method for creating, storing and managing tracking of goods and/or equipment to and from a variety of locations.

### BACKGROUND OF THE INVENTION

Today's business environment, particularly the movement of items in commerce, demands not only high levels of efficiency and cost effectiveness, but of management and execution as well. The process of moving items from one location to a final destination often involves a complex interaction of many components, particularly when the items for transport are very large, in great quantity, or both. Inefficiencies in such a transport and tracking system can lead to higher costs, delays in delivery, loss of goods, and the loss of clientele and business associates.

For example, if a container full of goods arrives by ship into a terminal and must be further transported by an outgoing truck, a record must be kept of the status and condition of that container during all phases of its transport. If the record is lost, or a portion of it is lost, or if it passes through too many hands and information is incorrectly entered or edited, the result could be very costly to the shipper or receiver of the goods. If such a container in transit was damaged, lost, shipped to the wrong location, or the goods were damaged or lost, the record would not be able to help prevent or explain what happened. Additionally, transport of such a container requires the interaction of many people and many types of heavy machinery and highly technical equipment. Management of all these components requires the ability to record data from workers and equipment in various locations of the terminal, and, on occasion, over large distances and many terminals. A common complaint from managers is that records can easily become lost or damaged while being dragged throughout a terminal, and the collected data can be incorrectly entered into a computerized system or final record for clients when brought back to the office.

Thus, there is a need for a system and method that provides an integrated solution for managing the tracking of materials to and from locations in commerce in an efficient and cost effective manner. The present invention provides an integrated software application capable of use through a wired or wireless network that assists managers and administrators in data gathering, as well as conceptualizing, organizing, realizing, and monitoring the flow of materials to and from different locations in commerce.

### SUMMARY OF THE INVENTION

The present invention includes a system of tracking a flow of goods through commerce. Computer software is associated with a computer-readable medium that provides a graphical user interface. Also included is at least one database, with at least one information item associated with at least one of the goods is relationally present in the at least one database. Further, at least one computerized device is capable of entering and accessing the at least one information item in the at least one database via the graphical user interface over a communicatively connected network in real time. The communicative connected network also includes at least one wireless connection.

The present invention additionally includes a method of managing a goods tracking system. The method includes providing a graphical user interface via a computer software associated with a computer-readable medium, associating at least one database with the graphical user interface, wherein at least one information item associated with at least one of the goods is relationally present in the at least one database, and communicatively connecting, in real time and via a network comprising at least one wireless connection, at least one computerized device capable of entering and accessing the at least one information item in said at least one database to the graphical user interface.

Thereby, the present invention provides an integrated software application capable of use through a wired or wireless network that assists managers and administrators in data gathering, as well as conceptualizing, organizing, realizing, and monitoring the flow of materials to and from different locations in commerce.

### BRIEF DESCRIPTION OF THE DRAWINGS

FIG. 1 is a block diagram illustrating flow in a cargo flow schema.

FIG. 2 is a block diagram more specifically illustrating an exemplary embodiment of the flow scheme and method of FIG. 1.

FIG. 3 is a block diagram of a methodology of improved cargo handling.

FIG. 4 is an embodiment of a display of the present invention.

FIG. 5 is an embodiment of a display of the present invention.

FIG. 6 is an embodiment of a display of the present invention.

FIG. 7 is an embodiment of a display of the present invention.

FIG. 8 is an embodiment of a display of the present invention.

FIG. 9 is an embodiment of a display of the present invention.

FIG. 10 is an embodiment of a display of the present invention.

FIG. 11 is an embodiment of a display of the present invention.

FIG. 12 is an embodiment of a display of the present invention.

FIG. 13 is an embodiment of a display of the present invention.

FIG. 14 is an embodiment of a display of the present invention.

FIG. 15 is an embodiment of a display of the present invention.

FIG. 16 is an embodiment of a display of the present invention.

FIG. 17 is an embodiment of a display of the present invention.

FIG. 18 is an embodiment of a display of the present invention.

FIG. 19 is an embodiment of a display of the present invention.

FIG. 20 is an embodiment of a display of the present invention.

FIG. 21 is an embodiment of a display of the present invention.

FIG. 22 is an embodiment of a display of the present invention.

FIG. 23 is an embodiment of a display of the present invention.

FIG. 24 is an embodiment of a display of the present invention.

FIG. 25 is an embodiment of a display of the present invention.

FIG. 26 is an embodiment of a display of the present invention.

FIG. 27 is an embodiment of a display of the present invention.

FIG. 28 is an embodiment of a display of the present invention.

FIG. 29 is an embodiment of a display of the present invention.

FIG. 30 is an embodiment of a display of the present invention.

FIG. 31 is an embodiment of a display of the present invention.

FIG. 32 is an embodiment of a display of the present invention.

FIG. 33 is an embodiment of a display of the present invention.

FIG. 34 is an embodiment of a display of the present invention.

FIG. 35 is an embodiment of a display of the present invention.

FIG. 36 is an embodiment of a display of the present invention.

FIG. 37 is an embodiment of a display of the present invention.

FIG. 38 is an embodiment of a display of the present invention.

FIG. 39 is an embodiment of a display of the present invention.

FIG. 40 is an embodiment of a display of the present invention.

FIG. 41 is an embodiment of a display of the present invention.

FIG. 42 is an embodiment of a display of the present invention.

FIG. 43 is an embodiment of a display of the present invention.

FIG. 44 is an embodiment of a display of the present invention.

FIG. 45 is an embodiment of a display of the present invention.

FIG. 46 is an embodiment of a display of the present invention.

FIG. 47 is an embodiment of a display of the present invention.

FIG. 48 is an embodiment of a display of the present invention.

FIG. 49 is an embodiment of a display of the present invention.

FIG. 50 is an embodiment of a display of the present invention.

FIG. 51 is an embodiment of a display of the present invention.

FIG. 52 is an embodiment of a display of the present invention.

FIG. 53 is an embodiment of a display of the present invention.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in a typical computerized system and method. Those of ordinary skill in the art will recognize that other elements are desirable and/or required in order to implement the present invention. However, because such elements are well known in the art, and because they do not facilitate a better understanding of the present invention, a discussion of such elements is not provided herein. The disclosure hereinbelow is directed to all such variations and modifications to applicable technologies known, and as will be apparent, to those skilled in the art.

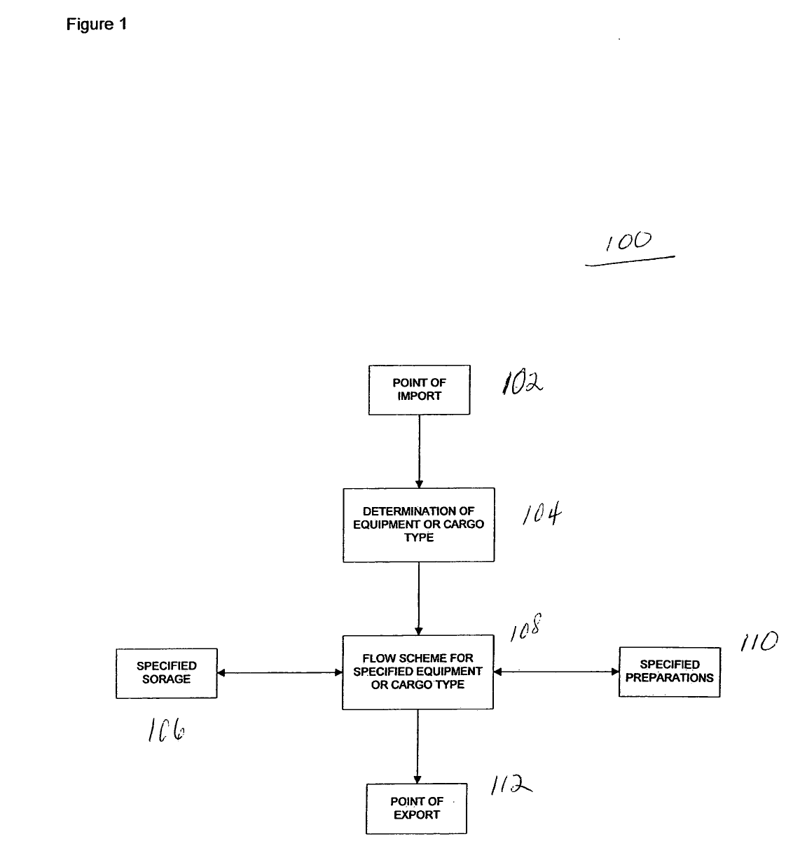

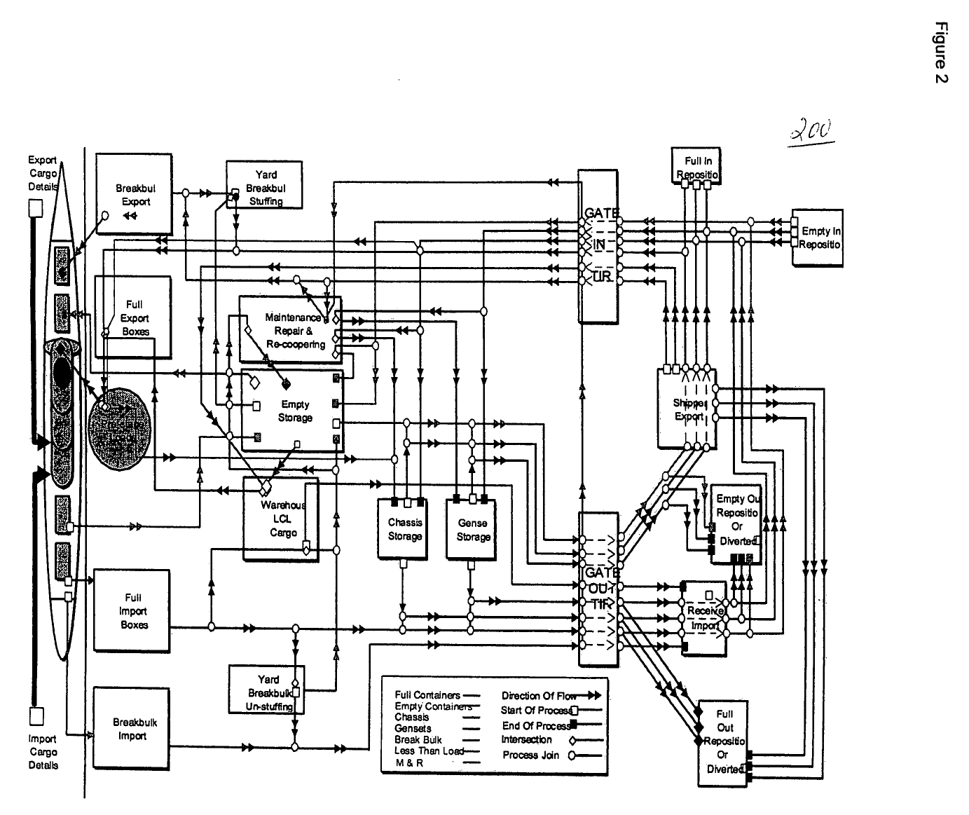

FIG. 1 is a block diagram illustrating equipment and cargo flow in a cargo flow schema. As illustrated, the cargo flow schema preferably has a direction of flow, and that direction of flow may be applicable to, for example, full containers, partially full containers, empty containers, or containers containing different types of cargo. Cargo, as used herein, may be any sort of freight, container, equipment, item, or thing, including, but not limited to, living things, such as people or other animal or plant types. Further, each of these terms may be used interchangeably, such that any term descriptive of cargo may also by itself represent cargo as used herein. For example, particular flow may be necessary for hazardous containers, fragile containers, or containers requiring a more rapid delivery. Cargo may enter the scheme, such as from a cargo dock or cargo bay, may flow through the scheme, and may exit the scheme, or may be stored in inventory within the flow scheme. Thus, the flow scheme may include an importer, an exporter, a preparer, and a storer. Further, containers already stored within the scheme may be accessed and exit, via export, from the flow scheme, such as via cargo shipping, without having been imported to the flow scheme.

FIG. 2 is a block diagram more specifically illustrating an exemplary embodiment of the cargo flow scheme and method of FIG. 1. FIG. 2 illustrates the importation and exportation of cargo details from a shipping point, such as an arriving cargo vessel. Imported containers and cargo may be removed, for example, from an arriving cargo vessel and may flow to other areas in the cargo flow scheme, such as to storage areas or gate-out, or export, areas. Full containers, or containers including specific types of material, may move differently through the flow scheme. For example, empty containers may move to storage locations, and broken equipment, or containers, may move to maintenance or repair areas. Additionally, different types of cargo may move to different storage or staging areas, depending upon the type of cargo being imported. In an outbound flow scheme, cargo may be received via a gate-in, or maybe retrieved from storage, such as for loading and export to the cargo vessel.

For example, for cargo for export, cargo may be taken in from external to the scheme, such as through the gate-in, and may pass through certain stages of the flow process, such as proceeding to empty storage, being filled from storage, and/or passing through maintenance repair, product assembly, or product breakdown. Full boxes, or full containers, or completed equipment, or goods for export, may then proceed to export, such as to an export location, or a pre-staging area whereat loads are prepared for placement on an export mechanism, such as a cargo ship.

The gate-in and gate-out locations may connect the flow scheme with external import and export, to allow for entry of goods, equipment, or the like into the inventory system. External entities may thus be exporters, or importers.

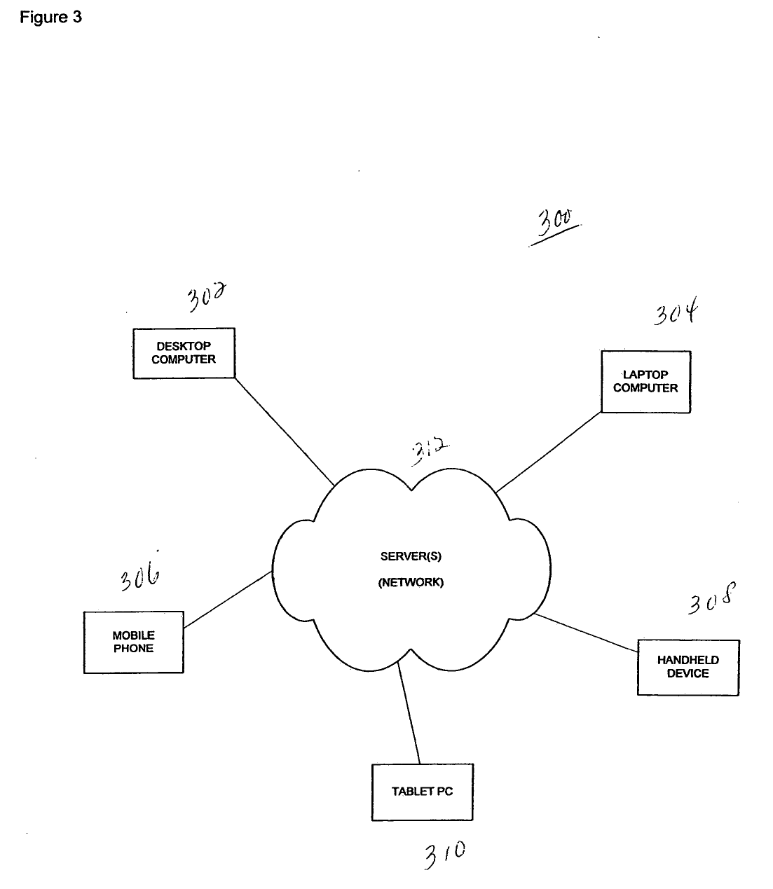

Within the system of FIGS. 1 and 2, the present invention may provide a methodology of improved cargo handling, as illustrated in FIG. 3. For example, a cargo deliverer, or remover, may provide information to the system of the present invention on the specific cargo that is coming into, or out of, the system, and from what point, or to what point, the cargo is traveling. For example, a steamship may arrive, and, upon docking, have entered information relating to the cargo of the steamship as it is delivered to the dock. The information, in this exemplary embodiment, may be inbound from a shipping point, but those skilled in the art will realize that the flow of the present invention will be similar in an outbound embodiment. Upon receiving of inbound cargo, at any point in the system, the information regarding that specific cargo may be uploaded to the system of the present invention, such as via a batch upload to the system, with or without application software at the upload point, or, more preferably, via a real-time upload to the system, such as from a hand-held device having thereon resident the information related to the specific cargo.

In an exemplary embodiment, wireless communication units, such as handheld units, PDA's, laptop computers, cellular phones, and the like, may communicate, such as via a wireless hub, with one or more servers or networks having resident thereon, or having in communication therewith, one or more relational databases in which information regarding cargo is maintained. Those databases may include, for example, MYSQL, or like databases that perform tabular database tracking. Therefore, in preferred embodiments of the present invention, a real-time thin client may be provided, whereby cargo is tracked at each point in a cargo system, in real-time, and such as by wireless uploads to the database system.

For example, when a retriever endeavors to retrieve a cargo item from the system of the present invention, the system will have previously validated, based on the unique information associated with that cargo, and at each point throughout the system, that the next action to be taken is the correct action with regard to that cargo. Thus, the system authorizes the proper time for retrieving, and insures retrieving by the correct retriever. Thereby, all actions taken are tracked in accordance with each particular cargo item, in real time, and correct next actions, and correct and incorrect previous actions, are maintained.

For example, each cargo item may have resident thereon a unique identifier, and each cargo item may receive, or additionally receive, a unique code for use within the tracking system of the present invention, and corresponded in the present invention to the existing unique identifier. This code may include, for example, a unique RF tag, a unique barcode sticker, or, in the case of a person, a picture ID, a hand scan, a retina scan, or other human architectural reader, that is physically associated with that cargo item, and which is associated within the database of the present invention, such as at the network server location, with any other unique identifiers, and associated information, of the cargo item. For example, certain items, such as lumber, may have printed out therefore and placed thereon barcodes or RF tags, and likewise heavy machinery may have placed thereon identifiers such, as barcodes or RF tags. Within the database system, such as at the network server location, the code of that unique barcode will have associated therewith relevant information and tracking of that item.

The identifier assigned to the item is preferably unique throughout the presence of that item within the system; however, to the extent the item departs from the system and returns at a later time, a new identifier preferably will be assigned to that item. Thus, any item, regardless of any preexisting form of identification, may be given a new unique identifier when entering the system. For example, via a barcode, an auto-incremented electronic code may be assigned to an incoming item. That item may maintain association with that code until it is shipped from an exit gate. If the item returns to the system, a new electronic code may be assigned, such as on a new barcode, to the item. However, the present invention may automatically search records, and to the extent a unique identifier, such as a machine license number, may be located and matched with the new item, information previously resident within the system may be auto-filled to the database in association with the new electronic code.

For example, tracking may include items received from, sent to, or activity occurring between, entrance and exit gates, such as within a stockyard and/or warehouse, wherein tracking may include inspections, movements, or placement in particular locations, such as storage. Identifiers, such as barcode stickers or adhesive RF tags, may be formed, or printed, at any point throughout the system as necessary by a device associated with the wireless network, such as upon instruction from a handheld device into which is entered the identifying information to be associated with a particular bar code or RF tag. When the item being tracked is a person, a pass may be printed, containing unique identification information for the person to present to personnel or other users when moving within the system. In another example, a handheld device may communicate wirelessly, such as via radio frequency, with a wireless hub, wherein the wireless hub sends the print request for a barcode through a network to a printer, which printer is instructed to print via its IR port. A barcode label thus printed may be placed upon the cargo item. Thereby, information may be entered, or associated, by the use of the handheld device. Into the handheld may be entered, for example, information, tracking notes, names, times, or the like. Additionally, as in the case of people or other cargo where photographic information may be useful, photographic information may also be formed or printed by a device associated with the network associated with the unique identifier. Thus, a pass may be printed out or emailed throughout the system and contain particular information relating to destination, length of stay, and the like. Such information may then act as a verifier or alert to its current position within the system.

Thus, the present invention may allow receipt of a package, for example, at an entry gate, the generation of a barcode for the package and placement of the barcode thereon, the association of the package with, for example, a pallet ID, wherein the item then passes through a warehouse, such as via conveyor, over, for example, a weigh station whereat the item is automatically weighed, and wherefrom the weight information is automatically associated with the item via a scanning of the barcode within the database. Thus, any entity with accessibility, such as via a network, to the server at which the tracking database is located, may, with authorization to do so, access all information and tracking in real time simply by entering identifying information, or by scanning the barcode, of the desired item.

In an exemplary embodiment, thereby a unit may be tracked within or associated with multiple remote locations, as long as each location is connected via the network to the server including the database having the information related to the item therein. Thus, a vessel may be loaded from a warehouse in Brazil, and may be unloaded to a stockyard in the United States, and, although the units employed in each system, and the language associated with tracking, may be different in each system, the present invention may universally translate both units and language for use by all parties, and may give both the shipper, and the receiver, the ability to view all information and tracking related to that item, from both locations. Thereby, the present invention may provide shipping conversions and all related shipping information 24 hours, seven days per week.

In an embodiment, mobile devices at remote locations for tracking items through the cargo system may be of multiple types, as discussed above. However, the system may assess what type of connection has been made, such as by a laptop, personal digital assistant, or PC, and may vary the display accordingly, such as for ease of entry of information. Further, particular remote devices may use embedded language, such as that used for instructions to a printer. Thereby, instructions in accordance with that embedded language may pass from the remote unit via the network to a server location, or to a recipient of the instruction, such as a printer. This connection to a network may be made, as discussed herein throughout, by a wireless hub connection, but may also be made, for example, by infrared, wireless modem, or the like. Further, different connections may be established in accordance with a breakdown in the preferred connection type, such as connection via wireless modem in the event a land telephone line or internet connection or intranet is unavailable.

Numerous reports may be available via the present invention, as virtually any and every aspect or event relating to a particular cargo item or container may be documented and accessed throughout the shipping system. For example, because validation of next action and current action is available throughout the system, reports may include errors, or the like. Of course, real-time aspects of the present invention may allow curing of errors before those errors become permanent. Further, in a preferred embodiment of the present invention, multiple parties may not enter information, or particularly conflicting information, regarding the same record at the same time. Nonetheless, reports may make available parties and times of party access to the present invention. In a preferred embodiment, reports may be created via a report requester, which may allow a user to choose specific fields for inclusion in the report. This may be done by dragging and dropping preferred fields into a particular column, thereby allowing reordering of the fields in a preferred order, and issuance of a report including only those fields desired. Reports may also be added to or edited, in real-time, by addition or subtraction of fields at a later time if necessary. Thereby, convenience is increased and time is saved by allowing the requestor to view reports regarding only what the requestor actually needs to see. Reports may be downloaded or exported to a desktop, or to any location or any device that can accept available report formats, such as ASCII, text format or database format, and integrated into legacy systems. Further, reports may not be downloaded, but rather may be maintained at the server, for viewing by a thin client.

Additionally, photographs may be included with a report for printing. Such photographs may be preexisting, taken upon entry of an item into the system, or, at any point in the system, photographs may be taken and entered in real-time into the system and associated or integrated with any records for a particular cargo item or container.

The present invention may also incorporate into reports relevant information collected from outside the system. For example, information associated with the VIN number of a car can provide addition information about the car via an internet link. The more information integrated into a cargo item's reports, the higher the accuracy of assessing when and where damage may have occurred, and to who any liability may be attached.

In another embodiment of the present invention, a “flag system” identifying problems or inconsistencies associated with a particular cargo item may be employed. This may be thought of as a “sanity check”, which not only may identify errors within the system, but also may function as a house-keeping function, assessing the health and organizational quality of the applicable shipping system and cargo flow management. For example, if a cargo item has been sitting with a mechanic for three weeks, or if two reports associated with a particular item conflict as to the location of that item at a given time point, or even if an item is reported to have “moved” from one checkpoint to another at an impossible rate (such as a container traveling from the dock to the gate in less than two minutes), a warning or alert may be generated for that item. Alerts may take the form of pop-up windows for applicable desktop or handheld devices, or the sending of an email alert to designated users or personnel. For such a system to exist, a set of rules may be created to represent each “flag” to be triggered. Any number of rule sets may be generated, and may be specific to site location or to subsets of units within the flow of the shipping system. While it is recommended to not allow flags to be created by any users, such a system may be designed to allow only selected or authorized users to edit or update any rules employed.

The system may also include a password feature for entry into the system, which may provide additional security and help avoid unauthorized tampering of information within the system database. Passwords may be given to users upon successful training, and may be given to users without restriction, or may be given to users on a temporary basis. For example, a password generator may create a password for a user, and set the password to expire at the change of the calendar day. Instructions on where or how to receive additional password privileges may also be given by the password generator. Password usage may be structured according to any system, as will be understood by those skilled in the pertinent arts. It may also be possible to track authorized user usage, viewing what pages within the system were opened and/or edited by a particular user, and at what time such actions were taken.

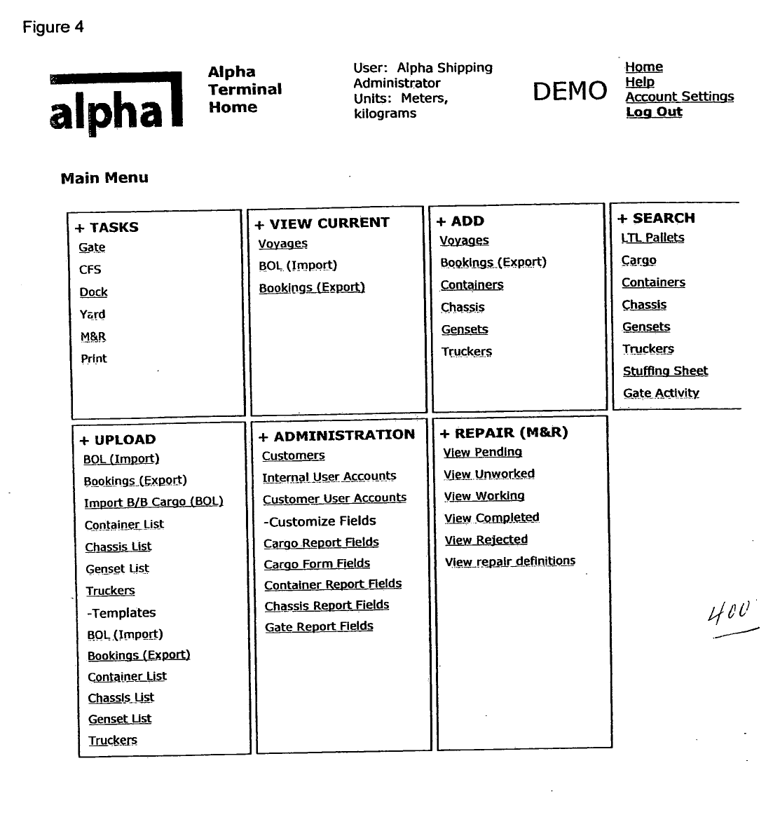

In an exemplary embodiment of the present invention, a user may be assigned a role, and each role may have associated therewith one or more permissions. Further, each user role may be further subdivided, as may be each permission. For example, a user may be an administrator, such as a terminal administrator or a line administrator. Such a user may connect to and enter the networked system via a computerized device, such as a PC, laptop, or any wireless handheld, and by reaching the “Main Menu” request screen, as illustrated in FIG. 4. The Main Menu may be used as the “home page” screen, and may also be accessible from every screen throughout the system by selecting “Home”.

From the Main Menu, the user may locate and access web pages throughout the system organized under general headings, such as Tasks, View Current, Add, Search, Upload, Administration, and Repair (M&R).

For example, under the Tasks heading, the user may reach screens by selecting a particular task, such as Gate, CFS (Container Freight Station), Dock, Yard, M&R (Maintenance and Repair), and Print.

For example, under the View Current heading, the user may reach screens by selecting a particular voyage category, such as Voyages, BOL (Import) (Bill of Lading), or Bookings (Export).

For example, under the Add heading, the user may reach screens by selecting a particular category to add, such as Voyages, Bookings (Export), Containers, Chassis, Gensets (Generator Sets), and Truckers.

For example, under the Search heading, the user may reach screens by selecting a particular category to search, such as LTL pallets (Less Than Load), Cargo, Containers, Chassis, Gensets, Truckers, Stuffing Sheet, and Gate Activity.

For example, under the Upload heading, the user may reach screens by selecting a particular category to upload, such as BOL (Import), Bookings (Export), Import B/B Cargo (Break-Bulk), Container List, Chassis List, Genset List, and Truckers. The user may also upload various templates, such as BOL (Import), Bookings (Export), Container List, Chassis List, Genset List, and Truckers.

For example, under the Administration heading, the user may reach screens by selecting a particular category of administration, such as Customers, Internal User Accounts, and Customer User Accounts. The user may also Customize Fields by selecting a particular Field, such as Cargo Report Fields, Cargo Form Fields, Container Report Fields, Chassis Report Fields, and Gate Report Fields.

For example, under the Repair (M&R) heading, the user may reach screens by selecting a particular category of repair, such as View Pending, View Unworked, View Working, View Completed, and View Rejected. The user may also check the repair definitions on the system by selecting “View Repair Definitions” under the Repair (M&R) heading.

Once the user has entered the system, the user may select from any screen throughout the system basic information, such as Home, Help, Account Settings, and Log Out, for assistance while utilizing the system. For example, the user may select “Home” to return to the Main Menu screen from any screen throughout the system. Also, the user may select “Help” to view information related to the functions of the system, as well as definitions of any terminology utilized throughout the system. The user may also select “Account Settings” to display and edit the current user's identification and system preferences. When the user has decided to leave the system, the user may select “Log Out”, to securely exit the system. The user may then be required to re-enter his or her particular log in information for re-gaining access to the system.

In an exemplary embodiment of the present invention, a gating function may control the entry and exit of cargo items or containers for the system. For example, when a cargo item is brought into the shipping yard for export, the cargo item must be uniquely identified and all features relating to the cargo item must be documented and attached to the unique identifier. Such relating features may be, for example, a description of the item, such as a container, as well as any items held within the container. A damage report highlighting any preexisting damage to the container or contents of the container may be made, including a photograph of the container. Further, any previous papers or reports associated with the container and contents may be inputted to the system. By further example, if the container contains hazardous materials, previous documentation may be reviewed and entered into the system. The system may then provide a “hazmat tag” associated with the unique identifier, and readily viewable by any user viewing the item, or other items which may further contain the hazmat item, such as a container containing not only the hazmat item, but other non-hazardous items. Thus, any cargo item or container, may be tagged as a hazmat item, as long as it is associated with a hazardous material. Likewise, when a hazmat item is removed from a container or palette, that container or palette will no longer carry the hazmat item tag. The system may also link additional handling information or requirements, as well as any legal information via the system database or via an external source, such as through the internet, for association with the hazmat item reports. This may provide a user with the information necessary for proper handling, storage, cleanup, as well as any additional liability issues, which may be associated with the particular hazardous material.

In another exemplary embodiment of the present invention, the gate in/gate out feature may incorporate weight measurements of cargo items as they enter and leave the system. Weight measurements may also occur at any checkpoint throughout the system, provided the proper weight measuring equipment are in place. For example, a container containing multiple items may enter the system via the gate, and may be placed onto a scale, which may produce a weight record for its associated report. At a later time, should an item, or several items, be removed from the container, and the container's weight recorded again, the difference in weight may signal to the user that the container is missing something. Such a system may act as a checks and balances to alert the user that something has changed, or that something has changed in weight appropriately. Further, any weight recorded in the system may be used in a calculation of other items associated with it. For example, if the gross weight of the container is known, and the weight of a particular item inside the container is not known, a mathematical calculation may be made by the system to determine the weight of the item in question. Gross weights, net cargo weights, and the like, may also be calculated. The system may make any basic calculation, provided the necessary inputted values are available.

In another example of the gating function of the present invention involves the system may track the “age” of a particular cargo item or container. For example, upon entry of an item into the system, a clock begins to run for that item. This may allow a user to view how long the item has been in the system, how long it has been in storage or repair, and the like. In the case of a person as cargo, the length of time the person remains at any point within the system may be recorded. This information may then be used not only for accurate recordkeeping, but also for security measures, and alerts may be established according to the information, as will be described in further detail below.

The gating function may also provide an authorized user to manipulate what information is actually entered into the system database upon entry of an item into the system. In some cases, an overabundance of insignificant or unnecessary information may come in with the item. An authorized user, such as a gate administrator, could determine which portions of the information are put into the system. This level of control allows a user to avoid reports that are too large to handle by subsequent users, and avoid filling storage within the database with unnecessary information. The user may accomplish this by compiling selected information and committing only that information into the database. Alternatively, the user may enter all information into a subfile, and then commit only those information items selected into the system database. In this example, the unselected information could be held separately for a specified period of time, in case any portion of its contents later becomes significant.

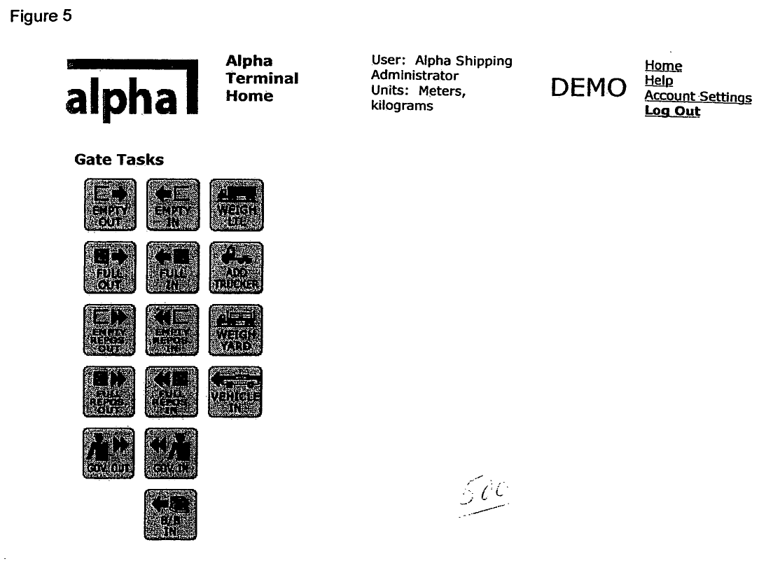

As illustrated in FIG. 5, the Gate function may allow the user to access and perform the various tasks required by a gate administrator. Such tasks may include: Gate In, Gate Out, Empty Out, Empty In, Full Out, Full In, Empty Reposition Out, Empty Reposition In, Full Reposition Out, Full Reposition In, B/B In, Add Trucker, Weigh LTL, Weigh Yard, Vehicle In, Gov. Out, and Gov. In.

According to another aspect of the present invention, each user may be assigned a role, and each role may or may not have associated therewith one or more permissions. For example, a user may be an administrator, such as a gate administrator, and may not be required to have a permission. Such a user may engage in a task, such as entering the system via a handheld device and reaching the “Empty Out” request screen. The Empty Out function may allow the user to record when a Trucker leaves the terminal with an empty container.

To reach the Empty Out screen, the user may first select “Gate” from the Main Menu on the handheld device, and further select “Empty Out”. The user may be prompted to select the type of Empty Out, by indicating it as either “Live Load” or “Drop and Pick” and entering it by selecting “Submit”. The user may then enter the Booking Number provided by the Trucker's dispatch order and select “Search”. The Search Results may display the Booking Information, as well as the Cargo Records associated with the Booking Number. The user may also select the Cargo Record that matches the type of Container that the Trucker may be leaving the gate with by selecting “Next” for the desired Cargo Record. The user may provide Empty Out Information, such as Gate Date, Container ID, Chassis ID, Trucker Code, and Genset ID, for example, for the Container, Chassis, Trucker, and Genset.

The field “Gate Date” may automatically appear. The Date/Time format may be recorded as: YYYY-MM-DD HH:MM.

The user may select “Container ID” and either enter or scan in the Container ID. The Container ID information may be required by the system.

The user may select “Chassis ID” and either enter or scan in the Chassis ID. The Chassis ID information may be required by the system.

The user may select “Trucker Code” and either enter or scan in the Trucker Code. The Trucker Code information may be required by the system.

The user may select “Genset ID” and either enter or scan in the Genset ID in to the system. It may be important to note that if the profile of the Container for the Container ID entered by the user does not match the profile of the type of container needed for the Booking, the system may return an error. The user may be unable to advance to the next screen until an appropriate Container ID has been entered or the Booking Information has been modified by an Administrator with the appropriate permissions. If a user enters a Trucker Code that is not recognized by the system, the system may give the user an option to create a New Trucker Record or to possibly correct the Trucker Code that may have been entered on the previous form. The User may select “Update” to continue forward to the Container EIR (Equipment Interchange Receipt) Section.

After assessment of any damage that may have happened to the Container, the user may record information, such as EIR Date, Damage Description, Interior Clean, Damage Level, and Action, for example, on the Container EIR Form.

The field “EIR Date” should automatically appear. The Date/Time format may be recorded as: YYYY-MM-DD HH:MM.

The user may select “Damage Description” and enter the information in to the system. This information may be filled out by the user by typing freeform text into the Damage Description box, or by using preformatted damage descriptions in conjunction with the visual Container graphics. To fill out the Damage Description using the preformatted damage descriptions and visual Container graphics, the user may first select a Damage type from the drop-down options available. The user may then select the area of the Container graphics where the damage appears. The damage description may appear in text format in the Damage Description box. The user may then repeat the process to add as many damage descriptions as needed.

The user may select “Interior Clean” and enter if the interior of the Container is clean by selecting Yes (the interior is clean) or No (the interior is not clean).

For example, after the user has assessed the damage level of the Container, the user may select “Damage Level” and enter one of the following levels: None, meaning the Container in Perfect Condition; Green, meaning the Container has sustained minimal damage; Yellow, meaning the Container has sustained considerable amount of damage, yet should still be safe for use, and repairs should be considered; Red, meaning the Container is badly damaged and should be repaired as soon as possible.

The user may select “Action” and enter the appropriate action based on the Damage Level, to send out the Container or to Reject the Container for Repair. The user may select either “Accept for Use” or “Reject for Repair”. It may be important to note that if the Container has been Rejected for Repair, the user may have to start the Empty Out process for this Cargo from the beginning. Once the Container EIR Form has been completely filled out, the user may select “Update” to continue forward to the Chassis EIR form.

To record any damage to the Chassis and the condition of the tires on the Chassis, the user may enter information, such as EIR Date, Damage Description, Tires, Damage Level, and Action, for example, to the Chassis EIR Form.

For example, the field “EIR Date” may automatically appear. The Date/Time format may be recorded as: YYYY-MM-DD HH:MM.

The user may select “Damage Description” and enter the information in to the system. This information may be filled out by the user by typing freeform text into the Damage Description box, or by using preformatted Parts list in conjunction with the Damage Type list. To fill out the Damage Description using the preformatted Parts and Damage Type list, the user may select a Part from the drop-down options available, and may further select a Damage Type from the drop-down options available. To add the damage description, the user may select “Add/Update” to enter the information in to the system. The damage description may appear in text format in the Damage Description box. The user may then repeat the process to add as many damage descriptions as needed.

The user may provide information, such as Outside Tires and Inside Tires, regarding the Tires on the Chassis. For all Outside Tires, the user may enter the Cap Number, if there is a cap, the Condition, which may be good, fair, or poor, and the Tread depth. For all Inside Tires, the user may enter the Condition as good, fair, or poor, and the Tread depth.

For example, after the user has assessed the damage level of the Chassis, the user may select “Damage Level” and enter one of the following levels: None, meaning the Chassis in Perfect Condition; Green, meaning the Chassis has sustained minimal damage; Yellow, meaning the Chassis has sustained considerable amount of damage, yet should still be safe for use, and repairs should be considered; Red, meaning the Chassis is badly damaged and should be repaired as soon as possible.

The user may select “Action” and enter the appropriate action based on the Damage Level, to send out the Chassis or to Reject the Chassis for Repair. The user may select either “Accept for Use” or “Reject for Repair”. It may be important to note that if the Chassis has been Rejected for Repair, the user may have to start the Empty Out process for this Cargo from the beginning.

Once the Chassis EIR Form has been completely filled out, the user may select “Update” to continue forward to the Genset EIR form. If there was no Genset associated with this Chassis, the user may select “Add” to complete the Empty Out transaction.

If a Genset may be going out with the Container and Chassis, the user may need to provide information, such as EIR Date, Fuel Level, and Action on the Genset EIR Form.

For example, the field “EIR Date” may automatically appear. Date/Time format may be recorded as: YYYY-MM-DD HH:MM.

The user may enter the Fuel Level by selecting Full, ¾, ½, ¼, or Empty.

The user may select “Action” and enter the appropriate action based on the damages and fuel level, to send out the Genset or to Reject the Genset for Repair. The user may select either “Accept for Use” or “Reject for Repair”. It may be important to note that if the Genset has been Rejected for Repair, the user may have to start the Empty Out process for this Cargo from the beginning. Once the Genset EIR Form has been completely filled out, the user may select “Add” to complete the Empty Out transaction. The user may then select “Print” to print a receipt for the Trucker. The receipt may also be used by the Trucker to speed up the Full In process. The user may select “Print” again to print an additional receipt if desired. Once the transaction is complete, and the trucker has left with the Empty Out, the status of the Cargo item the Trucker may be bringing back should change to “Transaction Pending”.

According to another aspect of the present invention, each user may be assigned a role, and each role may or may not have associated therewith one or more permissions. For example, a user may be an administrator, such as a gate administrator, and may not be required to have a permission. Such a user may engage in a task, such as entering the system via a handheld device and reaching the “Empty In” request screen. The Empty In function may allow the user to record when a Trucker is returning a “Full Out” (see description below). This function may close the loop on the transaction. In order for Empty In to work, the system may be required to have recorded a “Full Out” for the Equipment on the system.

To reach the Empty In screen, the user may first select “Gate” from the Main Menu of the handheld device, and further select “Empty In”. The user may then enter the E Code or Container ID and select “Search”. An E-Code may be a unique number for a particular record. It may allow the user to create and later scan a bar code that is in fact the E-code. By entering the E-code either through a scan or by manual entry may take the user straight to the relevant record. Although the E-Code may not be the only method of unique identification for a particular item, technically, it may be the primary key for the cargo table in the database, and may be the easiest, fastest, most accurate way to reference specific Cargo records in the system. One example may be the barcoded receipts given to truckers on their way out of the Gate; the barcode may be the E-code, and that may make it easier, faster, and more accurate when the trucker returns with that receipt and it gets scanned to start the full-in or empty-in task.

The E Code may be found on the Trucker's ‘Express Check-In’ receipt and may be entered into the system by scanning the bar code on the receipt or by entering the E Code via the handheld keyboard. If an ‘Express Check-In’ receipt is not available, the user may enter or scan the Container ID located on the Container.

The user may provide Empty In Information, such as Gate Date, Container ID, Chassis ID, Trucker Code, and Genset ID, for the Container, Chassis, Trucker, and Genset, for example.

For example, the field “Gate Date” may automatically appear. The Date/Time format may be recorded as: YYYY-MM-DD HH:MM.

The user may select “Container ID” to verify that the information is correct.

The user may select “Chassis ID” to verify that the information is correct.

The user may select “Trucker Code” and either enter or scan in the Trucker Code if it is different from what may appear in the text box.

The user may select “Genset ID” to verify that the information is correct It is important to note that the Trucker should be returning with the same Equipment that they left the terminal with when they picked up the Full Out. If the actual Equipment does not match with the Equipment displayed in the system, the user should alert Management. If a user enters a Trucker Code that is not recognized by the system, the system may give the user an option to create a New Trucker Record or to possibly correct the Trucker Code that may have been entered on the previous form. The User may select “Update” to continue forward to the Container EIR Section.

After assessment of any damage that may have happened to the Container, the user may record information, such as EIR Date, Damage Description, Interior Clean, Damage Level, and Action, for example, on the Container EIR Form.

For example, the field “EIR Date” should automatically appear. The Date/Time format may be recorded as: YYYY-MM-DD HH:MM.

The user may select “Damage Description” and enter the information in to the system. This information may be filled out by the user by typing freeform text into the Damage Description box, or by using preformatted damage descriptions in conjunction with the visual Container graphics. To fill out the Damage Description using the preformatted damage descriptions and visual Container graphics, the user may first select a Damage type from the drop-down options available. The user may then select the area of the Container graphics where the damage appears. The damage description may appear in text format in the Damage Description box. The user may then repeat the process to add as many damage descriptions as needed.

The user may select “Interior Clean” and enter if the interior of the Container is clean by selecting Yes (the interior is clean) or No (the interior is not clean).

For example, after the user has assessed the damage level of the Container, the user may select “Damage Level” and enter one of the following levels: None, meaning the Container in Perfect Condition; Green, meaning the Container has sustained minimal damage; Yellow, meaning the Container has sustained considerable amount of damage, yet should still be safe for use, and repairs should be considered; Red, meaning the Container is badly damaged and should be repaired as soon as possible.

The user may select “Action” and enter the appropriate action based on the Damage Level, to allow the Container to have Available status or to Reject the Container and send it to Maintenance and Repairs (M&R). The user may select either “Make Available” or “Send to M&R”. Once the Container EIR Form has been completely filled out, the user may select “Update” to continue forward to the Chassis EIR form.

To record any damage to the Chassis and the condition of the tires on the Chassis, the user may enter information, such as EIR Date, Damage Description, Tires, Damage Level, and Action to the Chassis EIR Form.

The field “EIR Date” may automatically appear. The Date/Time format may be recorded as: YYYY-MM-DD HH:MM.

The user may select “Damage Description” and enter the information in to the system. This information may be filled out by the user by typing freeform text into the Damage Description box, or by using preformatted Parts list in conjunction with the Damage Type list. To fill out the Damage Description using the preformatted Parts and Damage Type list, the user may select a Part from the drop-down options available, and may further select a Damage Type from the drop-down options available. To add the damage description, the user may select “Add/Update” to enter the information in to the system. The damage description may appear in text format in the Damage Description box. The user may then repeat the process to add as many damage descriptions as needed.

The user may provide information, such as Outside Tires and Inside Tires, about the Tires on the Chassis. For all Outside Tires, the user may enter the Cap Number, if there is a cap, the Condition, which may be good, fair, or poor, and the Tread depth. For all Inside Tires, the user may enter the Condition as good, fair, or poor, and the Tread depth.

For example, after the user has assessed the damage level of the Chassis, the user may select “Damage Level” and enter one of the following levels: None, meaning the Chassis in Perfect Condition; Green, meaning the Chassis has sustained minimal damage; Yellow, meaning the Chassis has sustained considerable amount of damage, yet should still be safe for use, and repairs should be considered; Red, meaning the Chassis is badly damaged and should be repaired as soon as possible.

The user may select “Action” and enter the appropriate action based on the Damage Level, to allow the Container to have Available status or to Reject the Container and send it to Maintenance and Repairs (M&R). The user may select either “Make Available” or “Send to M&R”. Once the Container EIR Form has been completely filled out, the user may select “Update” to continue forward to the Chassis EIR form. If there was no Genset associated with the Chassis, the user may select “Add” to complete the Empty In transaction.

If a Genset may be going out with the Container and Chassis, the user may need to provide information, such as EIR Date, Fuel Level, and Action on the Genset EIR Form.

The field “EIR Date” may automatically appear. The Date/Time format may be recorded as: YYYY-MM-DD HH:MM.

The user may enter the Fuel Level by selecting Full, ¾, ½, ¼, or Empty.

The user may select “Action” and enter the appropriate action based on the damages and fuel level, to send out the Genset or to Reject the Genset for Repair. The user may select either “Make Available” or “Send to M&R”. Once the Genset EIR Form has been completely filled out, the user may select “Add” to complete the Empty Out transaction. The user may then select “Print” to print a receipt for the Trucker. The receipt may also be used by the Trucker to speed up the Full Out process.

According to another aspect of the present invention, each user may be assigned a role, and each role may or may not have associated therewith one or more permissions. For example, a user may be an administrator, such as a gate administrator, and may not be required to have a permission. Such a user may engage in a task, such as entering the system via a handheld device and reaching the “Full Out” request screen. The Full Out function may allow the user to record when a Trucker leaves the terminal with a full container.

To reach the Full Out screen, the user may first select “Gate” from the Main Menu of the handheld device screen, and then further select “Full Out”. The user may then enter the E-Code, the Bill of Lading Number or the Container ID, and select “Search”. The user may select the Cargo Record that matches the Container ID and type of Container that the Trucker is leaving the gate with by selecting “Next” for the desired Cargo Record. The user may verify and/or enter the Full Out Information, such as Gate Date, Container ID, Container Type, Container Size, Food Grade, Reefer Temperature Setting, Reefer Temperature Actual, Reefer Status, Reefer Instructions, Hazardous Material Type, Other Hazardous Material Description, Seal 1, Seal 2-4, Chassis ID, Trucker Code, and Genset ID, for example, for the Cargo.

The Gate Date information should automatically appear. The Date/Time format may be recorded as: YYYY-MM-DD HH:MM.

The user may verify that the Container ID information is correct.

The user may verify that the Container Type information is correct.

The user may verify that the Container Size information is correct.

The user may verify that the Food Grade information is correct.

The field “Reefer Temp. Setting” may indicate what the actual temperature for the Genset should read.

The user may select “Reefer Temp. Actual” and enter the actual temperature on the Genset.

The user may select “Reefer Status” and enter the desired status. The user may select each status to read a definition of the selected status.

The field “Reefer Instructions” may allow the user to make note of any special handling instructions for the refrigerated cargo.

If the cargo is a Hazardous Material, the user may take note of the Hazardous Material being carried. The user may then verify that this information is correct.

If the cargo is a Hazardous Material that does not fall into a standard classification or needs further explanation, it may be listed under “Other Hazmat Desc.”. The user may take note of the Hazardous Material being carried, and verify that this information is correct.

The field “Seal 1” allows the user to verify that the Seal 1 information is correct.

Also, some containers may have more than one Seal. The information “Seal 2-4” allows the user to verify that this information is correct.

The user may select “Chassis ID” and enter or scan in the Chassis ID. The Chassis ID information may be required by the system.

The user may select “Trucker Code” and enter or scan in the Trucker Code. The Trucker Code information may be required by the system.

The user may select “Genset ID” and enter or scan in the Genset ID. It may be important to note that the information presented by the system should match the actual Equipment leaving the Gate. If this information does not match, the user should consider alerting Management immediately. If the Seal does not match or has been tampered with, US Customs may be notified. If the user enters a Trucker Code that the system does not recognize, the system may give the user the option to create a New Trucker Record or to correct the Trucker Code entered on the previous form. If the user enters a valid Genset ID that the system does not recognize, the system may give the user the option to create a New Genset Record or to correct the Genset ID entered on the previous form. The user may select “UPDATE” to continue forward to the Container EIR Section.

After assessment of any damage that may have happened to the Container, the user may record information, such as EIR Date, Damage Description, and Damage Level, for example, on the Container EIR Form.

The field “EIR Date” should automatically appear. The Date/Time format may be recorded as: YYYY-MM-DD HH:MM.

The user may select “Damage Description” and enter the information in to the system. This information may be filled out by the user by typing freeform text into the Damage Description box, or by using preformatted damage descriptions in conjunction with the visual Container graphics. To fill out the Damage Description using the preformatted damage descriptions and visual Container graphics, the user may first select a Damage type from the drop-down options available. The user may then select the area of the Container graphics where the damage appears. The damage description may appear in text format in the Damage Description box. The user may then repeat the process to add as many damage descriptions as needed.

For example, after the user has assessed the damage level of the Container, the user may select “Damage Level” and enter one of the following levels: None, meaning the Container in Perfect Condition; Green, meaning the Container has sustained minimal damage; Yellow, meaning the Container has sustained considerable amount of damage, yet should still be safe for use, and repairs should be considered; Red, meaning the Container is badly damaged and should be repaired as soon as possible. Once the Container EIR Form is completely filled out, the user may select “Add” to continue forward to the Chassis EIR form.

To record any damage to the Chassis and the condition of the tires on the Chassis, the user may enter information, such as EIR Date, Damage Description, Tires, Damage Level, and Action to the Chassis EIR Form.

The field “EIR Date” may automatically appear. Date/Time format may be recorded as: YYYY-MM-DD HH:MM.

The user may select “Damage Description” and enter the information in to the system. This information may be filled out by the user by typing freeform text into the Damage Description box, or by using preformatted Parts list in conjunction with the Damage Type list. To fill out the Damage Description using the preformatted Parts and Damage Type list, the user may select a Part from the drop-down options available, and may further select a Damage Type from the drop-down options available. To add the damage description, the user may select “Add/Update” to enter the information in to the system. The damage description may appear in text format in the Damage Description box. The user may then repeat the process to add as many damage descriptions as needed.

The user may provide information, such as Outside Tires and Inside Tires, about the Tires on the Chassis. For all Outside Tires, the user may enter the Cap Number, if there is a cap, the Condition as good, fair, or poor, and the Tread depth. For all Inside Tires, the user may enter the Condition as good, fair, or poor, and the Tread depth.

For example, after the user has assessed the damage level of the Chassis, the user may select “Damage Level” and enter one of the following levels: None, meaning the Chassis in Perfect Condition; Green, meaning the Chassis has sustained minimal damage; Yellow, meaning the Chassis has sustained considerable amount of damage, yet should still be safe for use, and repairs should be considered; Red, meaning the Chassis is badly damaged and should be repaired as soon as possible.

The user may select “Action” and enter the appropriate action based on the Damage Level, to allow the Chassis to be sent out or to Reject the Chassis for Repair. The user may select either “Accept for Use” or “Reject for Repair”. Once the Chassis EIR Form has been completely filled out, the user may select “Add” to continue forward to the Genset EIR form. If there was no Genset associated with the Chassis, the user may select “Add” to complete the Empty Out transaction.

If a Genset may be going out with the Container and Chassis, the user may need to provide information, such as EIR Date, Fuel Level, and Action on the Genset EIR Form.

The field “EIR Date” may automatically appear. Date/Time format may be recorded as: YYYY-MM-DD HH:MM.

The user may enter the Fuel Level by selecting Full, ¾, ½, ¼, or Empty.

The user may select “Action” and enter the appropriate action based on the damages and fuel level, to send out the Genset or to Reject the Genset for Repair. The user may select either “Accept for Use” or “Reject for Repair”. If the Genset has been Rejected for Repair, the user may have to start the Full Out process for the Cargo from the beginning. Once the Genset EIR Form has been completely filled out, the user may select “Add” to complete the Full Out transaction. The user may then select “Print” to print a receipt for the Trucker. The receipt may also be used by the Trucker to speed up the Full Out process.

According to another aspect of the present invention, each user may be assigned a role, and each role may or may not have associated therewith one or more permissions. For example, a user may be an administrator, such as a gate administrator, and may not be required to have a permission. Such a user may engage in a task, such as entering the system via a handheld device and reaching the “Full In” request screen. The Full In function may allow the user to record when a Trucker is returning from an Empty Out. It may be used for closing the loop on the transaction. For Full In to work, the system may be required to have recorded an Empty Out for the equipment.

To reach the Full In screen, the user may first select “Gate” from the Main Menu screen of the handheld device, and then further select “Full In”. The user may then enter either the E Code or the Container ID, and select “Search”. The E Code may be found on the Trucker's ‘Express Check-In’ receipt and may be entered into the system by either scanning the bar code on the receipt or by entering the E Code via the handheld keyboard. If an ‘Express Check-In’ receipt is not available, the user may enter or scan the Container ID located on the Container. The user may verify and/or enter the Full In Information, such as Gate Date, Container ID, Chassis ID, Genset ID, Reefer Temperature Setting, Reefer Temperature Actual, Reefer Status, Reefer Instructions, Scale Weight, Tractor Weight, Container Gross Weight, Hazardous Material Type, Other Hazardous Material Description, Seal 1, Seal 2-4, Over Dimensional, Length, Width, Height, and Trucker Code, for example, for the Cargo.

The Gate Date information should automatically appear. The Date/Time format may be recorded as: YYYY-MM-DD HH:MM.

The user may verify that the Container ID information is correct.

The user may verify that the Chassis ID information is correct.

The user may verify that the Genset ID information is correct.

The field “Reefer Temp. Setting” may indicate what the actual temperature for the Genset should read.

The user may select “Reefer Temp. Actual” and enter the actual temperature on the Genset.

The user may select “Reefer Status” and enter the desired status. The user may select each status to read a definition of the selected status.

The field “Reefer Instructions” may allow the user to make note of any special handling instructions for the refrigerated cargo.

The user may select “Scale Weight” and enter the scale weight for the truck and its cargo.

The user may select “Tractor Weight” and enter the tractor weight.

The user may select “Container Gross Weight” and enter the gross weight of the container. If the user does not enter a value into the field, the system will calculate the value automatically.

For example, if the cargo is a Hazardous Material, the user may take note of the Hazardous Material being carried. The user may then verify that this information is correct.

For example, if the cargo is a Hazardous Material that does not fall into a standard classification or needs further explanation, it may be listed under “Other Hazmat Desc.”. The user may take note of the Hazardous Material being carried, and verify that this information is correct.

The field “Seal 1” allows the user to verify that the Seal 1 information is correct.

For example, some containers may have more than one Seal. The information “Seal 2-4” allows the user to verify that this information is correct.

For example, if the cargo is Over Dimensional, the user may select ‘Yes’. If the cargo is not Over Dimensional, the user may select ‘No’.

The user may select “Length” and enter the length of the cargo.

The user may select “Width” and enter the width of the cargo.

The user may select “Height” and enter the height of the cargo.

The user may select “Trucker Code” and enter or scan in the Trucker Code if the user desires different information than what may already have appeared in the text box. It may be important to note that the Trucker should be returning with the same Equipment that they left the terminal with when they picked up the Empty Out. If the Actual Equipment does not match with the Equipment displayed in the system, the user may want to alert management immediately. If the user enters a Trucker Code that the system does not recognize, the system may give the user the option to create a New Trucker Record or to correct the Trucker Code entered on the previous form. The user may select “UPDATE” to continue forward to the Container EIR Section.

After assessment of any damage that may have happened to the Container, the user may record information, such as EIR Date, Damage Description, and Damage Level on the Container EIR Form.

The field “EIR Date” should automatically appear. The Date/Time format may be recorded as: YYYY-MM-DD HH:MM.

The user may select “Damage Description” and enter the information in to the system. This information may be filled out by the user by typing freeform text into the Damage Description box, or by using preformatted damage descriptions in conjunction with the visual Container graphics.

To fill out the Damage Description using the preformatted damage descriptions and visual Container graphics, the user may first select a Damage type from the drop-down options available. The user may then select the area of the Container graphics where the damage appears. The damage description may appear in text format in the Damage Description box. The user may then repeat the process to add as many damage descriptions as needed.

For example, after the user has assessed the damage level of the Container, the user may select “Damage Level” and enter one of the following levels: None, meaning the Container in Perfect Condition; Green, meaning the Container has sustained minimal damage; Yellow, meaning the Container has sustained considerable amount of damage, yet should still be safe for use, and repairs should be considered; Red, meaning the Container is badly damaged and should be repaired as soon as possible. Once the Container EIR Form is completely filled out, the user may select “Add” to continue forward to the Chassis EIR form.

To record any damage to the Chassis and the condition of the tires on the Chassis, the user may enter information, such as EIR Date, Damage Description, Tires, Damage Level, and Action to the Chassis EIR Form.

The field “EIR Date” may automatically appear. The Date/Time format may be recorded as: YYYY-MM-DD HH:MM.

The user may select “Damage Description” and enter the information in to the system. This information may be filled out by the user by typing freeform text into the Damage Description box, or by using preformatted Parts list in conjunction with the Damage Type list. To fill out the Damage Description using the preformatted Parts and Damage Type list, the user may select a Part from the drop-down options available, and may further select a Damage Type from the drop-down options available. To add the damage description, the user may select “Add/Update” to enter the information in to the system. The damage description may appear in text format in the Damage Description box. The user may then repeat the process to add as many damage descriptions as needed.

The user may provide information, such as Outside Tires and Inside Tires, about the Tires on the Chassis. For all Outside Tires, the user may enter the Cap Number, if there is a cap, the Condition, which may be good, fair, or poor, and the Tread depth. For all Inside Tires, the user may enter the Condition as good, fair, or poor, and the Tread depth.

For example, after the user has assessed the damage level of the Chassis, the user may select “Damage Level” and enter one of the following levels: None, meaning the Chassis in Perfect Condition; Green, meaning the Chassis has sustained minimal damage; Yellow, meaning the Chassis has sustained considerable amount of damage, yet should still be safe for use, and repairs should be considered; Red, meaning the Chassis is badly damaged and should be repaired as soon as possible.

The user may select “Action” and enter the appropriate action based on the Damage Level, to allow the Chassis to take on an Available status, Reject the Chassis and send it to Maintenance and Repairs (M&R), or keep the Chassis with the Container. The user may select either “Accept for Use”, “Reject for Repair” or “Keep with Container”. Once the Chassis EIR Form has been completely filled out, the user may select “Update” to continue to the Genset EIR form. If there was no Genset associated with the Chassis, the user may select “Add” to complete the Full In transaction.

If a Genset may be going out with the Container and Chassis, the user may need to provide information, such as EIR Date, Fuel Level, and Action on the Genset EIR Form.

The field “EIR Date” may automatically appear. Date/Time format may be recorded as: YYYY-MM-DD HH:MM.

The user may enter the Fuel Level by selecting Full, ¾, ½, ¼, or Empty.

The user may select “Action” and enter the appropriate action based on the damages, the fuel level, and how the Container may be carried by the line, to make the Genset Available, Reject the Genset for Repair, or keep the Genset with the Container. The user may select either “Make Available”, “Send to M&R”, or “Keep with Container”. Once the Genset EIR Form has been completely filled out, the user may select “Add” to complete the Full In transaction. The user may then select “Print” to print a receipt for the Trucker.

According to another aspect of the present invention, each user may be assigned a role, and each role may or may not have associated therewith one or more permissions. For example, a user may be an administrator, such as a gate administrator, and may not be required to have a permission. Such a user may engage in a task, such as entering the system via a handheld device and reaching the “Empty Reposition Out” request screen. The Empty Out function may allow the user to record when a Trucker leaves the Gate with an empty Container and Chassis that have been requested at another location, such as another Terminal due to a lack of equipment.

To reach the Empty Reposition Out screen, the user may first select “Gate” from the Main Menu of the handheld device, and further select “Empty Reposition Out”. The user may provide Information, such as Gate Date, Container ID, Chassis ID, Trucker Code, Genset ID, and Reposition To, for the system.

The field “Gate Date” may automatically appear. The Date/Time format may be recorded as: YYYY-MM-DD HH:MM.

The user may select “Container ID” and either enter or scan in the Container ID for the Empty Reposition Out Cargo.

The user may select “Chassis ID” and either enter or scan in the Chassis ID for the Empty Reposition Out Cargo.

The user may select “Trucker Code” and either enter or scan in the Trucker Code.

The user may select “Genset ID” and either enter or scan in the Genset for the Empty Reposition Out Cargo.

The user may select “Reposition To” and enter the name of the location where the cargo may be repositioned to.

It may be important to note that if a user enters a Trucker Code that is not recognized by the system, the system may give the user an option to create a New Trucker Record or to possibly correct the Trucker Code that may have been entered on the previous form. The User may select “Add” to continue with the Empty Reposition Out function.

After assessment of any damage that may have happened to the Container, the user may record information, such as EIR Date, Damage Description, Interior Clean, Damage Level, and Action on the Container EIR Form.

The field “EIR Date” should automatically appear. The Date/Time format may be recorded as: YYYY-MM-DD HH:MM.

The user may select “Damage Description” and enter the information in to the system. This information may be filled out by the user by typing freeform text into the Damage Description box, or by using preformatted damage descriptions in conjunction with the visual Container graphics. To fill out the Damage Description using the preformatted damage descriptions and visual Container graphics, the user may first select a Damage type from the drop-down options available. The user may then select the area of the Container graphics where the damage appears. The damage description may appear in text format in the Damage Description box. The user may then repeat the process to add as many damage descriptions as needed.

The user may select “Interior Clean” and enter if the interior of the Container is clean by selecting Yes (the interior is clean) or No (the interior is not clean).

For example, after the user has assessed the damage level of the Container, the user may select “Damage Level” and enter one of the following levels: None, meaning the Container in Perfect Condition; Green, meaning the Container has sustained minimal damage; Yellow, meaning the Container has sustained considerable amount of damage, yet should still be safe for use, and repairs should be considered; Red, meaning the Container is badly damaged and should be repaired as soon as possible.

The user may select “Action” and enter the appropriate action based on the Damage Level, to allow the Container to take on an Available status or to Reject the Container and send it to Maintenance and Repairs (M&R). The user may select either “Make Available” or “Send to M&R”. Once the Container EIR Form has been completely filled out, the user may select “Add” to continue the Empty Reposition Out function.

To record any damage to the Chassis and the condition of the tires on the Chassis, the user may enter information, such as EIR Date, Damage Description, Tires, Damage Level, and Action to the Chassis EIR Form.

The field “EIR Date” may automatically appear. Date/Time format may be recorded as: YYYY-MM-DD HH:MM.

The user may select “Damage Description” and enter the information in to the system. This information may be filled out by the user by typing freeform text into the Damage Description box, or by using preformatted Parts list in conjunction with the Damage Type list. To fill out the Damage Description using the preformatted Parts and Damage Type list, the user may select a Part from the drop-down options available, and may further select a Damage Type from the drop-down options available. To add the damage description, the user may select “Add/Update” to enter the information in to the system. The damage description may appear in text format in the Damage Description box. The user may then repeat the process to add as many damage descriptions as needed.

The user may provide information, such as Outside Tires and Inside Tires, about the Tires on the Chassis. For all Outside Tires, the user may enter the Cap Number, if there is a cap, the Condition, which may be good, fair, or poor, and the Tread depth. For all Inside Tires, the user may enter the Condition as good, fair, or poor, and the Tread depth.

For example, after the user has assessed the damage level of the Chassis, the user may select “Damage Level” and enter one of the following levels: None, meaning the Chassis in Perfect Condition; Green, meaning the Chassis has sustained minimal damage; Yellow, meaning the Chassis has sustained considerable amount of damage, yet should still be safe for use, and repairs should be considered; Red, meaning the Chassis is badly damaged and should be repaired as soon as possible.

The user may select “Action” and enter the appropriate action based on the Damage Level, to allow the Container to take on an Available status or to Reject the Container and send it to Maintenance and Repairs (M&R). The user may select either “Make Available” or “Send to M&R”.

Once the Chassis EIR Form has been completely filled out, the user may select “Update” to continue forward to the Genset EIR form. If there was no Genset associated with this Chassis, the user may select “Add” to complete the Empty Reposition Out transaction.

If a Genset may be leaving with the Chassis, the user may need to provide information, such as EIR Date, Fuel Level, and Action on the Genset EIR Form.

The field “EIR Date” may automatically appear. Date/Time format may be recorded as: YYYY-MM-DD HH:MM.

The user may enter the Fuel Level by selecting Full, ¾, ½, ¼, or Empty.

The user may select “Action” and enter the appropriate action based on the Damage Level, to allow the Container to take on an Available status or to Reject the Container and send it to Maintenance and Repairs (M&R). The user may select either “Make Available” or “Send to M&R”. Once the Genset EIR Form has been completely filled out, the user may select “Add” to complete the Empty Reposition Out transaction. The user may then select “Print” to print a receipt for the Trucker.

According to another aspect of the present invention, each user may be assigned a role, and each role may or may not have associated therewith one or more permissions. For example, a user may be an administrator, such as a gate administrator, and may not be required to have a permission. Such a user may engage in a task, such as entering the system via a handheld device and reaching the “Empty Reposition In” request screen. The Empty Reposition In function may allow the user to record when a Trucker brings an Empty Container or Chassis to the Gate to satisfy a need for more empty Containers or Chassis on the Terminal.

To reach the Empty Reposition In screen, the user may first select “Gate” from the Main Menu of the handheld device, and further select “Empty Reposition In”. The user may provide Information, such as Gate Date, Customer, Container ID, Container Type, Container Length, Food Grade, Chassis ID, Trucker Code, Genset ID, and Reposition From, for example, for the system.

The field “Gate Date” may automatically appear. The Date/Time format may be recorded as: YYYY-MM-DD HH:MM.

The user may select “Customer” and enter the Customer ID for the customer, such as the shipping line, that owns the Container being added to the system. The Customer information may be required by the system.

The user may select “Container ID” and enter the Container ID for the Empty Reposition In Cargo. Each Container may have a unique Container ID number comprised of four letters followed by seven numbers in the format “AAAA#######”.

The user may select “Container Type” and enter the container type for the container being added.

The user may select “Container Length” and enter the container length for the container being added.

The user may select “Food Grade” and enter the food grade for the container being added.

The user may select “Chassis ID” and enter in the Chassis ID for the Empty Reposition In Cargo. The Chassis ID information may be required by the system.

The user may select “Trucker Code” and either enter or scan in the Trucker Code if the desired information is different from what may already be in the text box. The Trucker Code Information may be required by the system.

The user may select “Genset ID” and enter in the Genset for the Empty Reposition In Cargo if it is applicable.

The user may select “Reposition From” and enter where the Empty Reposition In is being repositioned from. The Reposition From information may be required by the system.

It may be important to note that if a user enters a Trucker Code that is not recognized by the system, the system may give the user an option to create a New Trucker Record or to possibly correct the Trucker Code that may have been entered on the previous form. The User may select “Add” to continue with the Empty Reposition In function.

If any Equipment coming in to the Terminal on an Empty Reposition In is new to the system, the user may be prompted to provide applicable information, such as Customer ID, Container ID, Tare Weight, Container Type, Container Length, Food Grade, Chassis ID, Plate Number, Chassis Length, Chassis Type, Chassis Weight, Outside Tires, Inside Tires, Genset ID, and Set Type for the new Equipment Records.

The user may select “Customer ID” to edit the Customer ID for the customer that owns the Equipment being added to the system.

The user may select “Container ID” to display the new Container ID entered on the previous form. Each Container may have a unique Container ID number. This unique ID may be comprised of four letters followed by seven numbers in the format “AAAA#######”. The user may select “Back/Correct” to go back to the previous form and edit the Container ID number.

The user may select “Tare Weight” and enter the weight of the Container being added.

The user may select “Container Type” and enter the container type of the Container being added.

The user may select “Container Length” and enter the container length of the Container being added.

The user may select “Food Grade” and enter the food grade of the Container being added The user may select “Chassis ID” to display the new Chassis ID entered on the previous form. Each Chassis may have a unique Chassis ID number. This unique ID may be comprised of four letters followed by six numbers in the format “AAAA######”. The user may select “Back/Correct” to go back to the previous form to edit the Chassis ID number.

The user may select “Plate Number” and enter the License Plate Number for the Chassis being added.

The user may select “Chassis Length” and enter the Chassis Length for the Chassis being added.

The user may select “Chassis Type” and enter the Chassis Type for the Chassis being added.

The user may select “Chassis Weight” and enter the weight for the Chassis being added.

For example, for all of the Outside Tires, which are four in all, two on the left, and two on the right, the user may select the Tire Manufacturer from the drop-down selection menu. The user may indicate if the tire is or is not a Retreaded Tire. The user may also indicate if the tire does or does not have a Cap. If the tire has a Cap, the user may provide the Cap Number in the space provided.

For example, for all of the Inside Tires, which are four in all, two on the left, and two on the right, the user may select the Tire Manufacturer from the drop-down selection menu. The user may indicate if the tire is or is not a Retreaded Tire. Inside Tires may not have Caps.

The user may select “Genset ID” to display the new Genset ID entered on the previous form. Each Chassis may have a unique Genset ID number. The user may select “Back/Correct” to go back to the previous form to edit the Genset ID number.

The user may select “Set Type” to enter the Set Type for the Genset being added.

If a Container has been involved in an Empty Reposition In, the user may be asked to ass any damage to the Container. After assessment of any damage that may have happened to the Container, the user may record information, such as EIR Date, Damage Description, Interior Clean, Damage Level, and Action on the Container EIR Form.

The field “EIR Date” should automatically appear. The Date/Time format may be recorded as: YYYY-MM-DD HH:MM.

The user may select “Damage Description” and enter the information in to the system. This information may be filled out by the user by typing freeform text into the Damage Description box, or by using preformatted damage descriptions in conjunction with the visual Container graphics. To fill out the Damage Description using the preformatted damage descriptions and visual Container graphics, the user may first select a Damage type from the drop-down options available. The user may then select the area of the Container graphics where the damage appears. The damage description may appear in text format in the Damage Description box. The user may then repeat the process to add as many damage descriptions as needed.

The user may select “Interior Clean” and enter if the interior of the Container is clean by selecting Yes (the interior is clean) or No (the interior is not clean).

For example, after the user has assessed the damage level of the Container, the user may select “Damage Level” and enter one of the following levels: None, meaning the Container in Perfect Condition; Green, meaning the Container has sustained minimal damage; Yellow, meaning the Container has sustained considerable amount of damage, yet should still be safe for use, and repairs should be considered; Red, meaning the Container is badly damaged and should be repaired as soon as possible.

The user may select “Action” and enter the appropriate action based on the Damage Level, to allow the Container to take on an Available status or to Reject the Container and send it to Maintenance and Repairs (M&R). The user may select either “Make Available” or “Send to M&R”. Once the Container EIR Form has been completely filled out, the user may select “Add” to continue the Empty Reposition In function.

To record any damage to the Chassis and the condition of the tires on the Chassis, the user may enter information, such as EIR Date, Damage Description, Tires, Damage Level, and Action to the Chassis EIR Form.

The field “EIR Date” may automatically appear. Date/Time format may be recorded as: YYYY-MM-DD HH:MM.

The user may select “Damage Description” and enter the information in to the system. This information may be filled out by the user by typing freeform text into the Damage Description box, or by using preformatted Parts list in conjunction with the Damage Type list. To fill out the Damage Description using the preformatted Parts and Damage Type list, the user may select a Part from the drop-down options available, and may further select a Damage Type from the drop-down options available. To add the damage description, the user may select “Add/Update” to enter the information in to the system. The damage description may appear in text format in the Damage Description box. The user may then repeat the process to add as many damage descriptions as needed.

The user may provide information, such as Outside Tires and Inside Tires, about the Tires on the Chassis. For all Outside Tires, the user may enter the Cap Number, if there is a cap, the Condition as good, fair, or poor, and the Tread depth. For all Inside Tires, the user may enter the Condition as good, fair, or poor, and the Tread depth.

For example, after the user has assessed the damage level of the Chassis, the user may select “Damage Level” and enter one of the following levels: None, meaning the Chassis in Perfect Condition; Green, meaning the Chassis has sustained minimal damage; Yellow, meaning the Chassis has sustained considerable amount of damage, yet should still be safe for use, and repairs should be considered; Red, meaning the Chassis is badly damaged and should be repaired as soon as possible.

The user may select “Action” and enter the appropriate action based on the Damage Level, to allow the Container to take on an Available status or to Reject the Container and send it to Maintenance and Repairs (M&R). The user may select either “Make Available” or “Send to M&R”.

Once the Chassis EIR Form has been completely filled out, the user may select “Update” to continue forward to the Genset EIR form. If there was no Genset associated with this Chassis, the user may select “Add” to complete the Empty Reposition In transaction.

If a Genset may be coming in with the Chassis, the user may need to provide information, such as EIR Date, Fuel Level, and Action on the Genset EIR Form.

The field “EIR Date” may automatically appear. Date/Time format may be recorded as: YYYY-MM-DD HH:MM.

The user may enter the Fuel Level by selecting Full, ¾, ½, ¼, or Empty.

The user may select “Action” and enter the appropriate action based on the Damage Level, to allow the Container to take on an Available status or to Reject the Container and send it to Maintenance and Repairs (M&R). The user may select either “Make Available” or “Send to M&R”. Once the Genset EIR Form has been completely filled out, the user may select “Add” to complete the Empty Reposition In transaction. The user may then select “Print” to print a receipt for the Trucker.

According to another aspect of the present invention, each user may be assigned a role, and each role may or may not have associated therewith one or more permissions. For example, a user may be an administrator, such as a gate administrator, and may not be required to have a permission. Such a user may engage in a task, such as entering the system via a handheld device and reaching the “Full Reposition Out” request screen. The Full Reposition Out function may allow the user to record when a Trucker leaves the Gate with a Full Container, or Cargo Item, that has been repositioned to another Terminal.

To reach the Full Reposition Out screen, the user may first select “Gate” from the handheld device screen, and then further select “Full Reposition Out”. The user may enter either the E-Code or the Container ID for the Full Reposition Out Cargo. The Booking Search Results screen may display a summary Cargo Record for the Cargo Items with the Container ID entered. The user may select the Cargo Record that matches the Cargo for the Full Reposition In and select “Next”.

The user may add and/or edit the Full Reposition Out Information, such as Gate Date, Container ID, Container Type, Size, Food Grade, Reefer Temperature Setting, Reefer Temperature Actual, Reefer Status, Reefer Instructions, Hazardous Material Type, Other Hazardous Material Description, Seal 1-4 Numbers, Chassis ID, Trucker Code, Genset ID, and Reposition To, for the Cargo.

The Gate Date information should automatically appear. The Date/Time format may be recorded as: YYYY-MM-DD HH:MM.

The user may select “Container ID” to display the Container ID for the Full Reposition Out Cargo.

The user may select “Size” to display the Container Size for the Full Reposition Out Cargo.

The user may select “Food Grade” to display the Food Grade for the Full Reposition Out Cargo.

The user may select “Reefer Temp. Setting” to indicate what the actual temperature for the Genset should read.

The user may select “Reefer Temp. Actual” to record the actual temperature on the Genset.

The user may select “Reefer Status” and enter the desired status. The user may select each status to read a definition of the selected status.

The field “Reefer Instructions” may allow the user to make note of any special handling instructions for the refrigerated cargo.

The user may select “Hazmat Type” to display any type of Hazardous Material being carried.

The user may select “Other Hazmat Desc” to display any other type of Hazardous Material not covered by the Hazmat Type displayed.

The user may select “Seal 1-4 Numbers” to display the Seal 1 Number and any additional Seal Numbers for the Full Reposition Out Cargo.

The user may select “Chassis ID” and enter or scan in the Chassis ID for the Full Reposition Out Cargo.

The user may select “Trucker Code” and enter or scan in the Trucker Code.

The user may select “Genset ID” and enter or scan in the Genset ID for the Full Reposition Out Cargo.

The user may select “Reposition To” and enter the name of the location where this Cargo was repositioned from. If the user enters a Trucker Code that the system does not recognize, the system may give the user the option to create a New Trucker Record or to correct the Trucker Code entered on the previous form.

In the event that any Equipment leaving the Terminal on a Full Reposition Out is new to the system, the user may be prompted to provide information, such as Customer ID, Container ID, Tare Weight, Container Type, Container Length, Food Grade, Chassis ID, Plate Number, Chassis Length, Chassis Type, Chassis Weight, Outside Tires, Inside Tires, Genset ID, and Set Type for the new Equipment Records.

The user may select “Customer ID” to display and edit the Customer ID for the customer, such as the shipping line, that owns the Equipment being added to the system.

The user may select “Container ID” to display the new Container. Each Container may have a unique Container ID number. The unique ID may be comprised of four letters followed by seven numbers in the format “AAAA#######”. The user may select “Back/Correct” to go back to the previous form to edit the ID number.

The user may select “Tare Weight” and enter the weight of the Container being added.

The user may select “Container Type” and enter the Container Type for the Container being added.

The user may select “Container Length” and enter the Container Length for the Container being added.

The user may select “Food Grade” and enter the Food Grade for the Container being added.

The user may select “Chassis ID” to display the new Chassis. Each Chassis may have a unique Chassis ID number. The unique ID may be comprised of four letters followed by six numbers in the format “AAAA######”. The user may select “Back/Correct” to go back to the previous form to edit the ID number.

The user may select “Plate Number” and enter the License Plate Number for the Chassis being added.

The user may select “Chassis Length” and enter the Chassis Length for the Chassis being added.

The user may select “Chassis Type” and enter the Chassis Type for the Chassis being added.

The user may select “Chassis Weight” and enter the weight of the Chassis being added.

For example, for all of the Outside Tires, the user may select the Tire Manufacturer from the drop-down selection menu and may indicate if the tire is or is not a Retreaded Tire. The user may also indicate if the tire does or does not have a Cap. If the tire has a Cap, the user may enter the Cap Number in the space provided.

For example, for all of the Inside Tires, the user may select the Tire Manufacturer from the drop-down selection menu and may indicate if the tire is or is not a Retreaded Tire.

The user may select “Genset ID” to display the new Genset ID. Each Chassis has a unique Genset ID number. The user may select “Back/Correct” to go back to the previous form to edit the Genset ID number.

The user may select “Set Type” and enter the Set Type for the Genset being added.

After assessment of any damage that may have happened to the Container, the user may record information, such as EIR Date, Damage Description, Interior Clean, Damage Level, and Action on the Container EIR Form.

The field “EIR Date” should automatically appear. The Date/Time format may be recorded as: YYYY-MM-DD HH:MM.

The user may select “Damage Description” and enter the information in to the system. This information may be filled out by the user by typing freeform text into the Damage Description box, or by using preformatted damage descriptions in conjunction with the visual Container graphics.

To fill out the Damage Description using the preformatted damage descriptions and visual Container graphics, the user may first select a Damage type from the drop-down options available. The user may then select the area of the Container graphics where the damage appears. The damage description may appear in text format in the Damage Description box. The user may then repeat the process to add as many damage descriptions as needed.

The user may select “Interior Clean” and indicate whether the interior of the container is or is not clean by selecting “Yes” or “No”, respectively.

For example, after the user has assessed the damage level of the Container, the user may select “Damage Level” and enter one of the following levels: None, meaning the Container in Perfect Condition; Green, meaning the Container has sustained minimal damage; Yellow, meaning the Container has sustained considerable amount of damage, yet should still be safe for use, and repairs should be considered; Red, meaning the Container is badly damaged and should be repaired as soon as possible.

The user may select “Action” and enter the appropriate action based on the Damage Level, to allow the Container to take on an Available status or to Reject the Container and send it to Maintenance and Repairs (M&R). The user may select either “Make Available” or “Send to M&R”. Once the Container EIR Form is completely filled out, the user may select “Add” to continue forward to the Chassis EIR form.

To record any damage to the Chassis and the condition of the tires on the Chassis, the user may enter information, such as EIR Date, Damage Description, Tires, Damage Level, and Action to the Chassis EIR Form.

The field “EIR Date” may automatically appear. Date/Time format may be recorded as: YYYY-MM-DD HH:MM.

The user may select “Damage Description” and enter the information in to the system. This information may be filled out by the user by typing freeform text into the Damage Description box, or by using preformatted Parts list in conjunction with the Damage Type list. To fill out the Damage Description using the preformatted Parts and Damage Type list, the user may select a Part from the drop-down options available, and may further select a Damage Type from the drop-down options available. To add the damage description, the user may select “Add/Update” to enter the information in to the system. The damage description may appear in text format in the Damage Description box. The user may then repeat the process to add as many damage descriptions as needed.

The user may provide information, such as Outside Tires and Inside Tires, about the Tires on the Chassis. For all Outside Tires, the user may enter the Cap Number, if there is a cap, the Condition, which may be good, fair, or poor, and the Tread depth. For all Inside Tires, the user may enter the Condition as good, fair, or poor, and the Tread depth.

For example, after the user has assessed the damage level of the Chassis, the user may select “Damage Level” and enter one of the following levels: None, meaning the Chassis in Perfect Condition; Green, meaning the Chassis has sustained minimal damage; Yellow, meaning the Chassis has sustained considerable amount of damage, yet should still be safe for use, and repairs should be considered; Red, meaning the Chassis is badly damaged and should be repaired as soon as possible.

The user may select “Action” and enter the appropriate action based on the Damage Level, to allow the Chassis to take on an Available status or to Reject the Chassis and send it to Maintenance and Repairs (M&R). The user may select either “Make Available” or “Send to M&R”. Once the Chassis EIR Form has been completely filled out, the user may select “Update” to continue forward to the Genset EIR form. If there was no Genset associated with the Chassis, the user may select “Add” to complete the Full Reposition Out transaction.

If a Genset may be coming in with the Chassis, the user may need to provide information, such as EIR Date, Fuel Level, and Action on the Genset EIR Form.

The field “EIR Date” may automatically appear. Date/Time format may be recorded as: YYYY-MM-DD HH:MM.

The user may enter the Fuel Level by selecting Full, ¾, ½, ¼, or Empty.

The user may select “Action” and enter the appropriate action based on the Damage Level, to allow the Genset to take on an Available status or to Reject the Genset and send it to Maintenance and Repairs (M&R). Once the Genset EIR Form has been completely filled out, the user may select “Add” to complete the Full Reposition Out transaction. The user may then select “Print” to print a receipt for the Trucker.

According to another aspect of the present invention, each user may be assigned a role, and each role may or may not have associated therewith one or more permissions. For example, a user may be an administrator, such as a gate administrator, and may not be required to have a permission. Such a user may engage in a task, such as entering the system via a handheld device and reaching the “Full Reposition In” request screen. The Full Reposition In function may allow the user to record when a Trucker brings a Full Container or Cargo Item to the Gate that has been repositioned from another Terminal.

To reach the Full Reposition In screen, the user may first select “Gate” from the handheld device screen, and then further select “Full Reposition In”. The user may enter the Booking Number for the Full Reposition In Cargo. The Booking Search Results screen may display a summary Cargo Record for all Cargo Items expected for the Booking. The user may select the Cargo Record that matches the Cargo for the Full Reposition In and select “Next”.

The user may add and/or edit the Full Reposition In Information, such as Gate Date, Container ID, Container Type, Size, Food Grade, Chassis ID, Genset ID, Reefer Temperature Setting, Reefer Temperature Actual, Reefer Status, Reefer Instructions, Scale Weight, Tractor Weight, Container Gross Weight, Hazardous Material Type, Other Hazardous Material Description, Seal 1, Seal 2-4, Over Dimensional?, Length, Width, Height, Trucker Code, and Repositioned From, for the Cargo.

The Gate Date information should automatically appear. The Date/Time format may be recorded as: YYYY-MM-DD HH:MM.

The user may select “Container ID” and either enter or scan in the Container ID for the Full Reposition In Cargo.

The user may select “Size” to display the Container Size for the Full Reposition In Cargo.

The user may select “Food Grade” to display the Food Grade for the Full Reposition In Cargo.

The user may select “Chassis ID” and enter or scan in the Chassis ID for the Full Reposition In Cargo.

The user may select “Genset ID” and enter or scan in the Genset ID for the Full Reposition In Cargo.

The user may select “Reefer Temp. Setting” to indicate what the actual temperature for the Genset should read.

The user may select “Reefer Temp. Actual” to record the actual temperature on the Genset.

The user may select “Reefer Status” and enter the desired status. The user may select each status to read a definition of the selected status.

The field “Reefer Instructions” may allow the user to make note of any special handling instructions for the refrigerated cargo.

The user may select “Scale Weight” and enter the scale weight for the truck and its cargo.

The user may select “Tractor Weight” and enter the weight of the tractor.

The user may select “Container Gross Weight” and enter the Container Gross Weight. If the user does not enter a value for Container Gross Weight, the system will calculate one automatically.

The user may select “Hazmat Type” to indicate the type of Hazardous Material being carried.

The user may select “Other Hazmat Desc” to display and enter any other type of Hazardous Material not covered by the Hazmat Type displayed.

The user may select “Seal 1” and either enter or scan the code for Seal 1. The Seal 1 information may be required by the system.

The user select “Seal 2-4” and either enter or scan the codes for any additional Seals for any containers that have more than one Seal.

The user may select “Over Dimensional?” and indicate “Yes” if the Cargo is Over Dimensional, or “No” if the Cargo is not Over Dimensional.

The user may select “Length” to enter the length of the cargo.

The user may select “Width” to enter the width of the cargo.

The user may select “Height” to enter the height of the cargo.

The user may select “Trucker Code” and enter or scan in the Trucker Code.

The user may select “Reposition From” and enter the name of the location where this Cargo was repositioned from. If the user enters a Trucker Code that the system does not recognize, the system may give the user the option to create a New Trucker Record or to correct the Trucker Code entered on the previous form. The user may select “Update” to continue with the Full Reposition In function.

In the event that any Equipment coming in to the Terminal on a Full Reposition In is new to the system, the user may be prompted to provide information, such as Customer ID, Container ID, Tare Weight, Container Type, Container Length, Food Grade, Chassis ID, Plate Number, Chassis Length, Chassis Type, Chassis Weight, Outside Tires, Inside Tires, Genset ID, and Set Type for the new Equipment Records.

The user may select “Customer ID” to display and edit the Customer ID for the customer, such as the shipping line, that owns the Equipment being added to the system.

The user may select “Container ID” to display the new Container. Each Container may have a unique Container ID number. The unique ID may be comprised of four letters followed by seven numbers in the format “AAAA#######”. The user may select “Back/Correct” to go back to the previous form to edit the ID number.

The user may select “Tare Weight” and enter the weight of the Container being added.

The user may select “Container Type” and enter the Container Type for the Container being added.

The user may select “Container Length” and enter the Container Length for the Container being added.

The user may select “Food Grade” and enter the Food Grade for the Container being added.

The user may select “Chassis ID” to display the new Chassis. Each Chassis may have a unique Chassis ID number. The unique ID may be comprised of four letters followed by six numbers in the format “AAAA######”. The user may select “Back/Correct” to go back to the previous form to edit the ID number.

The user may select “Plate Number” and enter the License Plate Number for the Chassis being added.

The user may select “Chassis Length” and enter the Chassis Length for the Chassis being added.

The user may select “Chassis Type” and enter the Chassis Type for the Chassis being added.

The user may select “Chassis Weight” and enter the weight of the Chassis being added.

For example, for all of the Outside Tires, the user may select the Tire Manufacturer from the drop-down selection menu and may indicate if the tire is or is not a Retreaded Tire. The user may also indicate if the tire does or does not have a Cap. If the tire has a Cap, the user may enter the Cap Number in the space provided.

For example, for all of the Inside Tires, the user may select the Tire Manufacturer from the drop-down selection menu and may indicate if the tire is or is not a Retreaded Tire.

The user may select “Genset ID” to display the new Genset ID. Each Chassis has a unique Genset ID number. The user may select “Back/Correct” to go back to the previous form to edit the Genset ID number.

The user may select “Set Type” and enter the Set Type for the Genset being added.

After assessment of any damage that may have happened to the Container, the user may record information, such as EIR Date, Damage Description, Interior Clean, Damage Level, and Action on the Container EIR Form.

The field “EIR Date” should automatically appear. The Date/Time format may be recorded as: YYYY-MM-DD HH:MM.

The user may select “Damage Description” and enter the information in to the system. This information may be filled out by the user by typing freeform text into the Damage Description box, or by using preformatted damage descriptions in conjunction with the visual Container graphics. To fill out the Damage Description using the preformatted damage descriptions and visual Container graphics, the user may first select a Damage type from the drop-down options available. The user may then select the area of the Container graphics where the damage appears. The damage description may appear in text format in the Damage Description box. The user may then repeat the process to add as many damage descriptions as needed.

The user may select “Interior Clean” and indicate whether the interior of the container is or is not clean by selecting “Yes” or “No”, respectively.

For example, after the user has assessed the damage level of the Container, the user may select “Damage Level” and enter one of the following levels: None, meaning the Container in Perfect Condition; Green, meaning the Container has sustained minimal damage; Yellow, meaning the Container has sustained considerable amount of damage, yet should still be safe for use, and repairs should be considered; Red, meaning the Container is badly damaged and should be repaired as soon as possible.

The user may select “Action” and enter the appropriate action based on the Damage Level, to allow the Container to take on an Available status or to Reject the Container and send it to Maintenance and Repairs (M&R). The user may select either “Make Available” or “Send to M&R”. Once the Container EIR Form is completely filled out, the user may select “Add” to continue forward to the Chassis EIR form.

To record any damage to the Chassis and the condition of the tires on the Chassis, the user may enter information, such as EIR Date, Damage Description, Tires, Damage Level, and Action to the Chassis EIR Form.

The field “EIR Date” may automatically appear. Date/Time format may be recorded as: YYYY-MM-DD HH:MM.

The user may select “Damage Description” and enter the information in to the system. This information may be filled out by the user by typing freeform text into the Damage Description box, or by using preformatted Parts list in conjunction with the Damage Type list. To fill out the Damage Description using the preformatted Parts and Damage Type list, the user may select a Part from the drop-down options available, and may further select a Damage Type from the drop-down options available. To add the damage description, the user may select “Add/Update” to enter the information in to the system. The damage description may appear in text format in the Damage Description box. The user may then repeat the process to add as many damage descriptions as needed.

The user may provide information, such as Outside Tires and Inside Tires, about the Tires on the Chassis. For all Outside Tires, the user may enter the Cap Number, if there is a cap, the Condition, which may be good, fair, or poor, and the Tread depth. For all Inside Tires, the user may enter the Condition as good, fair, or poor, and the Tread depth.

For example, after the user has assessed the damage level of the Chassis, the user may select “Damage Level” and enter one of the following levels: None, meaning the Chassis in Perfect Condition; Green, meaning the Chassis has sustained minimal damage; Yellow, meaning the Chassis has sustained considerable amount of damage, yet should still be safe for use, and repairs should be considered; Red, meaning the Chassis is badly damaged and should be repaired as soon as possible.

The user may select “Action” and enter the appropriate action based on the Damage Level, to allow the Chassis to take on an Available status or to Reject the Chassis and send it to Maintenance and Repairs (M&R). The user may select either “Make Available” or “Send to M&R”. Once the Chassis EIR Form has been completely filled out, the user may select “Update” to continue forward to the Genset EIR form. If there was no Genset associated with the Chassis, the user may select “Add” to complete the Full Reposition In transaction.

If a Genset may be coming in with the Chassis, the user may need to provide information, such as EIR Date, Fuel Level, and Action on the Genset EIR Form.

The field “EIR Date” may automatically appear. Date/Time format may be recorded as: YYYY-MM-DD HH:MM.

The user may enter the Fuel Level by selecting Full, ¾, ½, ¼, or Empty. The user may select “Action” and enter the appropriate action based on the Damage Level, to allow the Genset to take on an Available status or to Reject the Genset and send it to Maintenance and Repairs (M&R). Once the Genset EIR Form has been completely filled out, the user may select “Add” to complete the Full Reposition In transaction. The user may then select “Print” to print a receipt for the Trucker.

According to another aspect of the present invention, each user may be assigned a role, and each role may or may not have associated therewith one or more permissions. For example, a user may be an administrator, such as a gate administrator, and may not be required to have a permission. Such a user may engage in a task, such as entering the system via a handheld device and reaching the “Break-Bulk In” request screen. The Break-Bulk In function may be used when Break Bulk items arrive on the Terminal. The shipper, having made an Export Booking, may deliver the cargo to the terminal using their own truck. The terminal may then record the Unit ID, its length, width, height, weight, condition, which trucker delivered it, and the time and date of delivery.

To reach the Break-Bulk In screen, the user may first select “Gate” from the screen on a handheld device and then further select “Break-Bulk In”. The user may select and enter the “Booking Number”, or select the desired type of Break-Bulk, such as Break-Bulk (Loose freight such as crates, large pieces of machinery, spools of wire, bales, bags, trailers), Neo-Bulk (Loose freight that can be unitized), and RO-RO (Roll On/Roll Off), and enter the result by selecting “Search”. The Booking Search Results screen may display summary Cargo Records that match the Booking Number and Break-Bulk Type entered by the user. The user may select the box or boxes that apply to the Break-Bulk item(s) being accepted at the Gate. The user may provide Break-Bulk In Information, such as Gate Date and Trucker Code, for the system.

The “Gate Date” information may automatically appear. The Date/Time format may be recorded as: YYYY-MM-DD HH:MM.

For example the user may select “Trucker Code” and either enter or scan in the Trucker Code. The Trucker Code information may be required by the system.

The user may select “ADD” to continue with the Break-Bulk In function.

For each Break-Bulk item accepted, the user may provide the information, such as Unit ID, Weight, Length, Width, Height, and Remarks to update the system.

The user may select “Unit ID” and enter a Unit ID. The Unit ID may be any alphanumeric combination.

The user may select “Weight” and enter a Weight for the Break-Bulk item.

The user may select “Length” and enter a Length for the Break-Bulk item.

The user may select “Width” and enter a Width for the Break-Bulk item.

The user may select “Height” and enter a Height for the Break-Bulk item.

The user may inspect the condition of the Break-Bulk item and select “Remarks” to enter any remarks the user may have about its condition.

The user may select “Update” to accept the Break-Bulk item(s). The Status of the Break-Bulk item (s) Cargo Record(s) may change from “Booked” to “On Terminal”. The user may select “PRINT” to print a receipt for the Trucker and the Terminal.

According to another aspect of the present invention, each user may be assigned a role, and each role may or may not have associated therewith one or more permissions. For example, a user may be an administrator, such as a gate administrator, and may not be required to have a permission. Such a user may engage in a task, such as entering the system via a handheld device and reaching the “Add Trucker” request screen. The Add Trucker function may allow the user to add Trucker information into the system.

To reach the Add Trucker screen, the user may first select “Gate” from the handheld device screen, and then further select “Add Trucker”.

The user may add information, such as Trucker ID Code, Name, and Trucking Company for the Trucker.

The user may select “Trucker ID Code” and enter the trucker ID Code. The Trucker ID Code may be any alphanumeric combination but must be unique for each Trucker.

The user may select “Name” and enter the Trucker's name.

The user may select “Trucking Co” and enter the name of the Trucking Company that the trucker works for. When finished entering the desired information, the user may select “Add” to add the Trucker information to the system.

According to another aspect of the present invention, each user may be assigned a role, and each role may or may not have associated therewith one or more permissions. For example, a user may be an administrator, such as a gate administrator, and may not be required to have a permission. Such a user may engage in a task, such as entering the system via a handheld device and reaching the “Weigh LTL” request screen.

To reach the Weigh LTL screen, the user may first select “Gate” from the handheld device screen, and then further select “Weigh LTL”. The user may then enter either the E-Code or the Container ID, and select “Search” to obtain the search report.

The Weigh LTL results screen may display information, such as Gate Date, Container ID, Chassis ID, Scale Weight, Tracker Weight, Container Gross Weight, and Scale 1, for example, which may be edited by the user.

For example, the information “Gate Date” may automatically display the time and date, and may appear in the format: YYYY-MM-DD HH:MM

The information “Container ID” may automatically appear, and the user may verify the Container ID.

The user may select “Chassis ID” and enter the Chassis ID for the truck and its cargo.

The user may select “Scale Weight” and enter the scale weight for the truck and its cargo.

The user may select “Tractor Weight” and enter the tracker weight.

The user may select “Container Gross Weight” and enter the container gross weight for the container. If the user decides to leave this field empty, a value will be calculated by the system automatically.

The user may select “Seal 1” and either enter or scan the code for Seal 1.

When the user has completed editing the information, the user may select Update to enter it into the system.

According to another aspect of the present invention, each user may be assigned a role, and each role may or may not have associated therewith one or more permissions. For example, a user may be an administrator, such as a gate administrator, and may not be required to have a permission. Such a user may engage in a task, such as entering the system via a handheld device and reaching the “Weigh Yard” request screen.

To reach the Weigh Yard screen, the user may first select “Gate” from the handheld device screen, and then further select “Weigh Yard”. The user may then enter either the E-Code or the Container ID, and select “Search” to obtain the search report.

The Weigh Yard results screen may display information, such as Gate Date, Container ID, Chassis ID, Scale Weight, Tracker Weight, Container Gross Weight, and Scale 1, for example, which may be edited by the user.

For example, the information “Gate Date” may automatically display the time and date, and may appear in the format: YYYY-MM-DD HH:MM.

The information “Container ID” may automatically appear, and the user may verify the Container ID.

The user may select “Chassis ID” and enter the Chassis ID for the truck and its cargo.

The user may select “Scale Weight” and enter the scale weight for the truck and its cargo.

The user may select “Tractor Weight” and enter the tracker weight.

The user may select “Container Gross Weight” and enter the container gross weight for the container. If the user decides to leave this field empty, a value will be calculated by the system automatically.

The user may select “Seal I” and either enter or scan the code for Seal 1.

When the user has completed editing the information, the user may select Update to enter it into the system.

According to another aspect of the present invention, each user may be assigned a role, and each role may or may not have associated therewith one or more permissions. For example, a user may be an administrator, such as a gate administrator, and may not be required to have a permission. Such a user may engage in a task, such as entering the system via a handheld device and reaching the “Vehicle In” request screen.

To reach the Vehicle In screen, the user may either first select “Gate” from the handheld device screen, and then further select “Vehicle In”, or first select “CFS” from the handheld, and further select “Vehicle In”. On the Vehicle In screen, the user may then enter the Booking number and select “Submit”.

According to another aspect of the present invention, each user may be assigned a role, and each role may or may not have associated therewith one or more permissions. For example, a user may be an administrator, such as a gate administrator, and may not be required to have a permission. Such a user may engage in a task, such as entering the system via a handheld device and reaching the “Gov. Out” request screen.

To reach the Gov. Out screen, the user may first select “Gate” from the handheld device screen, and then further select “Gov. Out”. The user may then enter the Container ID, and select “Search”

According to another aspect of the present invention, each user may be assigned a role, and each role may or may not have associated therewith one or more permissions. For example, a user may be an administrator, such as a gate administrator, and may not be required to have a permission. Such a user may engage in a task, such as entering the system via a handheld device and reaching the “Gov. In” request screen.

To reach the Gov. In screen, the user may first select “Gate” from the handheld device screen, and then further select “Gov. In”. The user may then enter either the E-Code or the Container ID, and select “Search”.

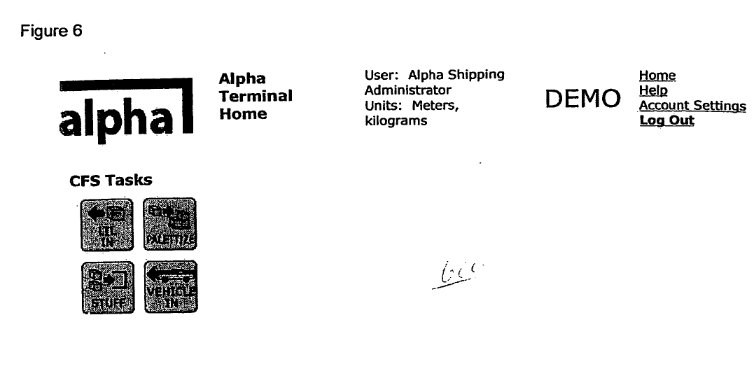

As illustrated in FIG. 6, the CFS function may allow the user to access and perform the various tasks required by a CFS administrator. Such tasks may include: LTL In, Stuff, Palletize, and Vehicle In.

According to another aspect of the present invention, each user may be assigned a role, and each role may or may not have associated therewith one or more permissions. For example, a user may be an administrator, such as a CFS administrator, and may not be required to have a permission. Such a user may engage in a task, such as entering the system via a handheld device and reaching the “Less Than Load In” request screen. The Less Than Load In function may be used when Less Than Load items arrive on the Terminal. Smaller packages or personal vehicles that may be consolidated into a container may be considered Less Than Load items. A container stuffed with multiple Less Than Load items may also have multiple Bookings or Bills Of Lading inside of it.

To reach the Less Than Load In screen, the user may first select “CFS” from the handheld device screen, and then further select “LTL In”. The user may then enter the Booking Number and select “Search”. The Booking Search Results screen may display expected Less Than Load items that match the Booking Number entered. The user may find the Package Type(s) and Commodity description(s) that match the Less Than Load In item(s). The user may then indicate the quantity delivered for each Less Than Load In item(s), and select “Next”.

The user may provide Less Than Load In Information, such as Delivery Date and Delivered By, for the Less Than Load item(s).

The field “Delivery Date” may automatically appear. The Date/Time may be displayed in the format “YYYY-MM-DD HH:MM”.

The user may select “Delivered By” and enter the name of the individual or company that may be delivering the Less Than Load In item(s). The Delivered By information may be required by the system. The user may select “ADD” to enter the information into the system.

For each Break-Bulk item accepted, the user may enter or edit information, such as Unit ID, Weight, Length, Width, Height, Package Type, Commodity, Remarks, and Warehouse Location, for the cargo.

The user may select “Unit ID” and enter a Unit ID. The Unit ID may be any alphanumeric combination.

The user may select “Weight” and enter a Weight for the Less Than Load item(s).

The user may select “Width” and enter a Width for the Less Than Load item(s).

The user may select “Height” and enter a Height for the Less Than Load item(s).

The user may select “Package Type” and enter a package type for the Less Than Load item(s).

The user may select “Commodity” and enter a Commodity for the Less Than Load item(s).

For example, after inspecting the condition of the Less Than Load Items, the user may select “Remarks” and record any remarks the user may have about the condition of the Less Than Load item(s).

The user may select “Warehouse Location” and enter a Warehouse Location for the Less Than Load item(s).

The user may select “Update” to accept the Less Than Load item(s). The user may also select “PRINT” to print a receipt for the Trucker and the Terminal.

According to another aspect of the present invention, each user may be assigned a role, and each role may or may not have associated therewith one or more permissions. For example, a user may be an administrator, such as a CFS administrator, and may not be required to have a permission. Such a user may engage in a task, such as entering the system via a handheld device and reaching the “Palletize” request screen. The Palletize function may be used to add Less Than Load items to a palette.

To reach the Palletize screen, the user may first select “CFS” from the handheld device screen, and then further select “Palletize”. The user may select the Customer, such as a shipping line, that the Palette may be shipped with. The user may then enter an ID for the Palette. Palette IDs may be any alphanumeric combination. Palette IDs do not have to be unique, however it is advised to keep the numbers as unique as possible. The user may select “Add” to add the Palette to the system. The user may enter the Unit ID to be added to the Palette. The user may select “Add to Palette” to add the desired Unit to the Palette. The user may repeat this step until all Units the user would like to add to the Palette have been added. The user may select “Done—Finish” when the user is done adding Units to the Palette. The user may provide New Palette Information, such as, Palette ID, Length, Width, Height, Hazardous Materials Summary, Weight Total, and Notes, to the system.

The user may select “Palette ID” to display the Palette ID.

The user may select “Length” and enter a length for the Palette.

The user may select “Width” and enter a width for the Palette.

The user may select “Height” and enter a height for the Palette.

The user may select “Hazmat Summary” to identify any Hazardous Material that may be included on the Palette.

The user may select “Weight Total” to edit the Total Weight of the Palette. The Weight may be automatically calculated by adding the weights of the Units added to the palette.

The user may select “Notes” to enter any additional notes about the Palette. The user may select “Update” to continue the Palletize function. The user may also select “PRINT” to print a receipt to affix to the palette.

According to another aspect of the present invention, each user may be assigned a role, and each role may or may not have associated therewith one or more permissions. For example, a user may be an administrator, such as a CFS administrator, and may not be required to have a permission. Such a user may engage in a task, such as entering the system via a handheld device and reaching the “Stuff” request screen. The Stuff function may be used to add Less Than Load items to a Container.

To reach the Stuff screen, the user may first select “CFS” from the handheld device screen, and then further select “Stuff”.

The user may provide information, such as Master Booking Number, Container ID, and Chassis ID for the container.

The user may select “Master Booking Number” and Enter the Master Booking Number for the Container to be Stuffed.

The user may select “Container ID” and enter the Container ID for the Container to be Stuffed.

The user may select “Chassis ID” and enter the Chassis ID for the Container to be Stuffed. The user may select “Add” to begin Stuffing the Container.

Alternatively, the user may also select “Resume Stopped Stuffing”, and enter the Container ID to return to a previous stuffing container task.

The user may then enter a Unit ID or Palette ID to be added to the Container. To do this, the user may select “Stuff” and add the desired Unit or Palette to the Container. The user may repeat this step until all Units and Palettes the user would like to add to the Container have been added. When the user is done adding Units and Palettes to the Container, the user may select “Done—Finish”. The user may provide Stuff Container Information, such as Container ID, Hazardous Material Type, Other Hazardous Material Type, and Seal 1 Number for the container.

The user may select “Container ID” to display the Container ID.

The user may select “Hazmat Type” and enter a Hazardous Material Type for the Stuffed Container.

The user may select “Other Hazmat Description” to identify any additional Hazardous Materials that may have been stuffed into the Container.

The user may select “Seal 1 Number” and enter the Seal 1 Number for the Stuffed Container.

The user may select “Update” button to continue the Stuff Container Function. The user may select “PRINT” to print a receipt of the Stuffed Container.

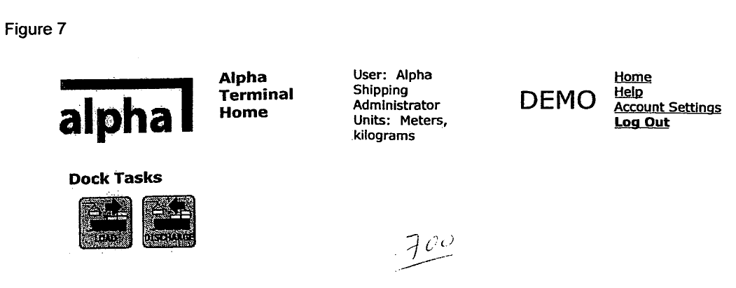

As illustrated in FIG. 7, the Dock function may allow the user to access and perform the various tasks required by a Dock administrator. Such tasks may include: Load and Discharge.

According to another aspect of the present invention, a user may be an administrator, and such a user may engage in a task, such as entering the system via a handheld device and reaching the “Load” request screen. To reach the Load screen, the user may first select “Dock” from the handheld device screen, and then further select “Load”.

To find a voyage, the user may select the field “Find a Voyage”, enter a Voyage ID and select “Find”. The user may also enter a number, indicating the number of days, into the field with the heading “Voyages for the next”, and then select “Go” to enter the information into the system. The voyage search may provide the voyage or voyages matching the entered search criteria, with information, such as Voyage, Vessel, Line, and Status.

For example, the information “Voyage” may display the Voyage ID for that particular voyage. The information “Vessel” may display the name of the particular vessel. The information “Line”, may display the three letter symbol for the particular shipping line. The information “Status” may display the status of the particular vessel. When the user has determined which Voyage he or she is interested in, the user may select “Go” for that particular voyage to display further information concerning that particular voyage, such as Voyage, Vessel, Customer, Estimated Arrival Date, Estimated Departure Date, and Actual Departure Date. If the user decides to select the voyage, the user may select “Select Voyage”. This may give the user the ability to search for Cargo. To search for Cargo, the user may enter either the last three digits of the Unit ID, or the entire Unit ID, and select “Search”. To search by stowage, the user may enter the stowage location and select “Search”. Alternatively, the user may select “Select a New Voyage” to return to the Load screen.

According to another aspect of the present invention, a user may be an administrator, and such a user may engage in a task, such as entering the system via a handheld device and reaching the “Discharge” request screen.

To reach the Discharge screen, the user may first select “Dock” from the handheld device screen, and then further select “Discharge”.

To find a voyage, the user may select the field “Find a Voyage”, enter a Voyage ID and select “Find”. The user may also enter a number, indicating the number of days, into the field with the heading “Voyages for the next”, and then select “Go” to enter the information into the system. The voyage search may provide the voyage or voyages matching the entered search criteria, with information, such as Voyage, Vessel, Line, and Status.

For example, the information “Voyage” may display the Voyage ID for that particular voyage. The information “Vessel” may display the name of the particular vessel. The information “Line”, may display the three letter symbol for the particular shipping line. The information “Status” may display the status of the particular vessel. When the user has determined which Voyage he or she is interested in, the user may select “Go” for that particular voyage to display further information concerning that particular voyage, such as Voyage, Vessel, Customer, Estimated Arrival Date, Estimated Departure Date, and Actual Departure Date. If the user decides to select the voyage, the user may select “Select Voyage”. This may give the user the ability to search for Cargo. To search for Cargo, the user may enter either the last three digits of the Unit ID, or the entire Unit ID, and select “Search”. To search by stowage, the user may enter the stowage location and select “Search”. Alternatively, the user may select “Select a New Voyage” to return to the Discharge screen.

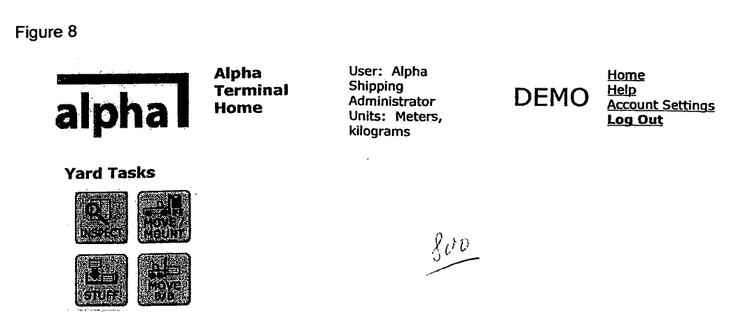

As illustrated in FIG. 8, the Yard function may allow the user to access and perform the various tasks required by the user. Such tasks may include: Inspect, Stuff, Move/Mount, and Move B/B.

According to another aspect of the present invention, each user may be assigned a role, and each role may or may not have associated therewith one or more permissions. For example, a user may be a manager, such as an equipment manager, and may not be required to have a permission. Such a user may engage in a task, such as entering the system via a handheld device and reaching the “Inspect” request screen. The Inspect function may be used to evaluate the condition of Containers and Chassis while they are idle in the yard. This may help to reduce the amount of Containers and Chassis that get rejected for Maintenance and Repair while leaving the Gate.

To reach the Inspect screen, the user may first select “Yard” from the handheld device screen, and then further select “Inspect”.

The user may either enter or scan the Equipment ID for the piece of equipment the user may be going to inspect. This may be a Container or a Chassis. The user may enter a Container ID or a Chassis ID, and depending upon the type of Equipment ID the user may enter, the user may be brought to the appropriate EIR Form.

If the user selects a Container ID, the user may assess any damage to the Container and record the information, such as EIR Date, Damage Description, Interior Clean, Damage Level, and Action, on the Container EIR Form.

After assessment of any damage that may have happened to the Container, the user may record information, such as EIR Date, Damage Description, Interior Clean, Damage Level, and Action on the Container EIR Form.

The field “EIR Date” should automatically appear. The Date/Time format may be recorded as: YYYY-MM-DD HH:MM.

The user may select “Damage Description” and enter the information in to the system. This information may be filled out by the user by typing freeform text into the Damage Description box, or by using preformatted damage descriptions in conjunction with the visual Container graphics. To fill out the Damage Description using the preformatted damage descriptions and visual Container graphics, the user may first select a Damage type from the drop-down options available. The user may then select the area of the Container graphics where the damage appears. The damage description may appear in text format in the Damage Description box. The user may then repeat the process to add as many damage descriptions as needed.

The user may select “Interior Clean” and indicate whether the interior of the container is or is not clean by selecting “Yes” or “No”, respectively.

For example, after the user has assessed the damage level of the Container, the user may select “Damage Level” and enter one of the following levels: None, meaning the Container in Perfect Condition; Green, meaning the Container has sustained minimal damage; Yellow, meaning the Container has sustained considerable amount of damage, yet should still be safe for use, and repairs should be considered; Red, meaning the Container is badly damaged and should be repaired as soon as possible.

The user may select “Action” and enter the appropriate action based on the Damage Level, to allow the Container to take on an Available status or to Reject the Container and send it to Maintenance and Repairs (M&R). The user may select either “Make Available” or “Send to M&R”. Once the Container EIR Form is completely filled out, the user may select “Add” to record the condition of the Container.

To record any damage to the Chassis and the condition of the tires on the Chassis, the user may enter information, such as EIR Date, Damage Description, Tires, Damage Level, and Action to the Chassis EIR Form.

The field “EIR Date” may automatically appear. Date/Time format may be recorded as: YYYY-MM-DD HH:MM.

The user may select “Damage Description” and enter the information in to the system. This information may be filled out by the user by typing freeform text into the Damage Description box, or by using preformatted Parts list in conjunction with the Damage Type list. To fill out the Damage Description using the preformatted Parts and Damage Type list, the user may select a Part from the drop-down options available, and may further select a Damage Type from the drop-down options available. To add the damage description, the user may select “Add/Update” to enter the information in to the system. The damage description may appear in text format in the Damage Description box. The user may then repeat the process to add as many damage descriptions as needed.

The user may provide information, such as Outside Tires and Inside Tires, about the Tires on the Chassis. For all Outside Tires, the user may enter the Cap Number, if there is a cap, the Condition as good, fair, or poor, and the Tread depth. For all Inside Tires, the user may enter the Condition as good, fair, or poor, and the Tread depth.

For example, after the user has assessed the damage level of the Chassis, the user may select “Damage Level” and enter one of the following levels: None, meaning the Chassis in Perfect Condition; Green, meaning the Chassis has sustained minimal damage; Yellow, meaning the Chassis has sustained considerable amount of damage, yet should still be safe for use, and repairs should be considered; Red, meaning the Chassis is badly damaged and should be repaired as soon as possible.

The user may select “Action” and enter the appropriate action based on the Damage Level, to allow the Chassis to take on an Available status or to Reject the Chassis and send it to Maintenance and Repairs (M&R). The user may select either “Make Available” or “Send to M&R”. Once the Chassis EIR Form has been completely filled out, the user may select “Add” to record the condition of the Chassis.

According to another aspect of the present invention, each user may be assigned a role, and each role may or may not have associated therewith one or more permissions. For example, a user may be a manager, such as an equipment manager, and may not be required to have a permission. Such a user may engage in a task, such as entering the system via a handheld device and reaching the “Stuff” request screen.

To reach the Stuff screen, the user may first select “Yard” from the handheld device screen, and then further select “Stuff”.

The user may provide information, such as Master Booking Number and the Container/Flat Rack ID, to enter into the system.

The user may select “Master Booking Number” and Enter the Master Booking Number for the Container to be Stuffed.

The user may select “Container/Flat Rack ID” and enter the Container/Flat Rack ID for the Container to be Stuffed.

The user may select “Add” to begin Stuffing the Container.

Alternatively, the user may also select “Resume Stopped Stuffing”, and enter the Container ID to return to a previous stuffing container task.

According to another aspect of the present invention, each user may be assigned a role, and each role may or may not have associated therewith one or more permissions. For example, a user may be a manager, such as an equipment manager, and may not be required to have a permission. Such a user may engage in a task, such as entering the system via a handheld device and reaching the “Move/Mount” request screen.

To reach the Move/Mount screen, the user may first select “Yard” from the handheld device screen, and then further select “Move/Mount”. The user may then enter information, such as Genset ID, Container ID, and Chassis ID, to add to the system.

When the user has entered the desired information, the user may select “Add” to add the information into the system.

According to another aspect of the present invention, each user may be assigned a role, and each role may or may not have associated therewith one or more permissions. For example, a user may be a manager, such as an equipment manager, and may not be required to have a permission. Such a user may engage in a task, such as entering the system via a handheld device and reaching the “Move B/B” request screen.

To reach the Move B/B screen, the user may first select “Yard” from the handheld device screen, and then further select “Move B/B”. The user may then enter the Unit ID and select “Search”.

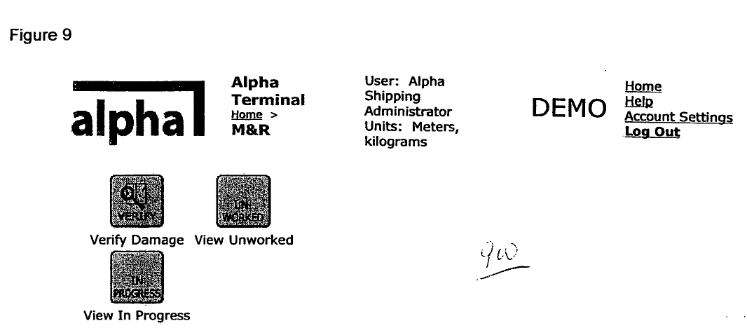

As illustrated in FIG. 9, the M&R function may allow the user to access and perform the various tasks required by the user. Such tasks may include: Verify, Unworked, and In Progress.

According to another aspect of the present invention, a user may be a manager, such as an equipment manager, and such a user may engage in a task, such as entering the system via a handheld device and reaching the “Verify” request screen. This may allow the user to enter or verify any damage that may have occurred to a particular Unit.

To reach the Verify screen, the user may first select “M&R” from the handheld device screen, and then further select “Verify”. The user may then enter the Unit ID and select “Search”. The search report may display one or more units covering information, such as Unit ID, Damage, and Owner, for the unit in question.

For example, the information “Unit ID” may display the Unit ID number associated with that particular unit. The information “Damage” may display any combination of the defined damage levels. “None” may indicate the unit may be in Perfect Condition. “Green” may indicate the unit may have sustained minimal damage. “Yellow” may indicate the unit may have sustained a considerable amount of damage, yet should still be safe for use, although the user may consider repairs. “Red” may indicate the unit may be badly damaged and should be repaired as soon as possible. The information “Owner” may display the name of the owner associated with the particular Unit ID. If the user decides to return to the M&R screen, the user may select “Return to M&R”.

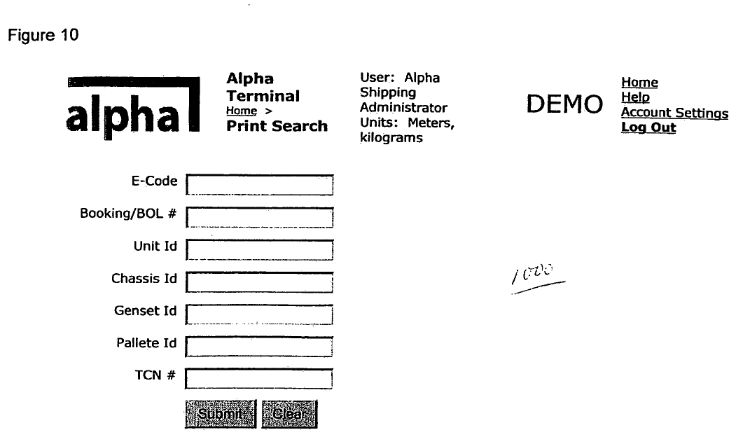

The present invention also may provide a printing system. Such a system may include any number of printers within a network of printers associated with the shipping system. For example, a handheld device may translate between native codes of the printers, such that each printer is independently recognized. Further, printers may be coupled to the printing network, such that printing may be performed via wired and/or wireless connection, such as, for example, Bluetooth and Wi-Fi systems, such that remote access may be available to a plurality of printer drivers, and may be translated seamlessly throughout. According to another aspect of the present invention, a user may be a manager, such as an equipment manager, and such a user may engage in a task, such as entering the system via a handheld device and reaching the “Print” request screen, as illustrated in FIG. 10. This may allow the user to print a report or receipt for the particular information searched for.

To reach the Print screen, the user may select “Print” from the handheld device screen.

To search for the report desired to print, the user may enter information, such as E-Code, Booking/BOL Number, Unit ID, Chassis ID, Genset ID, Palette ID, and TCN Number, to conduct the search. When the information has been entered, the user may select Submit to enter the information into the system. The user may then verify the report, and if it is correct, the user may select “Print”. If the user may decide to perform a different search, the user may select “New Search”.

In another exemplary embodiment of the present invention, a user may view or edit aspects of particular voyages existing within the system. For example, at any given point in time, a variety of voyages may be scheduled. The status of these voyages may be seen, allowing a user to see, for example, whether a particular voyage is scheduled for import, export, arriving at port or leaving port, docked, or in transit. A voyage may also be representative of any form of transport, such as, for example, by ship, boat, aircraft, train, truck, or any other form used for transport of cargo.

In a manner similar to the information incorporated into individual cargo item reports, information relating to a particular voyage may also be included into various reports, which may further be associated with a unique identifier for that voyage. Voyages may also be tagged as “hot” or prioritized in a way easily recognizable by a user or other personnel. Such a tagging system may also include a graded or multi-tier priority level format, allowing any number of voyages be prioritized as needed. Additionally, this information may be incorporated into statistical information related to that particular voyage, or into a collection of several voyages, to provide data to a user to aid decision making situations.

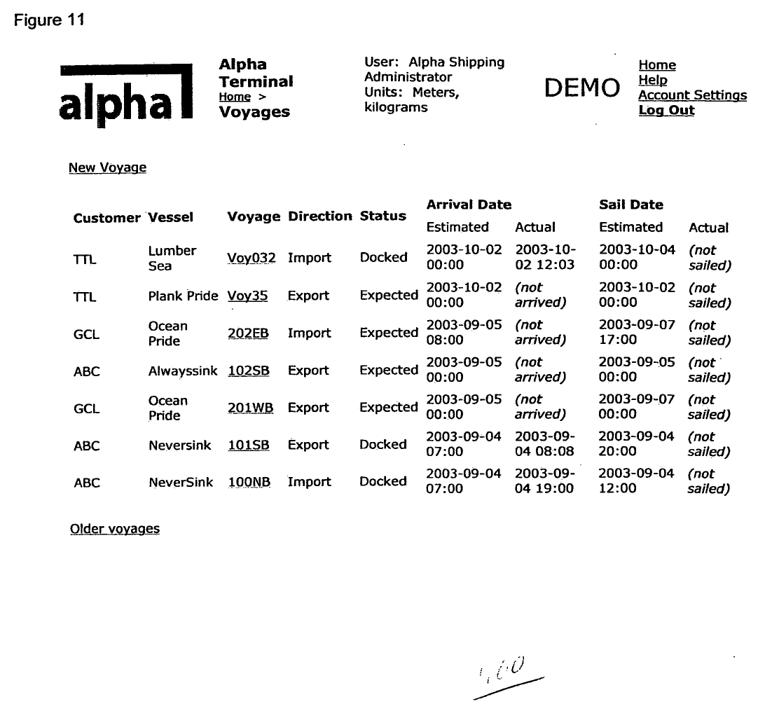

According to another aspect of the present invention, a user may be defined as a terminal administrator, or a line administrator, and may have a permission, such as the ability to manage voyages. Such a user may engage in a task, such as entering the system via the general entry and reaching the “Voyages” request screen, as illustrated in FIG. 11. The voyages function may be used to display voyages that are expected, docked, or may have sailed within the last three days. This may be thought of as an “active voyage” list. To reach the Voyages screen, the user may select “Voyages” from the View Current section of the Main Menu. From the Voyages screen a user also may have the ability to Create a New Voyage, View Voyage Cargo, and View Older Voyages.

The Voyages screen displays information such as Customer, Vessel, Voyage, Direction, Status, Estimated Arrival Date, Actual Arrival Date, Estimated Sail Date, and Actual Sail Date.

The field “Customer” may display the Customer ID for the customer, such as the shipping line, that owns the Vessel that may be carrying out the Voyage. If the user is a Customer User, the user may not be able to select a Customer ID.

The field “Vessel” may display the name of the Vessel that may be carrying out the Voyage. If the user is an Internal User, the user may have access to all Vessels. If the user is a Customer User, the user may have access to Vessels relating to their Line.

The field “Voyage” may display the Voyage Code. Voyage Codes may be any alphanumeric combination. Voyage codes do not have to be unique, but it is strongly advised to keep these codes unique. The Voyage Code may link the user to the View Voyage Cargo screen. If the user is an Internal User, the user may have access to all Voyages. If the user is a Customer User, the user may have access to Voyages relating to their Line.

The field “Direction” may display the direction of the Voyage. It may also indicate if the Voyage is an Import or an Export.

The field “Status” may display the Voyage Status as Expected, Docked, or Sailed. The Expected Voyage Status may have a yellow background, the Docked Voyage Status may have a salmon background, and the Sailed Voyage Status may have a gray background.

The field “Estimated Arrival Date” may display the Estimated Arrival Date for the Vessel that may be carrying out the Voyage. If an Estimated Arrival Date is specified but an Actual Arrival Date is not, the Status may default to “Expected”.

The field “Actual Arrival Date” may display the Actual Arrival Date for the Vessel that may be carrying out the Voyage. Once an Actual Arrival Date is entered, the Status may change to “Docked”.

The field “Estimated Sail Date” may display the Estimated Sail Date for the Vessel that may be carrying out the Voyage.

The field “Actual Sail Date” may display the Actual Sail Date for the Vessel that may be carrying out the Voyage. Once the user enters an Actual Sail Date, the Status may change to “Sailed”.

To View Older Voyages, the user may select “Older Voyages” from the Voyages screen. This may display a screen similar to the Voyages screen. The difference is that Older Voyages only displays voyages that sailed more than three days ago. The user may select “Back to Current Voyages” to return to the Voyages screen.

To Create a New Voyage, the user may select “New Voyage” from either the Voyages screen or the Older Voyages screen. The user may also Create a New Voyage by selecting “Voyages” from the Add section of the Main Menu. The user may then provide information, such as Customer, Vessel Name, Voyage Code, Direction, Estimated Arrival Date, Actual Arrival Date, Estimated Sail Date, and Actual Sail Date, for example, to create the new voyage.

For example, the user may select the “Customer ID” for the customer that owns the Vessel that may be carrying out the Voyage. If the user is a Customer User, the user may not have the option to select a Customer ID.

The user may also select “Vessel Name” and may enter the name of the Vessel that may be carrying out the Voyage. The user may be required to enter a Vessel Name to complete the creation of a new voyage.

The user may select “Voyage Code” and may enter a Voyage Code for the voyage. Voyage Codes may be any alphanumeric combination. Voyage codes do not have to be unique, but it is strongly advised to keep these codes unique. The user may be required to enter a Voyage Code to complete the creation of a new voyage.

The user may select “Direction” and may indicate the direction of the Voyage. The direction of the Voyage may be either Import or Export. The user may be required to enter a Direction to complete the creation of a new voyage.

The user may select “Estimated Arrival Date” and may enter the Estimated Arrival Date for the Vessel that may be carrying out the Voyage. If the user specifies an Estimated Arrival Date without specifying an Actual Arrival Date, the Status may default to “Expected”. Also, if the user does not specify both an Estimated Arrival Date and an Actual Arrival Date, the Status on the Current Voyages screen may default to “Expected” and the Estimated Arrival Date may display “ERROR: not specified”.

The user may select “Actual Arrival Date” and may enter the actual arrival date for the Vessel that may be carrying out the Voyage. When the user has entered the Actual Arrival Date, the Status may change to “Docked”.

The user may select “Estimated Sail Date” and may enter the Estimated Sail Date for the Vessel that may be carrying out the Voyage. If the user does not enter an Estimated Sail Date and the user has not specified an Actual Sail Date, the Estimated Arrival Date on the Current Voyages screen may display “ERROR: not specified”.

The user may select “Actual Sail Date” and may enter the Actual Sail Date for the vessel that may be carrying out the Voyage. When the user has entered the Actual Sail Date, the Status may change to “Sailed”.

When the desired information has been entered by the user, the user may select “Add” to add the Voyage to the system and complete the creation of a new voyage.

The user may also select “Current Voyages” from the general section of the Main Menu, which sends the user to the View Voyage Cargo screen. From the View Voyage Cargo screen, the user may access links to other screens that may allow the user to view information, such as dock a vessel, discharge cargo, roll cargo to other voyages, load cargo, and sail vessels, for example, to further manage voyages.

To View Voyage Cargo, the user may select the “Voyage Code” from the Voyages screen. The View Voyage Cargo screen may display Voyage information, such as Voyage, Customer, Vessel, Direction, Status, Arrival Date, Sail Date, and Edit Voyage Details, for example, allowing the user to change the Status of the Voyage, such as from Expected to Docked to Sailed, as well as Edit Voyage Details, display the Voyage Cargo, and Edit Voyage Cargo.

The field “Voyage” may display the Voyage Code. Voyage Codes may be any alphanumeric combination. Voyage codes do not have to be unique, but it may be strongly advised to keep these codes unique. If the user is an Internal User, the user may have access to all Voyages. If the user is a Customer User, the user may have access to Voyages relating to their Line.

The field “Customer” may display the Customer ID for the customer that owns the Vessel that may be carrying out the Voyage.

The field “Vessel” may display the name of the vessel that may be carrying out the Voyage. If the user is an Internal User, the user may have access to all Vessels. If the user is a Customer User, the user may have access to Vessels relating to their Line.

The field “Direction” may display the direction of the Voyage. It may indicate whether the Voyage is an Import or an Export.

The field “Status” may display and edit the status of the Voyage. Voyage Statuses may be “Expected”, as may be indicated by a yellow background, “Docked”, as may be indicated by a salmon background, or “Sailed”, as may be indicated by a gray background. If the Voyage Status is “Expected”, the user may change the Status by selecting “DOCK Vessel” and may enter the Status as “Docked”. If the Voyage Status is “Docked”, the user may change the Status by selecting “SAIL Vessel” and may enter the Status as “Sailed”. If the Voyage Status is “Sailed”, the user may not edit the Status.

The field “Arrival Date” may display the Estimated Arrival Date and Actual Arrival Date if the information has been specified for the Vessel that may be carrying out the Voyage.

The field “Sail Date” may display the Estimated Sail Date and Actual Sail Date if the information has been specified for the Vessel that may be carrying out the Voyage.

The field “Edit Voyage Details” may allow the user to Edit Voyage Details.

The user may display Voyage cargo information, such as E-Code, Status, Unit ID, Cargo Type, Load, and Discharge, for example, in further management of Voyages.

The field “E-Code” may display the E-Code for each Cargo Record assigned to a Voyage. The E-Code may be unique to each Cargo Record and may be assigned automatically by the system. The user may select “E-Code” from the Voyage Cargo list, which takes the user to the Cargo Edit screen for the selected E-Code.

The field “Status” may display the Status of the Cargo. The user may select “Status” to view the status assigned to a Voyage.

The field “Unit ID” may display the Unit ID of the Cargo assigned to a Voyage. A Unit ID may be a Container ID, LTL ID, or Break-Bulk ID. If the Cargo being shipped is an “Empty Container”, the user may have the option to assign a specific Container to be shipped as the Empty Equipment.

The field “Cargo Type” may display the Cargo Type of the Cargo assigned to a Voyage. A Cargo Type may be any type of Container, Break-Bulk, Neobulk, LTL Cargo, RO-RO Cargo, or Empty Equipment.

If the Voyage Status is “Expected”, the “Load” column may not be applicable. If the Voyage Status is “Docked”, cargo that has a status of “On Terminal” may be marked “loaded”. To do this, the user may select the checkbox in the load column indicating “LOAD Checked Cargo” at the bottom of the Voyage Cargo List. Once Loaded, the Equipment Status may change from “On terminal” to “Completed”.

If the Voyage Status is “Sailed”, the Load column may change to the Discharge column. This may display the date and time the Cargo was discharged.

To Assign a container to an Empty Equipment request, the user may select “Assign” from the Unit ID column for the Empty Equipment Cargo the user would like to assign a container to. The system may return a list of Containers that match the requested Container Type, Length, and Food Grade requested. The system may also display the Container ID, Status, Damage Level, and Yard Location for each Container that matches. To assign one of the Containers, the user may indicate the desired Container and select “Assign Container”. Once selected, the user may be returned to the View Voyage Cargo screen. Once the Container is assigned as the Empty Equipment Cargo, the Cargo Status for the Cargo Record may change to “On Terminal” and the selected Container ID may appear in the Unit ID column for the Cargo Record.

To Edit Voyage Details, the user may select “Edit Voyage Details” from the Voyage Information section of the View Voyage Cargo screen. The Edit Voyage screen may give the user the option to edit information, such as Customer, Vessel Name, Voyage Code, Direction, Estimated Arrival Date, Actual Arrival Date, Estimated Sail Date, and Actual Sail Date, for example, of the record of the Voyage in the system.

For example, by selecting “Customer”, the user may edit the Customer ID for the customer that owns the Vessel that may be carrying out the Voyage. If the user is a Customer User, the user may not have the option to select a Customer ID.

By selecting “Vessel Name”, the user may edit the name of the Vessel that may be carrying out the Voyage. The Vessel Name may be required by the system.

By selecting “Voyage Code” the user may edit a Voyage Code for the Voyage. Voyage Codes may be any alphanumeric combination. Voyage codes do not have to be unique, but may be unique, or substantially unique. The Voyage Code information may be required by the system.

By selecting “Direction”, the user may edit the direction of the Voyage, to either Import or Export. The direction information may be required by the system.

By selecting “Estimated Arrival Date”, the user may edit the Estimated Arrival Date for the Vessel that may be carrying out the Voyage. If an Estimated Arrival Date is specified by the user but an actual Arrival Date is not, the Status may default to “Expected”. If there is no Estimated Arrival Date and no Actual Arrival Date has been specified by the user, the Status on the Current Voyages screen may default to “Expected” and the Estimated Arrival Date may display “ERROR: not specified”.

For example, by selecting “Actual Arrival Date”, the user may edit the Actual Arrival Date for the Vessel that may be carrying out the Voyage. Once an Actual Arrival Date is entered by the user, the Status may change to “Docked”.

By selecting “Estimated Sail Date”, the user may edit the Estimated Sail Date for the Vessel that may be carrying out the Voyage. If there is no Estimated Sail Date and an Actual sail Date has not been specified by the user, the Estimated Arrival Date on the Current Voyages screen may display “ERROR: not specified”.

By selecting “Actual Sail Date”, the user may edit the Actual Sail Date for the Vessel that may be carrying out the Voyage. Once an Actual Sail Date has been entered by the user, the Status may change to “Sailed”.

To update the record of the Voyage in the system, the user may select “Update” to record the changes to the specified information of the Voyage in to the system.

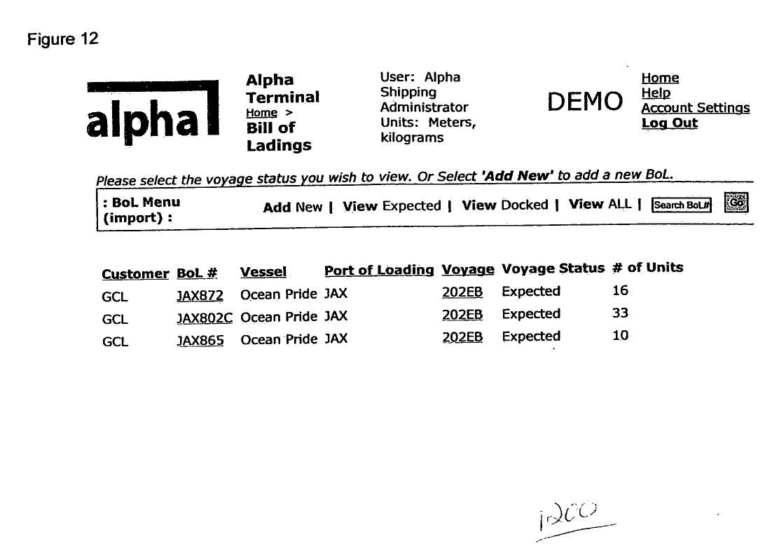

According to another aspect of the present invention, a user may be a terminal administrator or a line administrator, and may have a permission, such as the ability to manage bills of lading. Such a user may enter the system via the general entry and reach the “BOL (Import)” request screen, as illustrated in FIG. 12. The Bills of Lading function may be used for tasks, such as to view Current Bills of Lading, view Older Bills of Lading, create a new Bill of Lading, edit Bill of Lading details, and add cargo to the Bill of Lading, for example. The Bills of Lading screen may display Bills of Lading that may be expected, docked, or have sailed within the last three days. The Current Bills of Lading may be thought of as an “active voyage” list.

The Bills of Lading screen may allow the user to reach the View Bill of Lading screen. From the View Bill of Lading screen the user may reach other screens that may allow the user to view voyage details, edit Bills of Lading, add Cargo to a Bill of Lading, or edit a Cargo record associated with a Bill of Lading.

To view “Bills of Lading”, the user may select “BOL (Import)” from the View Current section of the Main Menu. The Bills of Lading will display information, such as Customer, Bill of Lading Number, Vessel, Port of Loading, Voyage, Voyage Status, and Number of Units, for example, that may be viewed by the user.

The field “Customer” may display the Customer ID for the customer that owns the Vessel that may be carrying out the Voyage. If the user is a Customer User, the user may not see the Customer ID.

The field “Bill of Lading Number” may display the Bill of Lading Number, and may allow the user to reach the View Bill of Lading screen.

The field “Vessel” may display the name of the Vessel that may be carrying the Cargo associated with the Bill of Lading. If the user is an Internal User, the user may have access to all Vessels. If the user is a Customer User, the user may have access to Vessels relating to their Line.

The field “Port of Loading” may display the symbol for the particular Port for loading the vessel.

The field “Voyage” may display the Voyage Code for the Vessel carrying the Cargo associated with the Bill of Lading. If the user is an Internal User, the user may have access to all Voyages. If the user is a Customer User, the user may have access to Voyages relating to their Line.

The field “Voyage Status” may display the Voyage Status. Voyage Statuses may be Expected, as may be indicated by a yellow background, Docked, as may be indicated by a salmon background, or Sailed, as may be indicated by a gray background.

The field “Number of Units” may display the total number of units associated with that particular Bill of Lading Number.

To View Older Bills of Lading, the user may select “Older Bills of Lading” from the Current Bills of Lading screen. This may display a screen similar to the View Current Bills of Lading screen. The difference may be that Older Bills of Lading only displays Bills of Lading that docked more than three days ago.

The user may return to the Current Bills of Lading screen by selecting “Back to current Bills of Lading” from the Older Bills of Lading screen.

To Create a New Bill of Lading, the user may select “Add New” from the Current Bills of Lading screen or the Older Bills of Lading screen. The user may provide information, such as Bill of Lading Number, Customer, Voyage, Load Port, Discharge Port, and Shipper, for example, to Create a New Bill of Lading.

For example, the user may select “Bill of Lading Number” and enter a Bill of Lading number for the New Bill of Lading. Bill of Lading numbers may be any alphanumeric combination. Bill of Lading numbers do not have to be unique, but it is strongly advised to keep these codes unique. The Bill of Lading Number information may be required by the system.

The user may select “Customer” and enter the Customer ID for the customer that owns the Vessel that may be carrying the Cargo associated with the new Bill of Lading. If the user is a Customer User, the user may not have the option to select a Customer ID.

The user may select “Voyage” and enter a Voyage Code for the Voyage associated with the Vessel that may be carrying the Cargo associated with the new Bill of Lading. If the user is an Internal User, the user may have access to all Voyages. If the user is a Customer User, the user may have access to Voyages relating to their Line.

The user may select “Load Port” and enter the name of the Port where the Cargo may be loaded.

The user may select “Discharge Port” and enter the name of the Port where the Cargo may be discharged.

The user may select “Shipper” and enter any necessary Shipper information. This field may contain the name and optional physical address of the Shipper of the Cargo that the Line may have been contracted to carry.

Once the new information has been entered by the user, the user may select “Add” to add the new Bill of Lading information to the system.

To View Bill of Lading, the user may select “Bill of Lading Number” from the Current Bill of Lading screen. The View Bill of Lading screen may display Bill of Lading information, and allow the user to perform tasks, such as Edit Bill of Lading Details, Add Cargo to the Bill of Lading, Edit Cargo associated with the Bill of Lading, view the E-Code for a Cargo item associated with the Bill of Lading, and also reach the View Voyage screen, for example. The View Bill of Lading Cargo screen may display bill of lading information, such as Customer, Bill of Lading Number, Shipper, Vessel, Voyage, and Voyage Status, for example, for the user.

For example, the field “Customer” may display the Customer ID for the customer that owns the Vessel that may be carrying the Cargo associated with this Bill of Lading.

The field “Bill of Lading Number” may display the Bill of Lading Number for the Bill of Lading the user may be viewing.

The field “Shipper” may display the name of the Shipper for the Cargo associated with the Bill of Lading.

The field “Vessel” may display the name of the Vessel that may be carrying the Cargo associated with the Bill of Lading.

The field “Voyage” may display the Voyage Code. The user may select “Voyage Code” to reach the View Voyage screen.

The field “Voyage Status” may display the Voyage Status. Voyage Statuses may be Expected, as may be indicated by a yellow background, Docked, as may be indicated by a salmon background, or Sailed, as may be indicated by a gray background.

The View Bill of Lading Cargo screen may display Bill of Lading Cargo information, such as Customer, Unit ID, Status, Cargo Type, Container Type, Container Length, Food Grade, Reference Number, TCN, Action, and E-Code, for example, for the user.

For example, the field “Customer” may display the Customer ID for the customer that owns the Vessel that may be carrying the Cargo associated with the Bill of Lading. If the user is a Customer User, the user may not see the Customer ID.

The field “Unit ID” may display the Unit ID of the Cargo assigned to the Bill of Lading. A Unit ID may be a Container ID, LTL ID, or Break-Bulk ID, for example.

The field “Status” may display the Status of the Cargo assigned to this Bill of Lading. While a voyage may have a status of “Expected”, the Cargo may have a status of “Inbound”. Once the vessel docks and the cargo is discharged, the cargo status may change to “On Terminal” or, as may be the case for Empty Equipment, “Completed”.

The field “Cargo Type” may display the Cargo Type of the Cargo assigned to the Bill of Lading. A Cargo Type may be any type of Container, Break-bulk, Neobulk, LTL Cargo, RO-RO Cargo, or Empty Equipment, for example.

The field “Container Type” may display the type of Container the Cargo associated with the Bill of Lading may be shipped in.

The field “Container Length” may display the length of the Container the Cargo associated with the Bill of Lading may be shipped in.

The field “Food Grade” may display the Food Grade of the Container the Cargo associated with the Bill of Lading may be shipped in.

The field “Reference Number” may display the Reference Number for the Cargo associated with the Bill of Lading.

The field “TCN” may display the Transportation Control Number for the Cargo associated with the Bill of Lading.

The field “Action” may allow the user to select “Edit” to enter changes to a Cargo record associated with the Bill of Lading.

The field “E-Code” may display the E-Code for each Cargo Record assigned to the Bill of Lading. The E-Code may be unique to each Cargo Record and may be assigned automatically by the system. Clicking on the E-Code in the Bill of Lading Cargo list may show the user a graphic of the bar-code for this Cargo Record.

To Edit Bill of Lading Details, the user may select “Edit Bill of Lading Details” from the View Bill of Lading screen. The Edit Bill of Lading Details screen may display and/or may allow the user to edit details, such as Bill of Lading Number, Customer, Voyages, Load Port, Discharge Port, and Shipper, for example, of the Bill of Lading record in the system.

For example, the user may select “Bill of Lading Number” and enter the Bill of Lading Number for the Bill of Lading. Bill of Lading numbers may be any alphanumeric combination. Bill of Lading numbers do not have to be unique, but it is strongly advised to keep these codes unique. The Bill of Lading Number information may be required by the system.

The user may select “Customer” and enter the Customer ID for the customer that owns the Vessel that may be carrying the Cargo associated with the Bill of Lading. If the user is a Customer User, the user may not see the Customer ID.

The user may select “Voyage” and enter the Voyage Code for the Voyage associated with the Vessel that may be carrying the Cargo associated with the Bill of Lading.

The user may select “Load Port” and enter the name of the Port where the Cargo may be loaded.

The user may select “Discharge Port” and enter the name of the Port where the Cargo may be discharged.

The user may select “Shipper” and enter the necessary Shipper information. This field may contain the name and optional physical address of the Shipper of the Cargo that the Line may have been contracted to carry.

When the user has finished making any changes, the user may select “Update” to record the changes to the Bill of Lading in to the system.

To Add Cargo to the Bill of Lading, the user may select “New Cargo” from the Bill of Lading screen. The New Cargo screen may allow the user to add Cargo information, such as Direction, Customer, Voyage ID, Bill of Lading Number, Consignee, Broker, Forwarder, Notify Party 1, Notify Party 2, Reference Number, TCN, Shipping Order Number, Cargo Type, Commodity, Hazardous Material Type, Other Hazardous Material Description, Over Dimensional?, Handling Instructions, Unit ID, Container Type, Length, Width, Height, Revenue Tons, Reefer Temperature Setting, Reefer Instructions, Genset ID, Container Gross Weight, and Weight, for example, to the record of the new cargo to the Bill of Lading.

For example, the field “Direction” may display whether the Cargo is bound for Import or Export. Cargo Records associated with Bills of Lading are Imports.

The field “Customer” may display the Customer the Cargo may be arriving on. If the user is a Customer User, the user may not see the Customer ID.

The field “Voyage1D” may display the Voyage ID the Cargo may be arriving on.

The field “Bill of Lading Number” may display the Cargo Bill of Lading Number.

The user may select “Consignee” and enter the Consignee for the Cargo Record being added.

The user may select “Broker” and enter the Broker for the Cargo Record being added.

The user may select “Forwarder” and enter the Forwarder for the Cargo Record being added.

The user may select “Notify Party 1” and enter the Notify Party 1 for the Cargo Record being added.

The user may select “Notify Party 2” and enter the Notify Party 2 for the Cargo Record being added.

The user may select “Reference Number” and enter the Reference Number for the Cargo Record being added

The user may select “TCN” and enter the TCN for the Cargo Record being added.

The user may select “Shipping Order Number” and enter the Shipping Order Number for the Cargo Record being added.

The user may select “Cargo Type” and enter the Cargo Type for the Cargo Record being added. If the user does not enter a Cargo Type, the selection will default to “Container”.

The user may select “Commodity” and enter the Commodity description in the text box for the Cargo Record being added.

The user may select “Hazmat Type” and enter the Hazardous Material Type for the Cargo Record being added. If the user does not enter a Hazmat Type, the selection will default to “None”.

The user may select “Other Hazmat Description”, and enter text in the Other Hazmat Description text box for the Cargo Record being added.

The user may select “Over Dimensional?” and enter the Over Dimensional indicator for the Cargo Record being added.

The user may select “Handling Instructions” and enter any Handling Instructions for the Cargo Record being added.

The user may select “Unit ID” and enter the Unit JD for the Cargo Record being added.

The user may select “Container Type” and enter the Container Type for the Container associated with the Cargo Record being added.

The user may select “Container Length” and enter the Container Length for the Container associated with the Cargo Record being added.

The user may select “Food Grade” and enter the Food Grade for the Container associated with the Cargo Record being added.

The user may select “Package Type” and enter the Package Type for the Cargo Record being added.

The user may select “Length” and enter the Length for the Cargo Record being added.

The user may select “Width” and enter the Width for the Cargo Record being added.

The user may select “Height” and enter the Height for the Cargo Record being added.

The user may select “Revenue Tons” and enter the Revenue Tons for the Cargo Record being added.

The user may select “Reefer Temperature Setting” and enter the Reefer Temperature Setting for the Genset associated with the Cargo Record being added.

The user may select “Reefer Instructions” and enter the Reefer Instructions for the Genset associated with the Cargo Record being added.

The user may select “Genset ID” and enter the Genset ID for the Genset associated with the Cargo Record being added.

The user may select “Container Gross Weight” and enter the Container Gross Weight for the Container associated with the Cargo Record being added.

The user may select “Weight” and enter the Weight for Break Bulk associated with the Cargo Record being edited. The Weight field may only be used in place of Container Gross Weight when Cargo Items are not in a Container.

When the user has finished adding the desired information of the new cargo, the user may select “Update” to record the changes to the Voyage in to the system.

To access the View Voyage screen, the user may select “Voyage Code” from the Bill of Lading Information section of the View Bill of Lading page. The View Voyage screen may display voyage information, such as Voyage, Customer, Vessel, Voyage Status, Arrival Date, Sail Date, and Edit Voyage Details, for example.

The field “Voyage” may display the Voyage Code. Voyage Codes may be any alphanumeric combination. Voyage codes do not have to be unique, but it is strongly advised to keep these codes unique.

The field “Customer” may display the Customer ID for the customer that owns the Vessel that may be carrying out the Voyage. If the user is a Customer User, the user may not see the Customer ID.

The field “Vessel” may display the name of the Vessel that may be carrying out the Voyage.

The field “Voyage Status” may display the Voyage Status. Voyage Statuses may be Expected, as may be indicated by a yellow background, Docked, as may be indicated by a salmon background, or Sailed, as may be indicated by a gray background. The user may be allowed to edit the Voyage Status.

The field “Arrival Date” may display the Estimated Arrival Date or Actual Arrival Date if it was specified by the user for the Vessel that may be carrying out the Voyage.

The field “Sail Date” may display the Estimated Sail Date or Actual Sail Date if specified by the user for the Vessel that may be carrying out the Voyage.

The user may select “Edit Voyage Details” to allow the user to Edit Voyage Details.

The View Voyage screen may also display voyage booking and bill of lading information, such as Customer, Booking/Bill of Lading Number, Direction, and Shipper, for example.

The field “Customer” may display the Customer ID for the customer that owns the Vessel that may be carrying the Cargo associated with a Booking or Bill of Lading.

The field “Booking/Bill of Lading Number” may display the Booking Number or Bill of Lading Number. The user may select “Booking Number or Bill of Lading Number” to enter the “View Bill of Lading” screen or “View Booking” screen for the selected number.

The field “Direction” may display the direction for Cargo associated with a Booking Number or Bill of Lading Number.

The field “Shipper” may display the Shipper of the Cargo associated with a Booking Number or Bill of Lading Number.

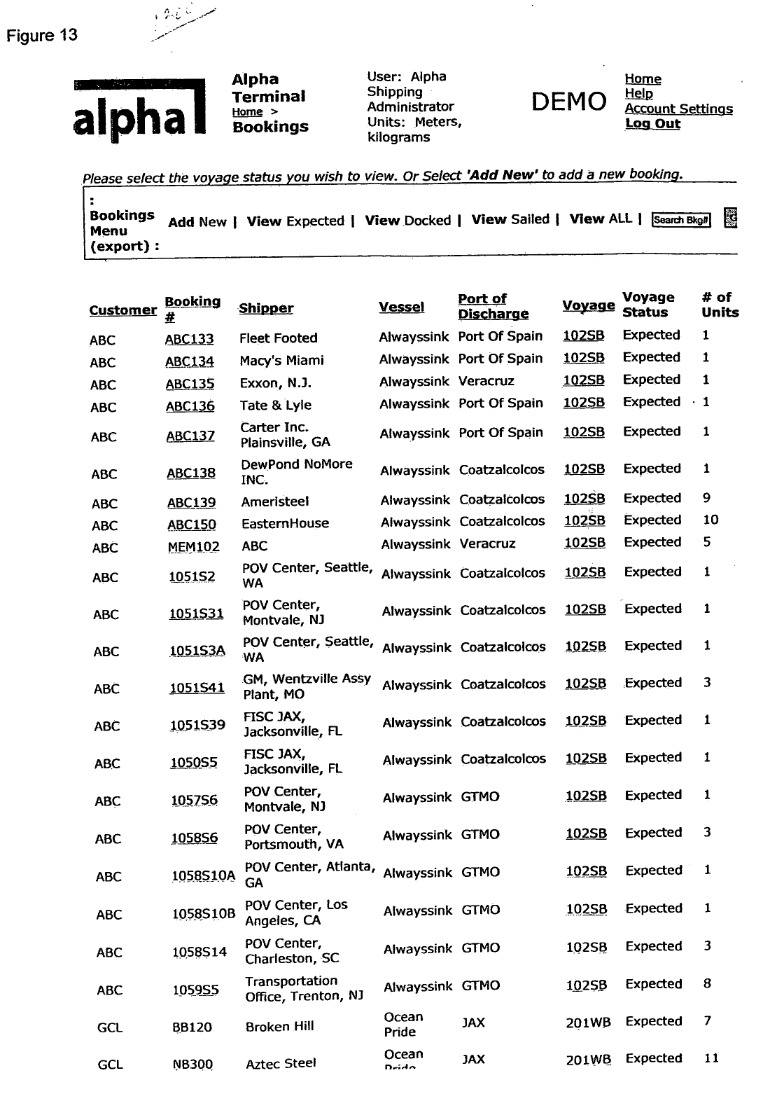

According to another aspect of the present invention, a user may be an administrator, such as a terminal administrator, or a line administrator, and may have a permission, such as the ability to manage bookings. Such a user may engage in a task, such as entering the system via the general entry and reaching the “Bookings (Export)” request screen, as illustrated in FIG. 13. The Bookings function may be used to display Bookings that are expected, docked, or have sailed within the last three days. This may be thought of as an “active voyage” list. From this screen the user may be allowed to Create a New Booking, View a Booking, and View Older Bookings, for example. From the Current Bookings screen the user may select the Bookings screen. From the Bookings screen the user may select other screens that may allow the user to view voyage details, edit Bookings, add Cargo to a Booking, or edit a Cargo record associated with a Booking, for example.

To manage bookings, a user may select “Bookings (Export)” from the View Current section on the Main Menu. The Current Bookings screen may display information, such as Customer, Booking Number, Shipper, Vessel, Port of Discharge, Voyage, Voyage Status, and Number of Units, for example, that the user may view for managing the bookings.

For example, the field “Customer” may display the Customer ID for the customer that owns the Vessels that may be carrying out the Voyages for the Bookings. If the user is a Customer User, the user may not see the Customer ID.

The field “Booking Number” may display the Booking Number and allow the user to select the View Booking screen.

The field “Shipper” may display the Name of the shipper associated with that particular Booking Number.

The field “Vessel” may display the name of the Vessel that may be carrying the Cargo associated with the Booking. If the user is an Internal User, the user may have access to all Vessels. If the user is a Customer User, the user may have access to Vessels relating to their Line.

The field “Port of Discharge” may display the Port from which that particular Vessel was discharged.

The field “Voyage” may display the Voyage Code for the Vessel carrying the Cargo associated with the Booking. If the user is an Internal User, the user may have access to all Voyages. If the user is a Customer User, the user may have access to Voyages relating to their Line.

The field “Voyage Status” may display the Voyage Status. Voyage Statuses may be Expected, as may be indicated by a yellow background, Docked, as may be indicated by a salmon background, or Sailed, as may be indicated by a gray background.

The field “Number of Units” may display the total number of units associated with that particular Booking Number.

To View Older Bookings, the user may select “Older Bookings” from the Current Bookings screen. This may allow the user to display a screen similar to the View Current Bookings screen. The difference may be that Older Bookings only displays Bookings that sailed more than three days ago.

The user may return to the Current Bookings screen by selecting “Back to Current Bookings” from the Older Bookings screen.

To Create a New Booking, the user may select “Add New” from the Current Bookings screen or the Older Bookings screen. The user may also Create a New Booking by selecting “Bookings (Export)” from the Add section of the Main Menu. The user may then provide information, such as Booking Number, Booking Date, Customer, Voyage, Load Port, Discharge Port, and Shipper, for example, to Create a New Booking.

For example, the user may select “Booking Number” and enter a Booking number for the New Booking. Booking numbers may be any alphanumeric combination. Booking numbers do not have to be unique, but it is strongly advised to keep these codes unique. The Booking Number information may be required by the system.

The user may select “Booking Date” and enter a Booking Date for the New Booking.

The user may select “Customer” and enter the Customer ID for the customer that owns the Vessel that may be carrying the Cargo associated with the new Booking. If the user is a Customer User, the user may not have the option to select a Customer ID.

The user may select “Voyage” and enter a Voyage Code for the Voyage associated with the Vessel that may be carrying the Cargo associated with the new Booking. If the user is an Internal User, the user may have access to all Voyages. If the user is a Customer User, the user may have access to Voyages relating to their Line.

The user may select “Load Port” and enter the name of the Port where the Cargo may be loaded.

The user may select “Discharge Port” and enter the name of the Port where the Cargo may be discharged.

The user may select “Shipper” and enter any necessary Shipper information. This field may contain the name and optional physical address of the Shipper of the Cargo that the Line was contracted to carry.

When the user has finished entering the information, the user may select “Add” to add the Booking to the system.

To View Bookings, the user may select “Booking Number” from the Current Bookings screen. The View Booking screen may display Booking information, allowing the user to Edit Booking Details, Add Cargo to the Booking, Edit Cargo associated with the Booking, view the E-Code for a Cargo item associated with the Booking, and View Voyage screen, for example.

The View Booking screen may display booking information, such as Customer, Booking Number, Shipper, Vessel, Voyage, and Voyage Status, for example.

For example, the field “Customer” may displays the Customer ID for the customer that owns the Vessel that may be carrying the Cargo associated with the Booking.

The field “Booking Number” may display the Booking Number for the Booking the user may be viewing.

The field “Shipper” may display the name of the Shipper for the Cargo associated with the Booking.

The field “Vessel” may display the name of the Vessel that may be carrying the Cargo associated with the Booking.

The field “Voyage” may display the Voyage Code. The user may select “Voyage Code” to reach the View Voyage screen. If the user is an Internal User, the user may have access to all Voyages. If the user is a Customer User, the user may have access to Voyages relating to their Line.

The field “Voyage Status” may display the Voyage Status. Voyage Statuses may be Expected, as may be indicated by a yellow background, Docked, as may be indicated by a salmon background, or Sailed, as may be indicated by a gray background.

The View Booking Cargo screen may display Booking Cargo Information, such as Customer, Unit ID, Status, Cargo Type, Container Type, Container Length, Food Grade, Reference Number, TCN, Action, and E-Code, for example.

For example, the field “Customer” may display the Customer ID for the customer that owns the Vessel that may be carrying the Cargo associated with the Booking. If the user is a Customer User, the user may not see the Customer ID.

The field “Unit ID” may display the Unit ID of the Cargo assigned to the Booking. A Unit ID may be a Container ID, LTL ID, or Break-Bulk ID.

The field “Status” may display the Status of the Cargo assigned to this Booking.

The field “Cargo Type” may display the Cargo Type of the Cargo assigned to the Booking. A Cargo Type may be any type of Container, Break-bulk, Neobulk, LTL Cargo, RO-RO Cargo, or Empty Equipment, for example.

The field “Container Type” may display the type of Container the Cargo associated with the Booking may be shipped in.

The field “Container Length” may display the length of the Container the Cargo associated with the Booking may be shipped in.

The field “Food Grade” may display the Food Grade of the Container the Cargo associated with the Booking may be shipped in.

The field “Reference Number” may display the Reference Number for the Cargo associated with the Booking.

The field “TCN” may display the Transportation Control Number for the Cargo associated with the Booking.

The field “Action” may allow the user to select “Edit” to enter changes to a Cargo Record associated with the Booking. To roll the cargo to a different Voyage, the user may select the indicated checkbox in the Action column. The user may select the Voyage to roll the checked Cargo to at the bottom of the screen and select “Roll”.

The field “E-Code” may display the E-Code for each Cargo Record assigned to the Booking. The E-Code may be unique to each Cargo Record and may be assigned automatically by the system. Clicking on the E-Code in the Booking Cargo list may show the user a graphic of the bar-code for this Cargo Record.

To Edit Booking Details, the user may select “Edit Booking Details” from the View Booking screen. The Edit Booking Details screen may display and/or may allow the user to edit details, such as Booking Number, Booking Date, Customer, Voyage, Load Port, Discharge Port, and Shipper, for example, of the Booking record in the system.

The user may select “Booking Number” and enter the Booking Number for the Booking. Booking numbers may be any alphanumeric combination. Booking numbers do not have to be unique, but it is strongly advised to keep these codes unique. The Booking Number information may be required by the system.

The user may select “Booking Date” and enter the Booking Date for the Booking.

The user may select “Customer” and enter the Customer ID for the customer that owns the Vessel that may be carrying the Cargo associated with the Booking. If the user is a Customer User, the user may not see the Customer ID.

The user may select “Voyage” and enter the Voyage Code for the Voyage associated with the Vessel that may be carrying the Cargo associated with the Booking. If the user is an Internal User, the user may have access to all voyages. If the user is a Customer User, the user may have access to Voyages relating to their Line.

The user may select “Load Port” and enter the name of the Port where the Cargo may be loaded.

The user may select “Discharge Port” and enter the name of the Port where the Cargo may be discharged.

The user may select “Shipper” and enter the necessary Shipper information. This field may contain the name and optional physical address of the Shipper of the Cargo that the Line may have been contracted to carry.

When the user has finished making any changes, the user may select “Update” to record the changes to the Booking in to the system.

To Add Cargo to the Booking, the user may select “New Cargo” from the View Booking screen. The New Cargo screen may allow the user to add Cargo information, such as Direction, Customer, Voyage ID, Booking Number, Consignee, Broker, Forwarder, Notify Party 1, Notify Party 2, Reference Number, TCN, Shipping Order Number, Cargo Type, Commodity, Marks, Hazardous Material Type, Other Hazardous Material Description, Over Dimensional?, Handling Instructions, Container Type, Size, Food Grade, Package Type, Length, Width, Height, Revenue Tons, Reefer Temperature Setting, Reefer Instructions, and Weight, for example, to the record of the new cargo to the Booking.

The field “Direction” may display whether the Cargo is bound for Import or Export. Cargo Records associated with Bookings are Exports.

The field “Customer” may display the Customer the Cargo may be set to sail with. If the user is a Customer User, the user may not see the Customer ID.

The field “Voyage1D” may display the Voyage ID the Cargo may be set to sail with.

The field “Booking Number” may display the Cargo Booking Number.

The user may select “Consignee” and enter the Consignee for the Cargo Record being added.

The user may select “Broker” and enter the Broker for the Cargo Record being added.

The user may select “Forwarder” and enter the Forwarder for the Cargo Record being added.

The user may select “Notify Party 1” and enter the Notify Party 1 for the Cargo Record being added.

The user may select “Notify Party 2” and enter the Notify Party 2 for the Cargo Record being added.

The user may select “Reference Number” and enter the Reference Number for the Cargo Record being added

The user may select “TCN” and enter the TCN for the Cargo Record being added.

The user may select “Shipping Order Number” and enter the Shipping Order Number for the Cargo Record being added.

The user may select “Cargo Type” and enter the Cargo Type for the Cargo Record being added. If the user does not enter a Cargo Type, the selection may default to “Container”.

The user may select “Commodity” and enter the Commodity description in the text box for the Cargo Record being added.

The user may select “Marks” and enter any Special Identifying Marks for the Cargo Record being added.

The user may select “Hazmat Type” and enter the Hazardous Material Type for the Cargo Record being added. If the user does not enter a Hazmat Type, the selection will default to “None”.

The user may select “Other Hazmat Description”, and enter text in the Other Hazmat Description text box for the Cargo Record being added.

The user may select “Over Dimensional?” and enter the Over Dimensional indicator for the Cargo Record being added.

The user may select “Handling Instructions” and enter any Handling Instructions for the Cargo Record being added.

The user may select “Container Type” and enter the Container Type for the Container associated with the Cargo Record being added.

The user may select “Size” and enter the Container Length for the Container associated with the Cargo Record being added.

The user may select “Food Grade” and enter the Food Grade for the Container associated with the Cargo Record being added.

The user may select “Package Type” and enter the Package Type for the Cargo Record being added.

The user may select “Length” and enter the Length for the Cargo Record being added.

For example the user may select “Width” and enter the Width for the Cargo Record being added.

The user may select “Height” and enter the Height for the Cargo Record being added.

The user may select “Revenue Tons” and enter the Revenue Tons for the Cargo Record being added.

The user may select “Reefer Temperature Setting” and enter the Reefer Temperature Setting for the Genset associated with the Cargo Record being added.

The user may select “Reefer Instructions” and enter the Reefer Instructions for the Genset associated with the Cargo Record being added.

The user may select “Weight:” and enter the Weight for Break Bulk associated with the Cargo Record being edited. The Weight field may only be used in place of Container Gross Weight when Cargo Items are not in a Container.

When the user has finished adding the desired information of the new cargo, the user may select “Update” to record the changes to the Voyage in to the system.

To access the View Voyage screen, the user may select “Voyage Code” from the Booking Information section of the View Booking page. The View Voyage screen may display voyage information, such as Voyage, Customer, Vessel, Voyage Status, Arrival Date, Sail Date, and Edit Voyage Details, for example.

For example, the field “Voyage” may display the Voyage Code. Voyage Codes may be any alphanumeric combination. Voyage codes do not have to be unique, but it is strongly advised to keep these codes unique.

The field “Customer” may display the Customer ID for the customer that owns the Vessel that may be carrying out the Voyage.

The field “Vessel” may display the name of the Vessel that may be carrying out the Voyage.

The field “Voyage Status” may display the Voyage Status. Voyage Statuses may be Expected, as may be indicated by a yellow background, Docked, as may be indicated by a salmon background, or Sailed, as may be indicated by a gray background. The user may be allowed to edit the Voyage Status.

The field “Arrival Date” may display the Estimated Arrival Date or Actual Arrival Date if it was specified by the user for the Vessel that may be carrying out the Voyage.

The field “Sail Date” may display the Estimated Sail Date or Actual Sail Date if specified by the user for the Vessel that may be carrying out the Voyage.

The user may select “Edit Voyage Details” to allow the user to Edit Voyage Details.

The View Voyage screen may also display voyage booking and bill of lading information, such as Customer, Booking/Bill of Lading Number, Direction, and Shipper.

The field “Customer” may display the Customer ID for the customer that owns the Vessel that may be carrying the Cargo associated with a Booking or Bill of Lading. If the user is a Customer User, the user may not see the Customer ID.

The field “Booking/Bill of Lading Number” may display the Booking Number or Bill of Lading Number. The user may select “Booking Number” or “Bill of Lading Number” to enter the “View Bill of Lading” screen or “View Booking” screen for the selected number.

The field “Direction” may display the direction for Cargo associated with a Booking Number or Bill of Lading Number.

The field “Shipper” may display the Shipper of the Cargo associated with a Booking Number or Bill of Lading Number.

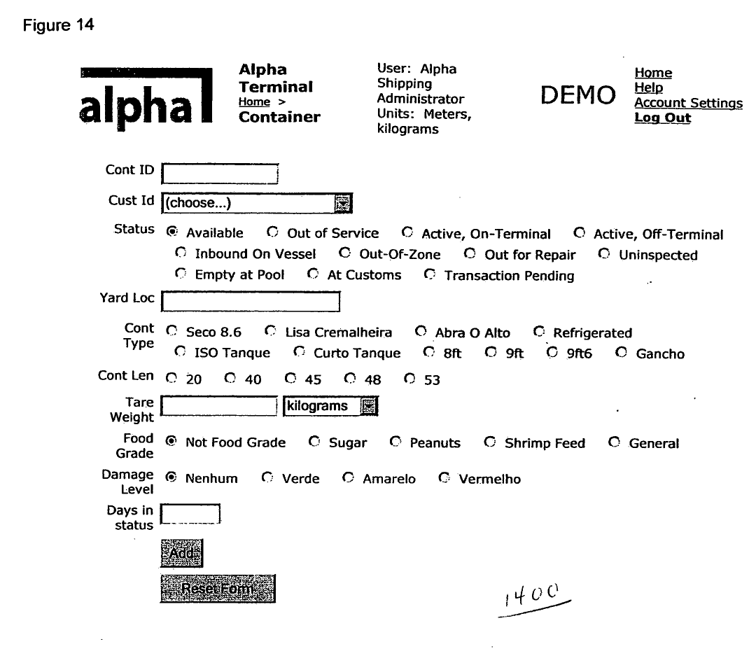

According to another aspect of the present invention, each user may be assigned a role, and each role may have associated therewith one or more permissions. For example, a user may be an administrator, such as an equipment administrator, and may have a permission, such as the ability to manage containers. Such a user may engage in a task, such as entering the system via the general entry and reaching the “Containers” request screen, as illustrated in FIG. 14. The Containers function may be used to add a new Container to the system.

To add a new container, a user may select “Containers” from the Add section of the Main Menu. The user may provide information, such as Container ID, Customer ID, Status, Yard Location, Container Type, Container Length, Tare Weight, Food Grade, Damage Level, and Days in Status, for example, for the New Container.

The user may select “Container ID” and enter a unique Container ID number. This unique ID may be comprised of four letters followed by six digits and usually a seventh digit that may act as a checksum digit.

The user may select “Customer ID” and enter the Customer ID for the customer that owns the Container being added to the system. If the user is a Customer User, the user may not have the option to select a Customer ID.

The user may select “Status” and enter the Status of the Container being added.

The user may select “Yard Location” and enter the yard location of the Container being added.

The user may select “Container Type” and enter the Container Type of the Container being added.

The user may select “Container Length” and enter the Container Length of the Container being added.

The user may select “Tare Weight” and enter the Tare Weight of the Container being added.

The user may select “Food Grade” and enter the Food Grade of the Container being added.

The user may select “Damage Level” and enter the Damage Level of the Container being added.

The user may select “Days in Status” and enter the number of days in status for the Container being added.

The user may select “Add” to add the New Container to the system.

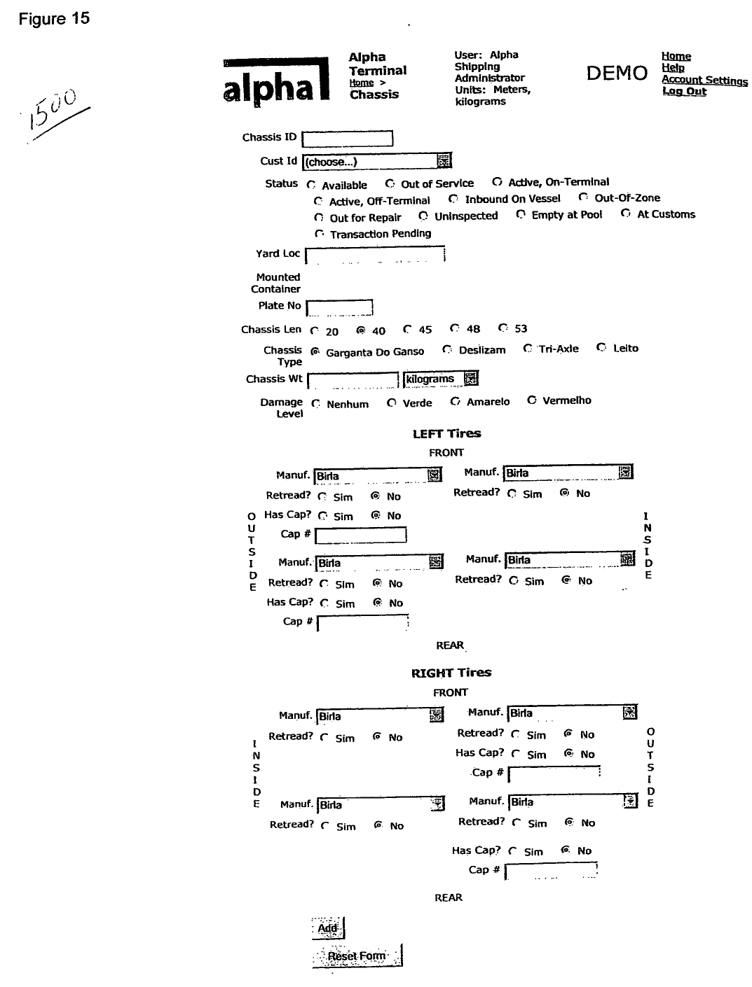

According to another aspect of the present invention, each user may be assigned a role, and each role may have associated therewith one or more permissions. For example, a user may be an administrator, such as an equipment administrator, and may have a permission, such as the ability to manage a chassis. Such a user may engage in a task, such as entering the system via the general entry and reaching the “Chassis” request screen, as illustrated in FIG. 15. The Chassis function may be used add a new chassis to the system.

To add a new chassis, a user may select “Chassis” from Add section of the Main Menu. The user may provide information, such as Chassis ID, Customer ID, Status, Yard Location, Plate Number, Chassis Type, Chassis Length, Chassis Weight, Damage Level, Outside Tires, and Inside Tires, for example, to complete the addition of the new chassis to the system.

The user may select “Chassis ID” and enter a unique Chassis ID number. This unique ID may be comprised of four letters followed by six digits and usually a seventh digit that may act as a checksum digit.

The user may select “Customer ID” and enter the Customer ID for the customer that owns the Chassis being added to the system. If the user is a Customer User, the user may not have the option to select a Customer ID.

The user may select “Status” and enter the Status of the Chassis being added.

The user may select “Yard Location” and enter the yard location of the Container being added.

The user may select “Plate Number” and enter the License Plate Number for the Chassis being added.

The user may select “Chassis Type” and enter the Chassis Type for the Chassis being added.

The user may select “Chassis Length” and enter the Chassis Length for the Chassis being added.

The user may select “Chassis Weight” and enter the Chassis Weight for the Chassis being added.

The user may select “Damage Level” and enter the Damage Level for the Chassis being added.

The user may select “Outside Tires” and enter all of the Outside Tires. There may be four in all, two on the left, and two on the right. The user may select “Tire Manufacturer” from the drop-down selection menu, and indicate if the tire is a Retreaded Tire or not. The user may then indicate if the tire has a Cap or not. If the tire has a Cap, the user may provide the Cap Number in the space provided.

The user may select “Inside Tires” and enter all of the Inside Tires. There may be four in all, two on the left, and two on the right. The user may select “Tire Manufacturer” from the drop-down selection menu, and indicate if the tire is a Retreaded Tire or not. Inside Tires may not have Caps.

The user may select “Add” to add the New Chassis to the system.

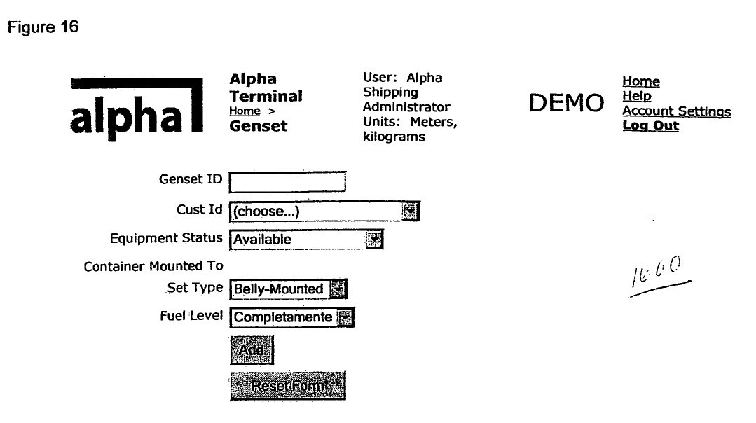

According to another aspect of the present invention, for example, a user may be an administrator, such as an equipment administrator, and may have a permission, such as the ability to manage a Genset. Such a user may engage in a task, such as entering the system via the general entry and reaching the “Genset” request screen, as illustrated in FIG. 16. The Genset function may be used add a new Genset to the system.

To add a new Genset, a user may select “Gensets” from the Add section of the Main Menu. The user may provide information, such as Genset ID, Customer ID, Status, Container Mounted to Set Type, and Fuel Level, for example, to complete the addition of the new Genset to the system.

The user may select “Genset ID” and enter a unique Genset ID number. This unique ID may be comprised of four letters followed by six digits and usually a seventh digit that may act as a checksum digit.

The user may select “Customer ID” and enter the Customer ID for the customer that owns the Genset being added to the system. If the user is a Customer User, the user may not have the option to select a Customer ID.

The user may select “Status” and enter the Status of the Genset being added.

The user may select “Container Mounted to Set Type” and enter the particular type for the Genset being added.

The user may select “Fuel Level” and enter the Fuel Level for the Genset being added. The user may select “Add” to add the New Genset to the system.

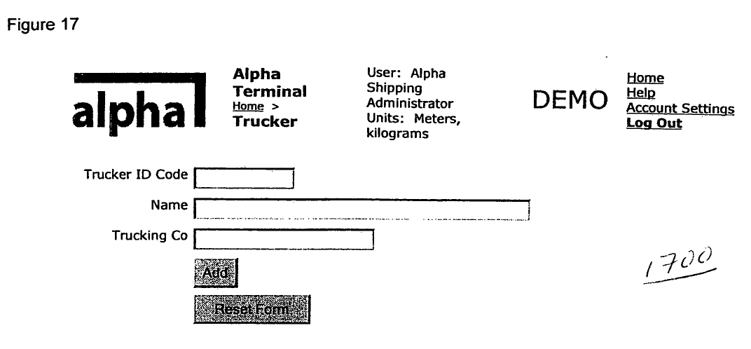

According to another aspect of the present invention, each user may be assigned a role, and each role may have associated therewith one or more permissions. For example, a user may be an administrator, such as a gate administrator, and may have a permission, such as the ability to add truckers. Such a user may engage in a task, such as entering the system via the general entry and reaching the “Truckers” request screen, as illustrated in FIG. 17. The Truckers function may be used to add Trucker information into the system.

To Add a New Trucker, the user may select “Truckers” from the Add section of the Main Menu. The user may provide information, such as Trucker ID Code, Name, and Trucking Company, for example, for the new Trucker.

For example, the user may select “Trucker ID Code” and enter any alphanumeric combination, however, the Trucker ID Code must be unique for each Trucker. It is suggested that a Driver's License number or Social Security number may be used, but it may be entirely the Terminal's decision to decide how to assign Trucker IDs.

The user may select “Name” and enter the Trucker's name.

The user may select “Trucking Co” and enter the name of the Trucking Company that the trucker works for.

The user may select “Add” to add the Trucker information to the system.

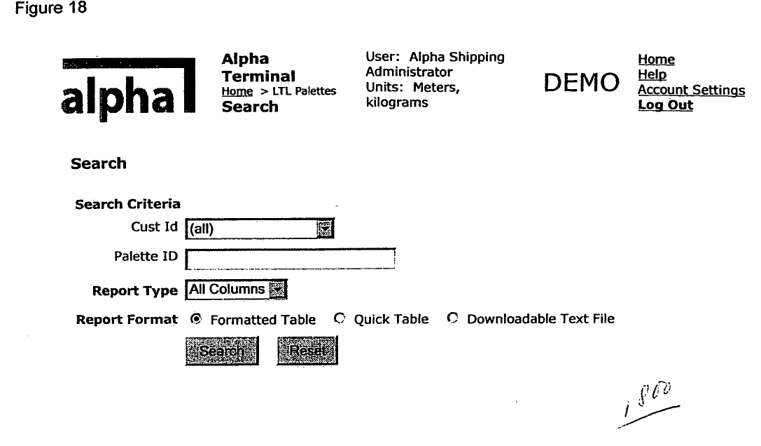

According to another aspect of the present invention, a user may be an administrator, such as a CFS administrator, for example, and may not require a permission. Such a user may engage in a task, such as entering the system via the general entry and reaching the “LTL Palettes” request screen, as illustrated in FIG. 18. The LTL Palettes function may be used to locate LTL Palettes with specific attributes. Once the system displays the search results, it may then be possible to edit these related attributes.

To search for LTL Palettes, a user may select “LTL Palettes” from the Search section of the Main Menu. A search for LTL Palettes based on criteria, such as Customer ID, Palette ID, Report Type, and Report Format, for example, may be used to obtain the search results.

The user may select “Customer ID” and enter the Customer ID for the customer that is carrying the LTL Palette(s) that the user would like to appear in the Search Results. If a Customer ID has not been selected, the system may default to displaying the LTL Palette(s) carried by All Customers.

The user may select “Palette ID” and enter a Palette ID or a partial Palette ID into the field. As an example of this, if the user enters the number “6” into the field, the search results may consist of LTL Palettes that have a Palette ID containing the number “6”. Palette IDs may be any alphanumeric combination. Palette IDs do not have to be unique, however it is highly advised to keep these numbers as unique as possible.

The user may select “Report Type” which may allow the user to filter display results based upon a predefined Report.

The user may select “Report Format” and enter the Format the user would like for the search results. An example Report Format may be a Formatted Table. A Formatted Table may be an aesthetically pleasing HTML formatted page. For large reports, the HTML format may take a while to generate. Another example Report Format may be a Quick Table. A Quick Table generates using simple text rather than HTML tables. It may be less aesthetically pleasing, but may generate much quicker than the Formatted Table, which may be very useful for large reports. Another example Report Format may be a Downloadable Text File. A Downloadable Text File generates a Tab Delimited Text File. This format may be imported to most spreadsheets for further manipulation.

The user may select “Search” to perform the LTL Palettes Search based upon the criteria specified in the areas above.

The LTL Palettes Search Results page may list LTL Palettes based upon the specified criteria entered above. From this screen, the user may choose to edit an LTL Palette record.

To Edit a LTL Palette, the user may select “Edit” for the LTL Palette record to be edited.

On the LTL Palette Edit screen the user may be presented with information, such as Palette ID, Length, Width, Height, Hazardous Material Summary, Weight Total, and Notes, for example, and may choose to edit information about the Trucker.

The user may select “Palette ID” and edit the Palette ID. Palette IDs may be any alphanumeric combination. Palette IDs do not have to be unique, however it is highly advised to keep these numbers as unique as possible.

The user may select “Length” and edit the length for the Palette.

The user may select “Width” and edit the width for the Palette.

The user may select “Height” and edit the height for the Palette.

The user may select “Hazmat Summary” and edit Hazardous Material information for the Palette.

The user may select “Weight Total” and edit the Total Weight of the Palette. The Weight may be automatically calculated by adding the weights of the Units added to the palette.

The user may select “Notes” and enter any additional notes about the Palette. The user may have an option to edit the Notes.

The user may select “Update” to record the changes to the LTL Palette in to the system.

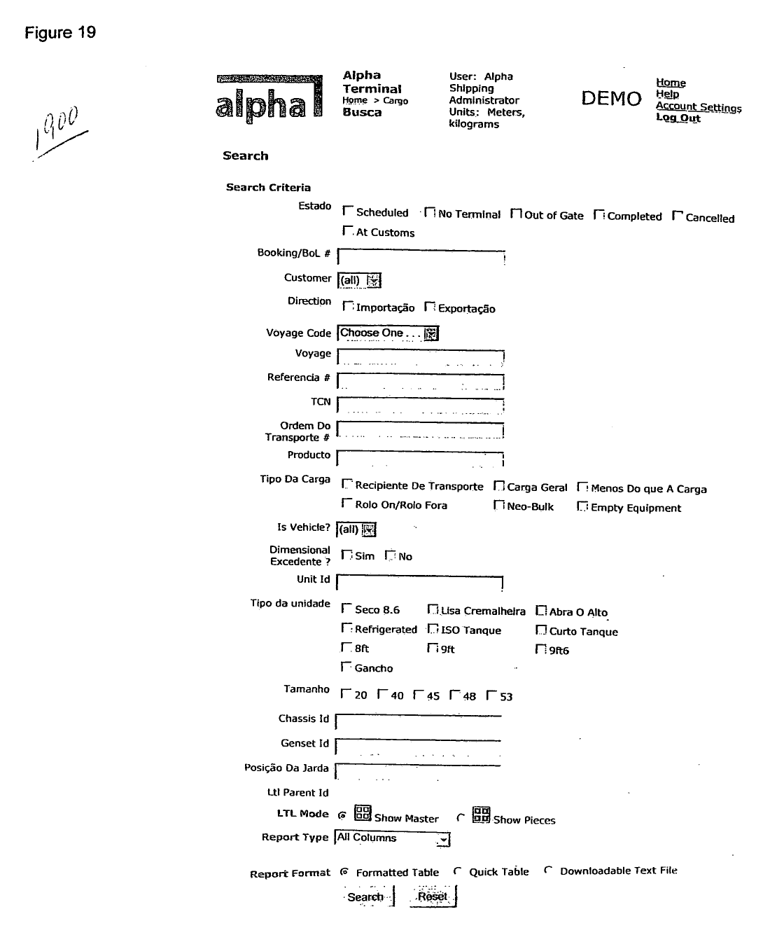

According to another aspect of the present invention, a user may be may be an administrator, such as a terminal administrator or a line administrator, and may have a permission, such as the ability to search cargo. Such a user may engage in a task, such as entering the system via the general entry and reaching the “Cargo” request screen, as illustrated in FIG. 19. The Cargo function may be used to locate Cargo with specific attributes. Once the system displays the search results, a user may edit these related attributes if the user has such a permission.

To search cargo, a user may select “Cargo” from the Search section of the Main Menu. A “Search Cargo” may be based on a number of criteria. As may be known by those possessing an ordinary skill in the pertinent art, the more criteria selected for the search, the narrower the search results may be. In an exemplary embodiment, the search cargo mechanism may be based on various criteria, such as status, booking, customer identification, direction, voyage identification, reference number, TCN, shipping order number, commodity, cargo type, “over dimensional?”, unit identification, container type, container length, chassis identification, Genset identification, yard location, report type, and report format, for example, of the cargo.

For example, a search by “Status” may allow for a search by status of the cargo. The user may select “Cargo Status”, and then select a defined status, for the Cargo Record(s) that the user would like to appear in the Search Results. If a Status is not selected, the search results may default, or search pursuant to another search mechanism that has been entered, such as by displaying the desired “Booking/Bill of Lading” records for all Statuses.

A search by “Booking/Bill of Lading Number” may allow for a search by the Booking or Bill of Lading Number of the cargo. The user may select “Booking/BOL #” and enter a Booking/Bill of Lading Number, or even a partial Booking or Bill of Lading Number into this field. As an example of this, if the number “1” was entered into this field, the search results would consist only of Bookings/Bill of Ladings that have a Booking/Bill of Lading Number containing the number “1”.

A search by “Customer ID” may allow for search by the Customer Identification of the cargo. If the user is an Internal User, he may select “Customer ID”, and then further select a defined customer identification for the customer, such as the shipping line, that is carrying the Cargo that the user would like to appear in the Search Results. If a Customer ID is not selected, the system may default, or may display “Cargo Carried by All Customers”. If the user is a Customer User, the user may not have this option.

A search by “Direction” may allow for a search by a defined direction of the cargo, such as importation or exportation, for example, of the cargo. If the user selects “Import”, Bills of Lading may appear in the Cargo Search results. If the user selects “Export”, Bookings may appear in the Cargo Search results. If the user selects both “Import” and “Export”, or if the user does not select any Direction, both Bookings and Bills of Lading may appear in the Cargo Search results.

A search by “Voyage Identification” may allow for a search by voyage identification of the cargo. The user may select “Voyage ID” and enter the specific voyage identification. If the user selects a Voyage, Bookings or Bills of Lading pertaining to the selected Voyage may appear in the Cargo Search results. If the user does not select a Voyage, Bookings and/or Bills of Lading pertaining to all Voyages may appear in the Cargo Search results. An Internal User may have access to all Voyages. A Customer User may have access to Voyages relating to their Line.

A search by “Reference Number” may allow for a search by reference number of the cargo. The user may select “Reference Number” and enter either the whole reference number or part of the reference number into the field. As an example of this, if the user enters the number “2” into this field, the search results may consist of Bookings/Bills of Lading that have a Reference Number containing the number “2”.

A search by “TCN” may allow for a search by TCN of the cargo. The user may select “TCN” and enter either the whole TCN or part of the TCN into the field. As an example of this, if the user enters “3” into this field, the search results may consist of Bookings/Bills of Lading that have a TCN containing the number “3”.

A search by “Shipping Order Number” may allow for a search by shipping order number of the cargo. The user may select “Shipping Order Number” and enter either the whole shipping order number or part of the shipping order number into the field. As an example of this, if the user enters “4” into this field, the search results may consist of Bookings/Bills of Lading that have a Shipping Order Number containing the number “4”.

A search by “Commodity” may allow for a search by commodity of the cargo. The user may select “Commodity” and enter either the whole name of the commodity or part of the name of the commodity. As an example of this, if the user enters the letter “a” into this field, the search results may consist of Bookings/Bills of Lading that have a Commodity containing the letter “a”. As another example of this, if the user enters “Mach” into this field, the search results may consist of Bookings/Bill of Ladings that have a Commodity containing the letters “Mach”, such as the word Machinery.

A search by “Cargo Type” may allow for a search by the type of cargo. The user may select “Cargo Type” and enter the Cargo Type(s) for the Cargo Record(s) the user would like to appear in the Search Results. If the user does not select a Cargo Type, the search results may display Booking/Bill of Lading records for all Cargo Types.

A search by “Over Dimensional?” may allow for a search by the cargo being over dimensional or not. The user may select “Over Dimensional?” and enter whether or not the Cargo Record(s) the user may be searching for may be Over Dimensional or not. If the user leaves this field blank, or if both Over Dimensional and not Over Dimensional are selected, the Cargo Search results may display both over dimensional and regular sized Cargo Record(s).

A search by “Unit Identification” may allow for a search by unit identification number of the cargo. The user may select “Unit ID” and enter either a whole Unit Identification Number or part of a Unit Identification Number into the field. As an example of this, if the user enters the number “5” into this field, the search results may display cargo and/or equipment that have a Unit ID Number containing the number “5”.

A search by “Container Type” may allow for a search by the container type of the cargo. The user may select “Container Type” and enter the container type for the Cargo Record(s) that the user would like to appear in the Search Results. If a container type is not selected, the search results may display Booking/Bill of Lading records for all container types.

A search by “Container Length” may allow for a search by container length of the cargo. The user may select “Container Length” and enter the container length for the Cargo Record(s) the user would like to appear in the Search Results. If a container length is not selected, the search results may display Booking/Bill of Lading records for all container lengths.

A search by “Chassis Identification” may allow for a search by chassis identification number of the cargo. Each chassis may have a unique Chassis ID number. Such a number may be comprised of four letters followed by six numbers, such as “AAAA111-111”. The Chassis ID number may or may not have a seventh digit, which may be used by the system as a checksum to verify the identification number. The user may select “Chassis ID” and enter either a whole Chassis ID number or part of a Chassis ID number into this field. As an example of this, if the user enters the letter “C” into this field, the search results may consist of Booking/Bill of Lading records that have a Chassis ID containing the letter “C”.

A search by “Genset ID Number” may allow for a search by Genset identification number of the cargo. Each Genset may have a unique Genset ID number. The user may select “Genset ID” and enter either a whole Genset ID number or part of a Genset ID number. As an example of this, if the user enters the letter “D” into this field, the search results may consist of Booking/Bill of Lading records that have a Chassis ID containing the letter “D”.

A search by “Yard Location” may allow for a search by yard location of the cargo. The user may select “Yard Location” and enter either the whole name of the yard location or part of the name of the yard location into the field. As an example of this, if the user enters the letter “C” into this field, the search results may consist of cargo and/or equipment that relates to Bookings/Bills Of Lading currently in a yard location containing the letter “C”.

A search by “Report Type” may allow for a search by the report type of the cargo. By selecting a report type, the user may be able to filter display results based upon a predefined Report.

A search by “Report Format” may allow for a search by the report format for the cargo. The user may select “Report Format” and enter the report format, such as Formatted Table, Quick Table, or Downloadable Text File, for example, desired for the search results. A formatted table may be selected, providing an aesthetically pleasing HTML formatted page. For large reports, the HTML may take extra time to generate. A Quick Table may be selected, which may generate using simple text rather than HTML tables. It may be less aesthetically pleasing, but may generate more quickly than the Formatted Table, which may be very useful for large reports. A Downloadable Text File may also be selected, which may generate a Tab Delimited text file. This format may be imported to most spreadsheets for further manipulation.

Once the desired criteria has been entered, the user may select “Search” to perform the Cargo Search based upon the specified criteria in the areas described above. The Cargo Search Results page may list Cargo Records based upon criteria entered as described above. From this screen, the user may choose to edit a Cargo Record.

To Edit a Cargo Record, the user may select “Edit” in the row for the Cargo Record to be edited. On the Cargo Edit screen the user may be presented with information, such as E-Code, Customer, Voyage ID, Booking Number, Direction, Status, Transaction Pending, Consignee, Broker, Forwarder, Notify Party 1, Notify Party 2, Reference Number, TCN, Shipping Order Number, Marks, Commodity, Cargo Type, Hazmat Type, Other Hazmat Description, Over Dimensional?, Handling Instructions, Unit ID, Container Type, Container Length, Food Grade, Seal 1 Number, Seal 2 Number, Seal 3 Number, Seal 4 Number, Package Type, Length, Width, Height, Volume, Revenue Tons, Reefer Temperature Setting, Reefer Temperature Actual, Reefer Instructions, Chassis ID, Genset ID, Scale Weight, Tractor Weight, Container Gross Weight, Weight, Yard Location, Warehouse Location, Stowage Location, Gate In Date, Trucker-In, Gate Out Date, Trucker-Out, Gate Reposition Date, Trucker-Reposition, Reposition Location, Vessel Load Date, Vessel Discharged, and Days Out, for example, and may edit this information concerning the Cargo Record.

For example, “E-Code” may display the E-Code. The E-Code may be unique to each Cargo Record and may be assigned automatically by the system.

The field “Customer” may display the Customer, such as a shipping line, the Cargo may be booked to.

The field “Voyage ID” may display the Voyage Identification.

The field “Booking Number” may display the Cargo Booking Number.

The field “Direction” may be displayed if the Cargo is bound for Import or Export.

The field “Status” may display the Status of the Cargo.

The field “Transaction Pending” may indicate if the Cargo Record may currently be in process. Some of the gate tasks may involve multiple steps. The “Transaction Pending” flag may be set at the beginning step, and may be un-set with the completion of the last step. This may make it easy to identify records where a transaction may have been started but never completed.

The field “Volume” may display the volume of the package if there are length, width, and height measurements for the package. The information in the volume field may be automatically calculated by the system.

The field “Days Out” may display the Days Out for the Cargo Record being edited.

The fields “Consignee, Broker, Forwarder, Notify Party 1, Notify Party 2, Reference Number, TCN, Shipping Order Number, Marks, Commodity, Cargo Type, Hazmat Type, Other Hazmat Description, Over Dimensional?, Handling Instructions, Unit ID, Container Type, Container Length, Food Grade, Seal 1 Number, Seal 2 Number, Seal 3 Number, Seal 4 Number, Package Type, Length, Width, Height, Revenue Tons, Reefer Temperature Setting, Reefer Temperature Actual, Reefer Instructions, Chassis ID, Genset ID, Scale Weight, Tractor Weight, Container Gross Weight, Weight, Yard Location, Warehouse Location, Stowage Location, Gate In Date, Trucker-In, Gate Out Date, Trucker-Out, Gate Reposition Date, Trucker-Reposition, Reposition Location, Vessel Load Date, and Vessel Discharged”, for example, may require editing by the user. The user may edit these fields by entering the new information into their respective fields for the Cargo Record being edited.

The field “Weight” may also require editing by the user. The user may edit the Weight field for Break bulk by entering the new information for the Cargo Record being edited. The “Weight” field may only be used when Cargo Items are not in a Container. Such use may serve as an alternative for Container Gross Weight.

Once the user has finished entering any new information in the specified fields of the Cargo Record being edited, the user may select “Update” to record the changes to the Cargo Record in to the system.

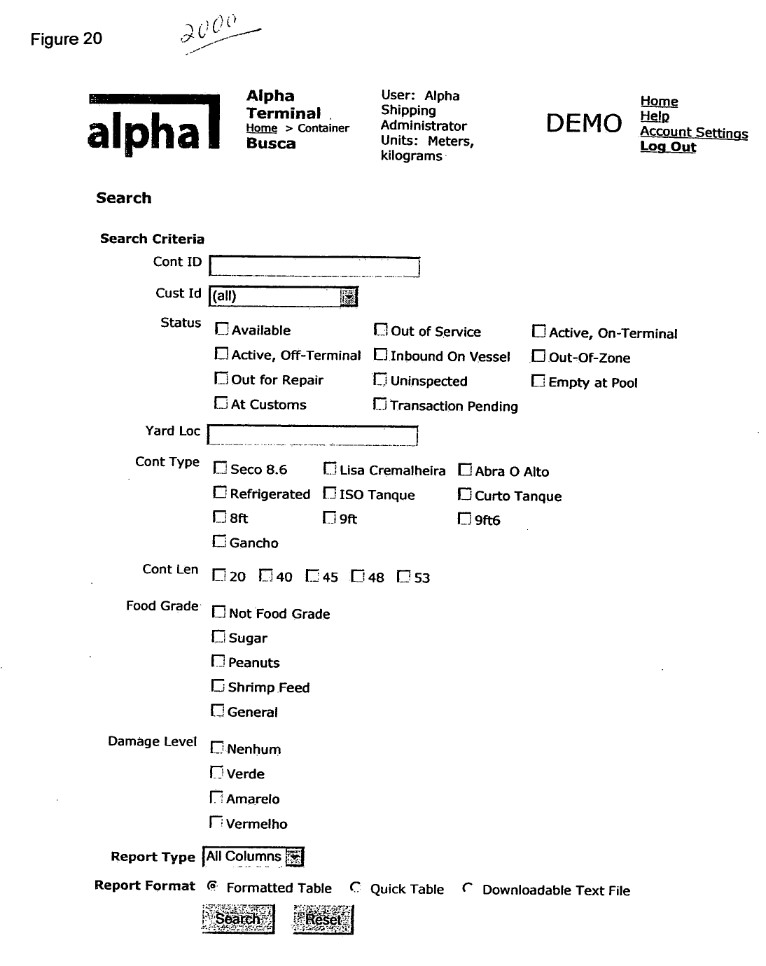

According to another aspect of the present invention, each user may be assigned a role, and each role may have associated therewith one or more permissions. For example, a user may be an administrator, such as a terminal administrator, and may have a permission, such as the ability to manage containers. Such a user may engage in a task, such as entering the system via the general entry and reaching the “Containers” request screen, as illustrated in FIG. 20. The Containers function may be used to locate Containers with specific attributes. Once the system displays the search results, it may then be possible to edit these related attributes.

To search containers, a user may select “Containers” from the Search section of the Main Menu. A Search for Containers may be based on criteria, such as Container ID, Customer ID, Status, Yard Location, Container Type, Container Length, Food Grade, Damage Level, Report Type, and Report Format, for example, to obtain the search results.

The user may select “Container ID” and enter a unique Container ID number. This unique ID may be comprised of four letters followed by six digits and usually a seventh digit that acts as a checksum digit. The user may enter a whole Container ID or a partial Container ID into the field. As an example of this, if the user entered the letter “C” into this field, the search results may consist only of Containers that have a Container ID containing the letter “C”.

The user may select “Customer ID” and enter the Customer ID for the customer that may own the containers that the user may like to appear in the Search Results. If a Customer ID has not been selected, the system may default to displaying the Containers owned by All Customers. If the user is a Customer User, the user may not have the ability to search by Customer ID.

The user may select “Status” and enter the status of the Container(s) that the user may want to appear in the search Results.

The user may select “Yard Location” and enter the yard location of the Container that the user may like to have appear in the search results.

The user may select “Container Type” and enter the Container Type for the Container(s) that the user may like to appear in the search Results.

The user may select “Container Length” and enter the Container Length for the Container(s) that the user may like to appear in the search Results.

The user may select “Food Grade” and enter the Food Grade for the Container(s) that the user may like to appear in the search Results.

The user may select “Damage Level” and enter the Damage Level for the Container(s) that the user may like to appear in the search Results.

The user may select “Report Type” which may allow the user to filter display results based upon a predefined Report.

The user may select “Report Format” and enter the Format the user would like for the search results. An example Report Format may be a Formatted Table. A Formatted Table may be an aesthetically pleasing HTML formatted page. For large reports, the HTML may take a while to generate. Another example Report Format may be a Quick Table. A Quick Table generates using simple text rather than HTML tables. It may be less aesthetically pleasing, but may generate much quicker than the Formatted Table, which may be very useful for large reports. Another example Report Format may be a Downloadable Text File. A Downloadable Text File generates a Tab Delimited Text File. This format may be imported to most spreadsheets for further manipulation.

The user may select “Search” to perform the Container Search based upon the criteria specified in the areas above. The Container Search Results page may list Containers based upon the criteria entered above.

From the Container Search Results screen, the user may choose to edit a Container record. To Edit a Container, the user may select “Edit” for the Container record to be edited. On the Container Edit screen the user may be presented with the information, such as Container ID, Customer ID, Status, Container Type, Container Length, Tare Weight, Food Grade, and Damage Level, for example, that the user may edit about the Container.

The user may select “Container ID” and enter a unique Container ID number. This unique ID may be comprised of four letters followed by six digits and usually a seventh digit that may act as a checksum digit.

The user may select “Customer ID” and enter the Customer ID for the customer that owns the Container being edited.

The user may select “Status” and enter the Status of the Container being edited.

The user may select “Container Type” and enter the Container Type of the Container being edited.

The user may select “Container Length” and enter the Container Length of the Container being edited.

The user may select “Tare Weight” and enter the weight of the Container being edited.

The user may select “Food Grade” and enter the Food Grade of the Container being edited.

The user may select “Damage Level” and enter the Damage Level of the Container being edited.

The user may select “Update” to record the changes made to the Container in to the system.

It may be important to note that users that are Customer Users logged in may only have access through the system to Equipment that belongs to them.

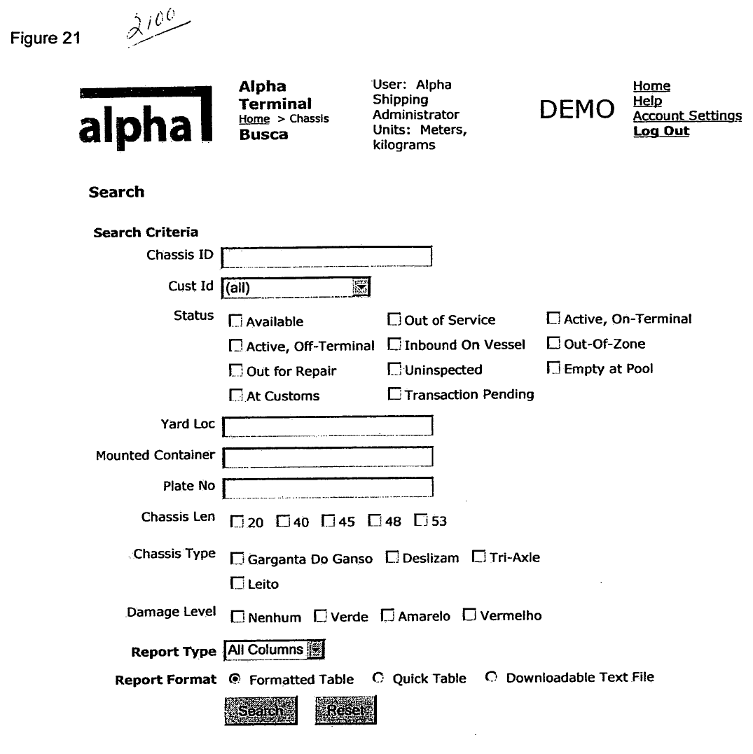

According to another aspect of the present invention, each user may be assigned a role, and each role may have associated therewith one or more permissions. For example, a user may be an administrator, such as a terminal administrator, and may have a permission, such as the ability to manage chassis. Such a user may engage in a task, such as entering the system via the general entry and reaching the “Chassis” request screen, as illustrated in FIG. 21. The Chassis function may be used to locate Chassis with specific attributes. Once the system displays the search results, it may then be possible to edit these related attributes.

To search chassis, a user may select “Chassis” from the Search section of the Main Menu. A Search for Chassis may be based on criteria, such as Chassis ID, Customer ID, Status, Mounted Container, Yard Location, Plate Number, Chassis Length, Chassis Type, Damage Level, Report Type, and Report Format, for example, may be used to obtain the search results.

The user may select “Chassis ID” and enter a unique Chassis ID number. This unique ID may be comprised of four letters followed by six digits and usually a seventh digit that acts as a checksum digit. The user may enter a whole Chassis ID or a partial Chassis ID into the field. As an example of this, if the user entered the letter “C” into this field, the search results may consist only of Chassis that have a Chassis ID containing the letter “C”.

The user may select “Customer ID” and enter the Customer ID for the customer that may own the chassis that the user may like to appear in the Search Results. If a Customer ID has not been selected, the system may default to displaying the Chassis owned by All Customers. If the user is a Customer User, the user may not have the ability to search by Customer ID.

For example, the user may select “Status” and enter the status of the Chassis that the user may like to appear in the search Results.

The user may select “Yard Location” and enter the location in the yard of the chassis that the user may like to appear in the search results.

The user may select “Mounted Container” and enter the mounted container of the chassis that the user may like to appear in the search results.

The user may select “Plate Number” and enter the whole Plate Number or part of the Plate Number into the field. As an example of this, if the user enters the number “1” into the field, the search results may consist of Chassis that have a Chassis License Plate Number containing the number “1”.

The user may select “Chassis Length” and enter the Chassis Length for the Chassis that the user may like to appear in the search Results.

The user may select “Chassis Type” and enter the Chassis Type for the Chassis that the user may like to appear in the search Results.

The user may select “Damage Level” and enter the Damage Level for the Chassis that the user may like to appear in the search Results.

The user may select “Report Type” which may allow the user to filter display results based upon a predefined Report.

The user may select “Report Format” and enter the Format the user would like for the search results. An example Report Format may be a Formatted Table. A Formatted Table may be an aesthetically pleasing HTML formatted page. For large reports, the HTML may take a while to generate. Another example Report Format may be a Quick Table. A Quick Table generates using simple text rather than HTML tables. It may be less aesthetically pleasing, but may generate much quicker than the Formatted Table, which may be very useful for large reports. Another example Report Format may be a Downloadable Text File. A Downloadable Text File generates a Tab Delimited Text File. This format may be imported to most spreadsheets for further manipulation.

The user may select “Search” to perform the Chassis Search based upon the criteria specified in the areas above. The Chassis Search Results page may list Chassis based upon the criteria entered above.

From the Chassis Search Results screen, the user may choose to edit a Chassis record. To Edit a Chassis, the user may select “Edit” for the Chassis record to be edited. On the Chassis Edit screen the user may be presented with information, such as Chassis ID, Customer ID, Status, Plate Number, Chassis Length, Chassis Type, Chassis Weight, Damage Level, Outside Tires, and Inside Tires, for example, that the user may edit about the Chassis.

For example, the user may select “Chassis ID” and enter a unique Chassis ID number. This unique ID may be comprised of four letters followed by six digits and usually a seventh digit that may act as a checksum digit.

The user may select “Customer ID” and enter the Customer ID for the customer that owns the Chassis being edited.

The user may select “Status” and enter the Status of the Chassis being edited.

The user may select “Plate Number” and enter the License Plate Number of the Chassis being edited.

The user may select “Chassis Length” and enter the Chassis Length of the Chassis being edited.

The user may select “Chassis Type” and enter the Chassis Type of the Chassis being edited.

The user may select “Chassis Weight” and enter the Weight of the Chassis being edited.

The user may select “Damage Level” and enter the Damage Level of the Chassis being edited.

The user may select “Outside Tires” and enter the four Outside Tires, two on the left, and two on the right. The user may select “Tire Manufacturer” from the drop-down menu, and indicated if the tire is a Retreaded Tire or not. The user may also indicate if the tire has a cap or not. If the tire has a Cap, the user may edit the Cap Number in the space provided.

The user may select “Inside Tires” and enter the four Inside Tires, two on the left, and two on the right. The user may select “Tire Manufacturer” from the drop-down menu, and indicated if the tire is a Retreaded Tire or not. Inside tires may not have Caps.

The user may select “Update” to record the changes made to the Chassis in to the system.

It may be important to note that users that are Customer Users logged in may only have access through the system to Equipment that belongs to them.

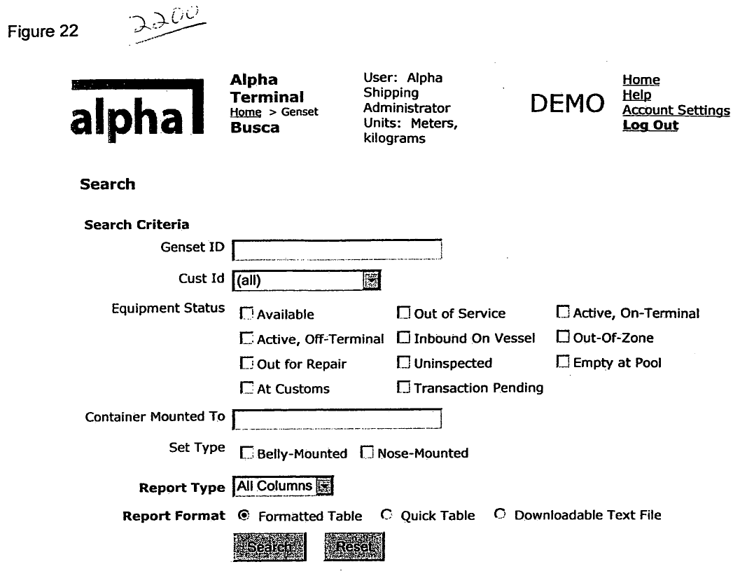

According to another aspect of the present invention, each user may be assigned a role, and each role may have associated therewith one or more permissions. For example, a user may be an administrator, such as a terminal administrator, and may have a permission, such as the ability to manage Gensets. Such a user may engage in a task, such as entering the system via the general entry and reaching the “Gensets” request screen, as illustrated in FIG. 22. The Gensets function may be used to locate Gensets with specific attributes. Once the system displays the search results, it may then be possible to edit these related attributes.

To search Gensets, a user may select “Gensets” from the Search section of the Main Menu. A Search for Gensets may be based on criteria, such as Genset ID, Customer ID, Equipment Status, Container Mounted To, Set Type, Report Type, and Report Format, for example, which may be used to obtain the search results.

The user may select “Genset ID” and enter a unique Genset ID number. This unique ID may be comprised of four letters followed by six digits and usually a seventh digit that acts as a checksum digit. The user may enter a whole Genset ID or a partial Genset ID into the field. As an example of this, if the user entered the letter “C” into this field, the search results may consist only of Genset that have a Genset ID containing the letter “C”.

The user may select “Customer ID” and enter the Customer ID for the customer that may own the Genset that the user may like to appear in the Search Results. If a Customer ID has not been selected, the system may default to displaying the Genset owned by All Customers. If the user is a Customer User, the user may not have the ability to search by Customer ID.

The user may select “Equipment Status” and enter the status of the Genset that the user may like to appear in the search Results.

The user may select “Container Mounted To”, and enter the container mounted for the Genset that the user may like to appear in the search results.

The user may select “Set Type” and enter the Set Type for the Genset that the user may like to appear in the search Results.

The user may select “Report Type” which may allow the user to filter display results based upon a predefined Report.

The user may select “Report Format” and enter the Format the user would like for the search results. An example Report Format may be a Formatted Table. A Formatted Table may be an aesthetically pleasing HTML formatted page. For large reports, the HTML may take a while to generate. Another example Report Format may be a Quick Table. A Quick Table generates using simple text rather than HTML tables. It may be less aesthetically pleasing, but may generate much quicker than the Formatted Table, which may be very useful for large reports. Another example Report Format may be a Downloadable Text File. A Downloadable Text File generates a Tab Delimited Text File. This format may be imported to most spreadsheets for further manipulation.

The user may select “Search” to perform the Genset Search based upon the criteria specified in the areas above. The Genset Search Results page may list Gensets based upon the criteria entered above.

From the Genset Search Results screen, the user may choose to edit a Genset record. To Edit a Genset, the user may select “Edit” for the Genset record to be edited. On the Genset Edit screen the user may be presented with information, such as Genset ID, Customer ID, Status, Set Type, and Fuel Level, for example, that the user may edit about the Genset.

The user may select “Genset ID” and enter a unique Genset ID number. This unique ID may be comprised of four letters followed by six digits and usually a seventh digit that may act as a checksum digit.

The user may select “Customer ID” and enter the Customer ID for the customer that owns the Genset being edited.

The user may select “Status” and enter the Status of the Genset being edited.

The user may select “Set Type” and enter the Set Type of the Genset being edited.

The user may select “Fuel Level” and enter the Fuel Level of the Genset being edited.

The user may select “Update” to record the changes made to the Genset in to the system.

It may be important to note that users that are Customer Users logged in may only have access through the system to Equipment that belongs to them.

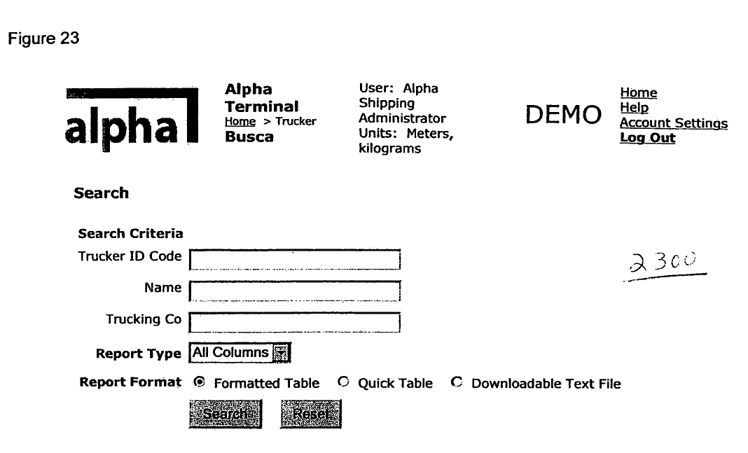

According to another aspect of the present invention, each user may be assigned a role, and each role may or may not have associated therewith one or more permissions. For example, a user may be an administrator, such as a gate administrator, and may not be required to have a permission. Such a user may engage in a task, such as entering the system via the general entry and reaching the “Truckers” request screen, as illustrated in FIG. 23. The Truckers function may be used to locate Truckers with specific attributes. Once the system displays the search results, it may then be possible to edit these related attributes.

To search truckers, a user may select “Truckers” from the Search section of the Main Menu. A Search for Truckers may be based on criteria, such as Trucker ID Code, Name, Trucking Company, Report Type, and Report Format, for example, which may be used to obtain the search results.

For example, the user may select “Trucker ID Code” and enter a unique Trucker ID code. The unique ID may be comprised of any alpha-numeric combination. The user enter a whole Trucker ID or a partial Trucker ID into the field. As an example of this, if the user enters “1” into the field, the search results may consist of Truckers that have a Trucker ID containing the number “1”.

The user may select “Name” and enter a whole Trucker Name or a partial Trucker Name into the field. As an example of this, if the user enters “E” into the field, the search results may consist of Truckers that have a Name containing the letter “E”.

The user may select “Trucking Company” and enter a whole Trucking Company Name or a partial Trucking Company Name into the field. As an example of this, if the user enters “D” into the field, the search results may consist of Truckers that have a Trucking Company Name containing the letter “D”.

The user may select “Report Type” which may allow the user to filter display results based upon a predefined Report.

The user may select “Report Format” and enter the Format the user would like for the search results. An example Report Format may be a Formatted Table. A Formatted Table may be an aesthetically pleasing HTML formatted page. For large reports, the HTML may take a while to generate. Another example Report Format may be a Quick Table. A Quick Table generates using simple text rather than HTML tables. It may be less aesthetically pleasing, but may generate much quicker than the Formatted Table, which may be very useful for large reports. Another example Report Format may be a Downloadable Text File. A Downloadable Text File generates a Tab Delimited Text File. This format may be imported to most spreadsheets for further manipulation.

The user may select “Search” to perform the Trucker Search based upon the criteria specified in the areas above. The Trucker Search Results page may list Truckers based upon the criteria entered above.

From the Truckers Search Results screen, the user may choose to edit a Trucker record. To Edit a Trucker, the user may select “Edit” for the Trucker record to be edited. On the Trucker Edit screen the user may be presented with information, such as Trucker ID Code, ID Card, Name, and Trucking Company, for example, that the user may edit about the Trucker.

For example, the field “Trucker ID Code” may display the Trucker ID Code.

The field “ID Card” may allow the user to select “Barcode” to display the Barcode that should appear on the Trucker's ID Card.

The user may select “Name” to edit the Trucker's Name.

The user may select “Trucking Company” to edit the name of the Trucking Company that the Trucker may be employed by. The user may select “Update” to record the changes to the Trucker in to the system.

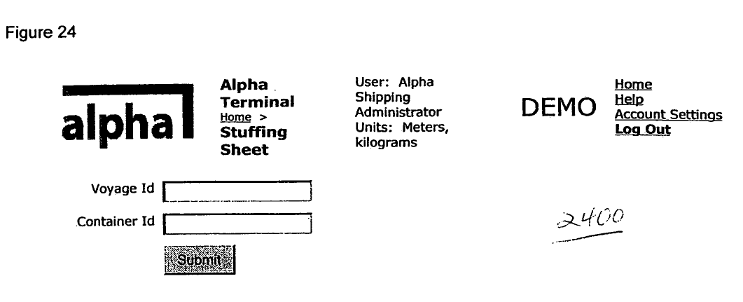

According to another aspect of the present invention, each user may be assigned a role, and each role may or may not have associated therewith one or more permissions. For example, a user may be an administrator, and such a user may engage in a task, such as entering the system via the general entry and reaching the “Stuffing Sheet” request screen, as illustrated in FIG. 24.

To search Stuffing Sheets, a user may select “Stuffing Sheet” from the Search section of the Main Menu. The user may enter either the Voyage ID or Container ID and select “Submit”.

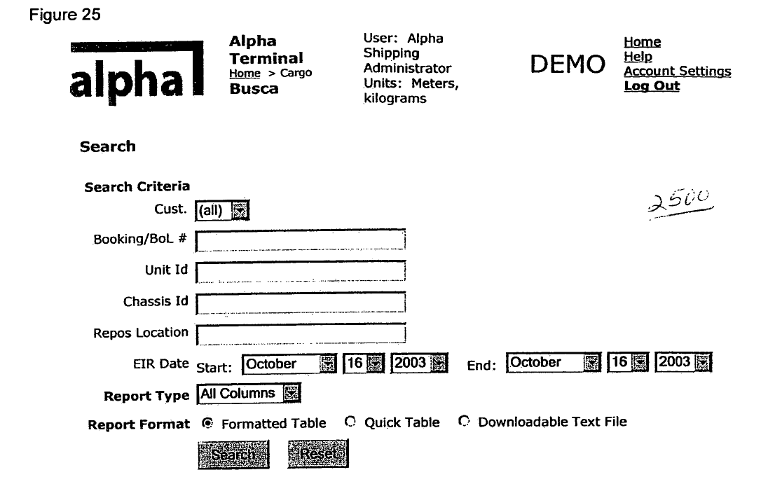

According to another aspect of the present invention, each user may be assigned a role, and each role may or may not have associated therewith one or more permissions. For example, a user may be an administrator, and such a user may engage in a task, such as entering the system via the general entry and reaching the “Gate Activity” request screen, as illustrated in FIG. 25.

To search Gate Activity, a user may select “Gate Activity” from the Search section of the Main Menu. The user may enter search criteria, such as Customer, Booking/BOL Number, Unit ID, Chassis ID, Reposition Location, EIR Date, Report Type, and Report Format, for example, to obtain a search report. When all of the required information has been entered, the user may select “Search” to enter it into the system. It is important to note that while the searching system may also be used to search and manage the database as described herein, the searching system may also be functional with any existing and legacy database structures, as will be understood be those of ordinary skill in the pertinent arts.

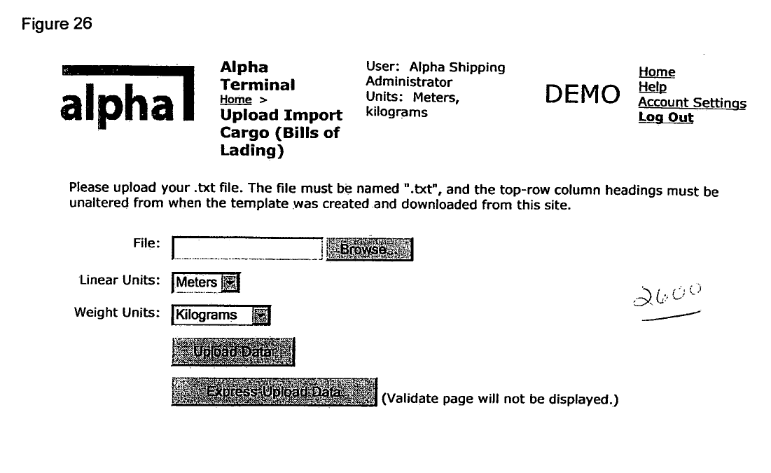

According to another aspect of the present invention, a user may be an administrator, such as a terminal administrator, or a line administrator, and may have a permission, such as the ability to upload Bills of Lading. Such a user may engage in a task, such as entering the system via the general entry and reaching the “BOL (Import)” request screen, as illustrated in FIG. 26. The Upload Import Cargo function may be used to upload a Tab Delimited Text File with Import Cargo (Bills of Lading) Information to speed up the process of adding Import Cargo (Bills of Lading) to the system through bulk upload.

To Upload Import Cargo (Bills of Lading), a user may select “BOL (Import)” from the Upload section on the Main Menu.

From the BOL (Import) screen, the user may select “Browse” to locate the Import Cargo (Bills of Lading) Bulk Upload Template Text file (cargo.txt as a default) from the computer's hard drive. This file may be obtained by the user selecting “BOL (Import)” from the Upload-Templates section of the Main Menu. Once the user has located the file, the user may highlight the file select “Open”. The Location of the file directory and file may appear in the File field.

The user may select “Linear Units” and “Weight Units” for information recorded as integers on the Bulk Upload Template file.

The user may upload the data followed by a Validation Page by selecting “Upload Data”, or the user may upload the data without a Validation Page by selecting “Express-Upload Data”.

The Validation Page may check the Bulk Upload Template for information that does not match the parameters needed for acceptance by the system. If the system reports errors in the Bulk Upload Template, the user may correct the errors and relocate the Bulk Upload Template Text file.

If the system reports that the Upload Data is error-free, the user may select “Confirm Upload” to add the information to the system.

If there are no errors reported, the system may report that the Upload is complete.

If the user is a Terminal user performing the upload, the System may require that the “cust_id field” be completed by the user.

If the user is a Customer user performing the upload, then the System does not require that the “cust-id field” be completed because the System recognizes that they are logged in under a specific Customer.

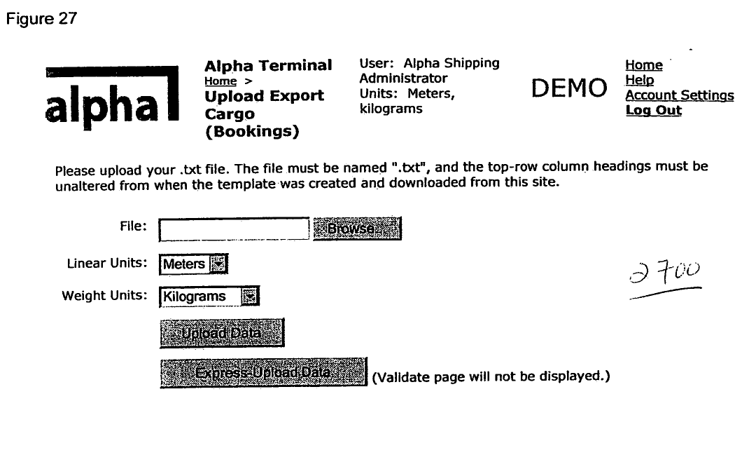

According to another aspect of the present invention, each user may be assigned a role, and each role may have associated therewith one or more permissions. Further, each user role may be further subdivided, as may be each permission. For example, a user may be an administrator, such as a terminal administrator, or a line administrator, and may have a permission, such as the ability to upload Bookings. Such a user may engage in a task, such as entering the system via the general entry and reaching the “Bookings (Export)” request screen, as illustrated in FIG. 27. The Bookings (Export) function may be used to upload a Tab Delimited Text File with Export Cargo (Bookings) Information to speed up the process of adding Export Cargo (Bookings) to the system through bulk upload.

To Upload Export Cargo (Bookings), a user may select “Bookings (Export)” from the Upload section on the Main Menu.

From the Bookings (Export) screen, the user may select “Browse” to locate the Export Cargo (Bookings) Bulk Upload Template Text file (cargo.txt as a default) from the computer's hard drive. This file may be obtained by the user selecting “Bookings (Export)” from the Upload-Templates section of the Main Menu. Once the user has located the file, the user may highlight the file and select “Open”. The Location of the file directory and file may appear in the File field.

The user may select “Linear Units” and “Weight Units” for information recorded as integers on the Bulk Upload Template file.

The user may upload the data followed by a Validation Page by selecting “Upload Data”, or the user may upload the data without a Validation Page by selecting “Express-Upload Data”.

The Validation Page may check the Bulk Upload Template for information that does not match the parameters needed for acceptance by the system. If the system reports errors in the Bulk Upload Template, the user may correct the errors and relocate the Bulk Upload Template Text file.

If the system reports that the Upload Data is error-free, the user may select “Confirm Upload” to add the information to the system. If there are no errors reported, the system may report that the Upload is complete.

If the user is a Terminal (Internal) user performing the upload, the System may require that the “cust_id field” be completed by the user. If the user is a Customer user performing the upload, then the System does not require that the “cust-id field” be completed because the System recognizes that they may be logged in under a specific Customer.

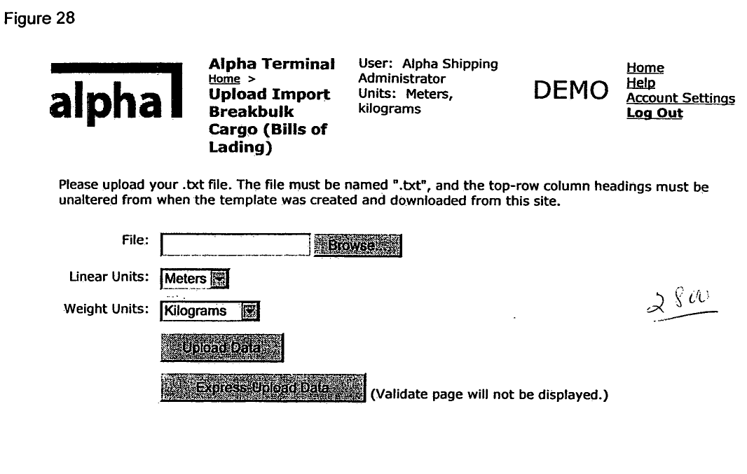

According to another aspect of the present invention, a user may be an administrator, such as a terminal administrator, or a line administrator, and may have a permission, such as the ability to upload Bills of Lading. Such a user may engage in a task, such as entering the system via the general entry and reaching the “Import B/B Cargo (BOL)” request screen, as illustrated in FIG. 28. The Upload Import Break-bulk Cargo function may be used to upload a Tab Delimited Text File with Import Cargo (Bills of Lading) Information to speed up the process of adding Import Break-bulk Cargo (Bills of Lading) to the system through bulk upload.

To Upload Import Break-bulk Cargo (Bills of Lading), a user may select “Import B/B Cargo (BOL)” from the Upload section on the Main Menu.

From the Import B/B Cargo (BOL) screen, the user may select “Browse” to locate the Import B/B Cargo (BOL) Bulk Upload Template Text file (cargo.txt as a default) from the computer's hard drive. This file may be obtained by the user selecting “Import B/B Cargo (BOL)” from the Upload-Templates section of the Main Menu. Once the user has located the file, the user may highlight the file select “Open”. The Location of the file directory and file may appear in the File field.

The user may select “Linear Units” and “Weight Units” for information recorded as integers on the Bulk Upload Template file.

The user may upload the data followed by a Validation Page by selecting “Upload Data”, or the user may upload the data without a Validation Page by selecting “Express-Upload Data”.

The Validation Page may check the Bulk Upload Template for information that does not match the parameters needed for acceptance by the system. If the system reports errors in the Bulk Upload Template, the user may correct the errors and relocate the Bulk Upload Template Text file.

If the system reports that the Upload Data is error-free, the user may select “Confirm Upload” to add the information to the system.

If there are no errors reported, the system may report that the Upload is complete.

If the user is a Terminal user performing the upload, the System may require that the “cust_id field” be completed by the user.

If the user is a Customer user performing the upload, then the System does not require that the “cust-id field” be completed because the System recognizes that they are logged in under a specific Customer.

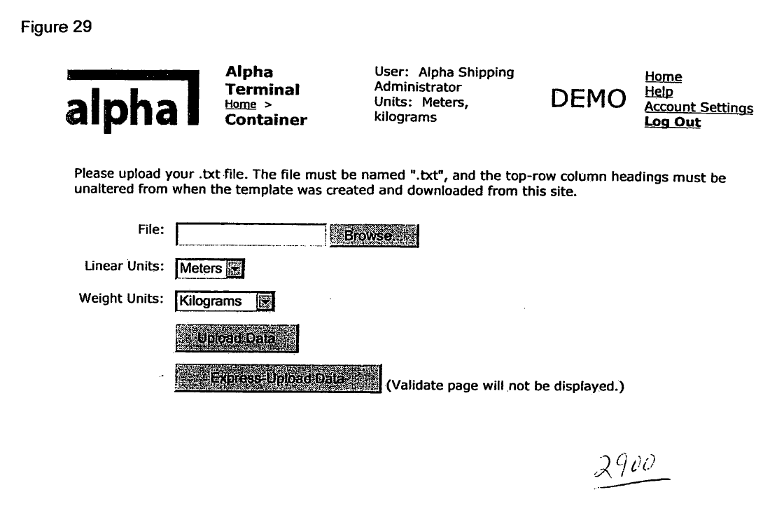

According to another aspect of the present invention, each user may be assigned a role, and each role may have associated therewith one or more permissions. For example, a user may be an administrator, such as a terminal administrator, and may have a permission, such as the ability to manage containers. Such a user may engage in a task, such as entering the system via the general entry and reaching the “Container List” request screen, as illustrated in FIG. 29. The Upload Container List function may be used to upload a Tab Delimited Text File with Container Information to speed up the process of adding Containers to the system through bulk upload.

To Upload Container Lists, a user may select “Container List” from the Upload section on the Main Menu.

From the Container List screen, the user may select “Browse” to locate the Container Bulk Upload Template Text file (containers.txt as a default) from the computer's hard drive. This file may be obtained by the user selecting “Container List” from the Upload-Templates section of the Main Menu. Once the user has located the file, the user may highlight the file and select “Open”. The location of the file directory and file may appear in the File field.

The user may select “Linear Units” and “Weight Units” for information recorded as integers on the Bulk Upload Template file.

The user may upload the data followed by a Validation Page by selecting “Upload Data”, or the user may upload the data without a Validation Page by selecting “Express-Upload Data”.

The Validation Page may check the Bulk Upload Template for information that does not match the parameters needed for acceptance by the system. If the system reports errors in the Bulk Upload Template, the user may correct the errors and relocate the Bulk Upload Template Text file.

If the system reports that the Upload Data is error-free, the user may select “Confirm Upload” to add the information to the system.

If there are no errors reported, the system may report that the Upload is complete.

If the user may be a Terminal user performing the upload, the System may require that the “cust_id field” be completed by the user.

If the user may be a Customer user performing the upload, then the System may not require that the “cust-id field” be completed because the System recognizes that they may be logged in under a specific Customer.

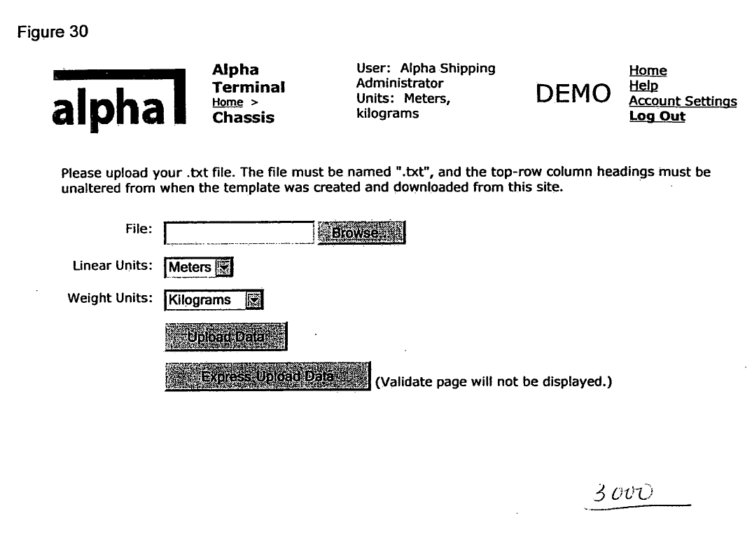

According to another aspect of the present invention, a user may be an administrator, such as a terminal administrator, and may have a permission, such as the ability to manage a chassis, for example. Such a user may engage in a task, such as entering the system via the general entry and reaching the “Chassis List” request screen, as illustrated in FIG. 30. The Upload Chassis List function may be used to upload a Tab Delimited Text File with Chassis Information to speed up the process of adding Chassis to the system through bulk upload.

To Upload Chassis Lists, a user may select “Chassis List” from the Upload section on the Main Menu.

From the Chassis List screen, the user may select “Browse” to locate the Chassis Bulk Upload Template Text file (chassis.txt as a default) from the computer's hard drive. This file may be obtained by the user selecting “Chassis List” from the Upload-Templates section of the Main Menu. Once the user has located the file, the user may highlight the file and select “Open”. The Location of the file directory and file may appear in the File field.

The user may select “Linear Units” and “Weight Units” for information recorded as integers on the Bulk Upload Template file.

The user may upload the data followed by a Validation Page by selecting “Upload Data”, or the user may upload the data without a Validation Page by selecting “Express-Upload Data”.

The Validation Page may check the Bulk Upload Template for information that does not match the parameters needed for acceptance by the system. If the system reports errors in the Bulk Upload Template, the user may correct the errors and relocate the Bulk Upload Template Text file.

If the system reports that the Upload Data is error-free, the user may select “Confirm Upload” to add the information to the system.

If there are no errors reported, the system may report that the Upload is complete.

If the user is a Terminal user performing the upload, the System may require that the “cust_id field” be completed by the user. If the user is a Customer user performing the upload, then the System may not require that the “cust-id field” be completed because the System may recognize that they may be logged in under a specific Customer.

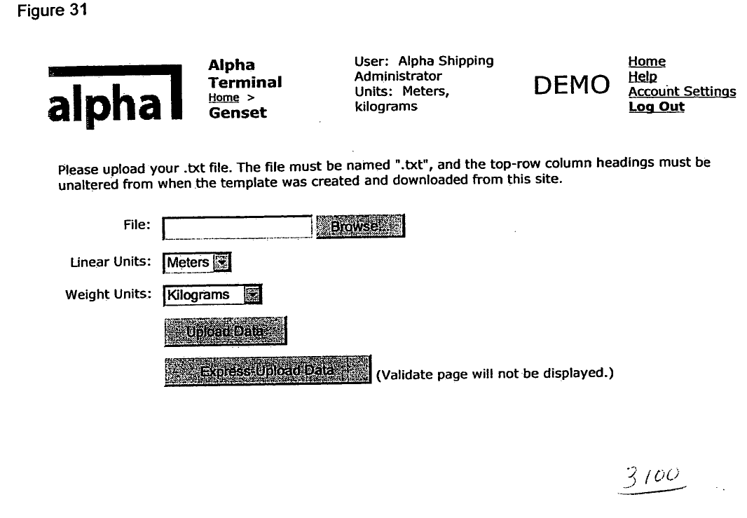

According to another aspect of the present invention, a user may be an administrator, such as a terminal administrator, and may have a permission, such as the ability to manage a Genset, for example. Such a user may engage in a task, such as entering the system via the general entry and reaching the “Genset List” request screen, as illustrated in FIG. 31. The Upload Genset List function may be used to upload a Tab Delimited Text File with Genset Information to speed up the process of adding Gensets to the system through bulk upload.

To Upload Genset Lists, a user may select “Genset List” from the Upload section on the Main Menu.

From the Genset List screen, the user may select “Browse” to locate the Genset Bulk Upload Template Text file (Gensets.txt as a default) from the computer's hard drive. This file may be obtained by the user selecting “Genset List” from the Upload-Templates section of the Main Menu. Once the user has located the file, the user may highlight the file and select “Open”. The Location of the file directory and file may appear in the File field.

The user may select “Linear Units” and “Weight Units” for information recorded as integers on the Bulk Upload Template file.

The user may upload the data followed by a Validation Page by selecting “Upload Data”, or the user may upload the data without a Validation Page by selecting “Express-Upload Data”.

The Validation Page may check the Bulk Upload Template for information that does not match the parameters needed for acceptance by the system. If the system reports errors in the Bulk Upload Template, the user may correct the errors and relocate the Bulk Upload Template Text file.

If the system reports that the Upload Data is error-free, the user may select “Confirm Upload” to add the information to the system.

If there are no errors reported, the system may report that the Upload is complete.

If the user is a Terminal user performing the upload, the System may require that the “cust_id field” be completed by the user.

If the user is a Customer user performing the upload, then the System may not require that the “cust-id field” be completed because the System recognizes that they may be logged in under a specific Customer.

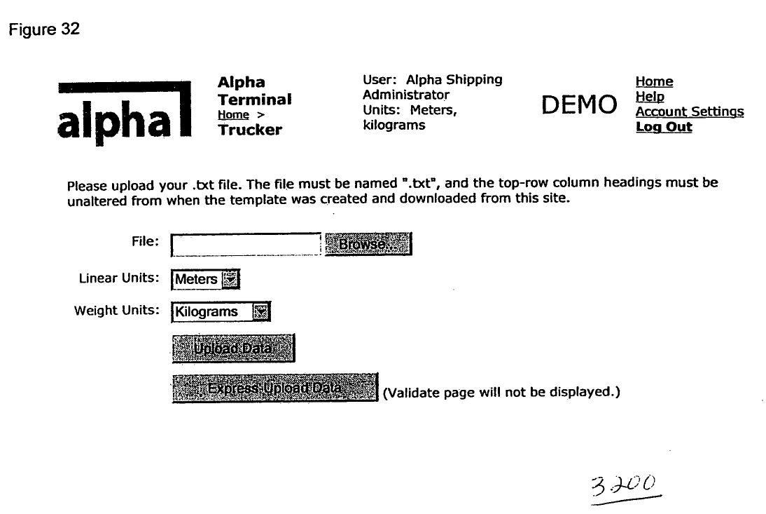

According to another aspect of the present invention, each user may be assigned a role, and each role may have associated with it one or more permissions. For example, a user may be an administrator, such as a terminal administrator, and may have a permission, such as the ability to upload truckers. Such a user may engage in a task, such as entering the system via the general entry and reaching the “Truckers” request screen, as illustrated in FIG. 32. The Upload Truckers function may be used to upload a Tab Delimited Text File with Trucker Information to speed up the process of adding Truckers to the system through bulk upload.

To Upload Truckers, a user may select “Truckers” from the Upload section on the Main Menu.

From the Truckers screen, the user may select “Browse” to locate the Trucker Bulk Upload Template Text file (truckers.txt as a default) from the computer's hard drive. This file may be obtained by the user selecting “Truckers” from the Upload-Templates section of the Main Menu. Once the user has located the file, the user may highlight the file and select “Open”. The Location of the file directory and file may appear in the File field.

The user may select “Linear Units” and “Weight Units” for information recorded as integers on the Bulk Upload Template file.

The user may upload the data followed by a Validation Page by selecting “Upload Data”, or the user may upload the data without a Validation Page by selecting “Express-Upload Data”.

The Validation Page may check the Bulk Upload Template for information that does not match the parameters needed for acceptance by the system. If the system reports errors in the Bulk Upload Template, the user may correct the errors and relocate the Bulk Upload Template Text file.

If the system reports that the Upload Data is error-free, the user may select “Confirm Upload” to add the information to the system. If there are no errors reported, the system may report that the Upload is complete.

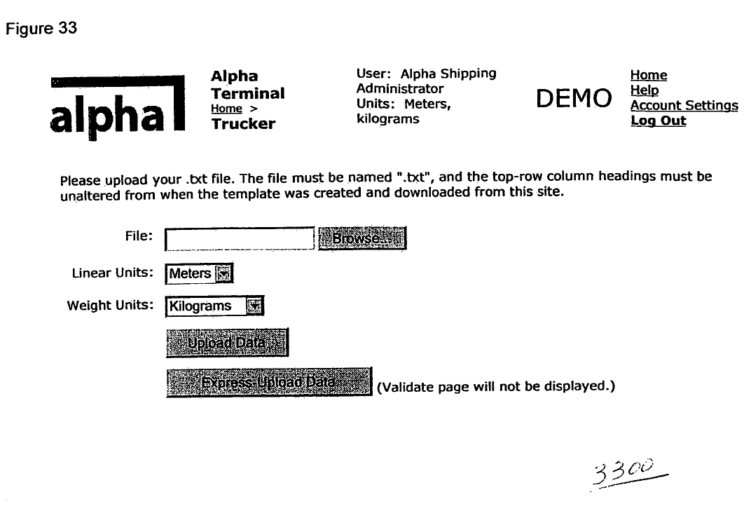

According to another aspect of the present invention, each user may be assigned a role, and each role may have associated therewith one or more permissions. For example, a user may be an administrator, such as a terminal administrator, and may have a permission, such as the ability to upload bills of lading. Such a user may engage in a task, such as entering the system via the general entry and reaching the “BOL (Import)” request screen, as illustrated in FIG. 33. The Upload-Templates section may be used to download a Tab Delimited Text File, which may be imported into a spreadsheet if desired by the user, to speed up the process of adding information to system through bulk upload. The BOL (Import) Template Upload may provide a template to speed the process of adding Import Cargo (Bills of Lading) into the system.

To Upload Bills of Lading, the user may select “BOL (Import)” from the Upload-Templates section of the Main Menu.

Required fields may appear on the Template for Upload. The user may select fields to include in the Upload Template. To select optional fields, the user may indicate in the box next to the optional field name that the user may like to include. Once the user has identified the fields the user would like to include on the Upload Template, the user may select “Create Template”.

The user may select “Download File” to download the Upload Template. On most systems, the user may right-click on the link, and may select “Save Target As . . . ” to save the template to the user's local computer.

When working with the Upload Template, the user may remove optional field columns, but the user may not try to add or change any columns on the Upload Template. It is advised that rather than try to edit the columns on the Upload Template, the user may create and download a new template with the system instead. The top line with column names must stay intact or the template may be rejected upon Upload. Some columns may have size limits. If the user exceeds these limits, the user may be warned when the user uploads the file.

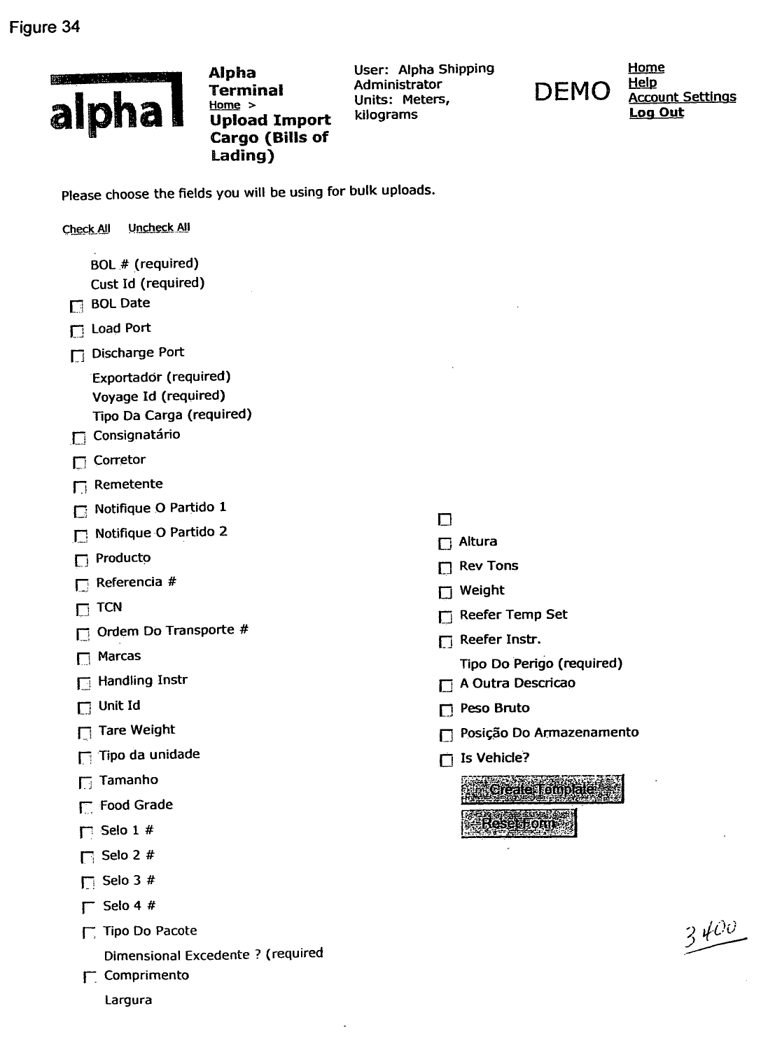

According to another aspect of the present invention, each user may be assigned a role, and each role may have associated therewith one or more permissions. For example, a user may be an administrator, such as a terminal administrator, and may have a permission, such as the ability to upload bookings. Such a user may engage in a task, such as entering the system via the general entry and reaching the “Bookings (Export)” request screen, as illustrated in FIG. 34. The Upload-Templates section may be used to download a Tab Delimited Text File, which may be imported into a spreadsheet if desired by the user, to speed up the process of adding information to system through bulk upload. The Bookings (Export) Upload Template may provide a template to speed the process of adding Export Cargo (Bookings) into the system.

To Upload Bookings, the user may select “Bookings (Export)” from the Upload-Templates section of the Main Menu.

Required fields may appear on the Template for Upload. The user may select fields to include in the Upload Template. To select optional fields, the user may indicate in the box next to the optional field name that the user may like to include. Once the user has identified the fields the user would like to include on the Upload Template, the user may select “Create Template”.

The user may select “Download File” to download the Upload Template. On most systems, the user may right-click on the link, and may select “Save Target As . . . ” to save the template to the user's local computer.

When working with the Upload Template, the user may remove optional field columns, but the user may not try to add or change any columns on the Upload Template. It is advised that rather than try to edit the columns on the Upload Template, the user may create and download a new template with the system instead. The top line with column names must stay intact or the template may be rejected upon Upload. Some columns may have size limits. If the user exceeds these limits, the user may be warned when the user uploads the file.

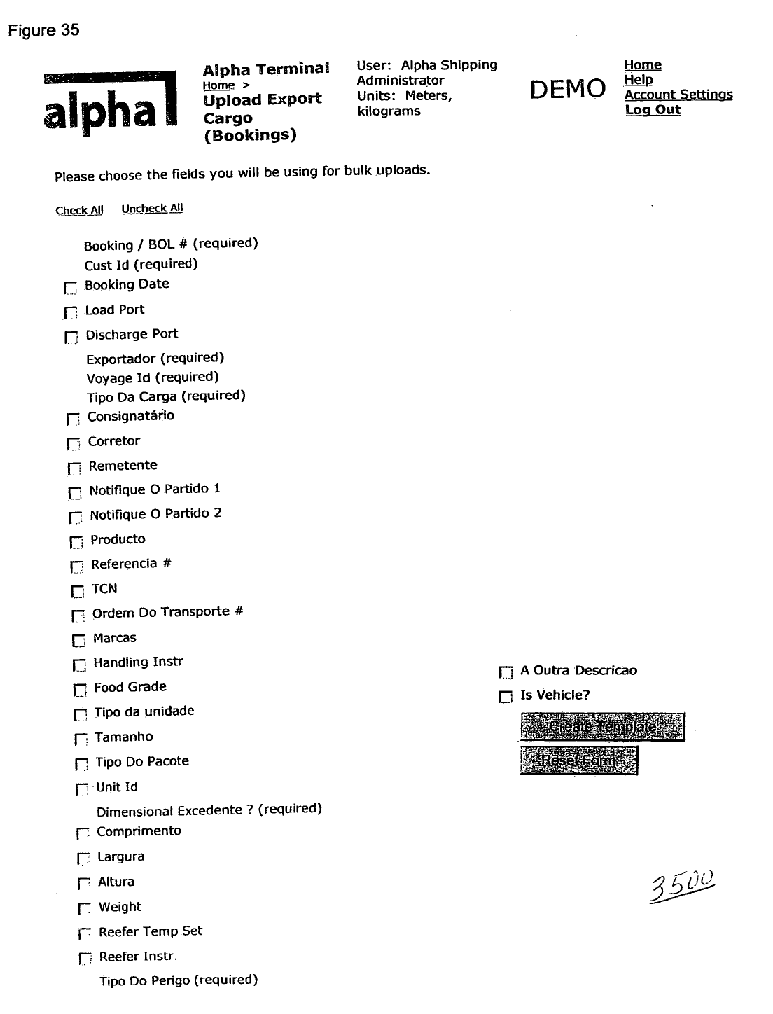

According to another aspect of the present invention, each user may be assigned a role, and each role may have associated therewith one or more permissions. For example, a user may be an administrator, such as a terminal administrator, and may have a permission, such as the ability to upload containers. Such a user may engage in a task, such as entering the system via the general entry and reaching the “Container List” request screen, as illustrated in FIG. 35. The Upload-Templates section may be used to download a Tab Delimited Text File, which may be imported into a spreadsheet if desired by the user, to speed up the process of adding information to system through bulk upload. The Containers Upload Template may provide a template to speed the process of adding Containers into the system.

To Upload Containers, the user may select “Container List” from the Upload-Templates section of the Main Menu.

Required fields may appear on the Template for Upload. The user may select fields to include in the Upload Template. To select optional fields, the user may indicate in the box next to the optional field name that the user may like to include. Once the user has identified the fields the user would like to include on the Upload Template, the user may select “Create Template”.

The user may select “Download File” to download the Upload Template. On most systems, the user may right-click on the link, and may select “Save Target As . . . ” to save the template to the user's local computer.

When working with the Upload Template, the user may remove optional field columns, but the user may not try to add or change any columns on the Upload Template. It is advised that rather than try to edit the columns on the Upload Template, the user may create and download a new template with the system instead. The top line with column names must stay intact or the template may be rejected upon Upload. Some columns may have size limits. If the user exceeds these limits, the user may be warned when the user uploads the file.

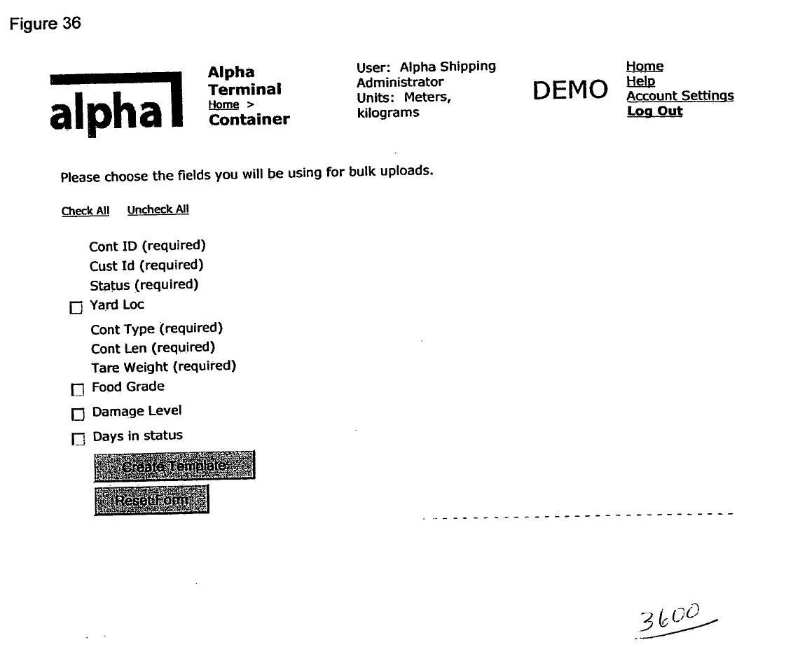

According to another aspect of the present invention, each user may be assigned a role, and each role may have associated with it one or more permissions. For example, a user may be an administrator, such as a terminal administrator, and may have a permission, such as the ability to upload chassis. Such a user may engage in a task, such as entering the system via the general entry and reaching the “Chassis List” request screen, as illustrated in FIG. 36. The Upload-Templates section may be used to download a Tab Delimited Text File, which may be imported into a spreadsheet if desired by the user, to speed up the process of adding information to system through bulk upload. The Chassis Upload Template may provide a template to speed the process of adding Chassis into the system.

To Upload Chassis, the user may select “Chassis List” from the Upload-Templates section of the Main Menu.

Required fields may appear on the Template for Upload. The user may select fields to include in the Upload Template. To select optional fields, the user may indicate in the box next to the optional field name that the user may like to include. Once the user has identified the fields the user would like to include on the Upload Template, the user may select “Create Template”.

The user may select “Download File” to download the Upload Template. On most systems, the user may right-click on the link, and may select “Save Target As . . . ” to save the template to the user's local computer.

When working with the Upload Template, the user may remove optional field columns, but the user may not try to add or change any columns on the Upload Template. It is advised that rather than try to edit the columns on the Upload Template, the user may create and download a new template with the system instead. The top line with column names must stay intact or the template may be rejected upon Upload. Some columns may have size limits. If the user exceeds these limits, the user may be warned when the user uploads the file.

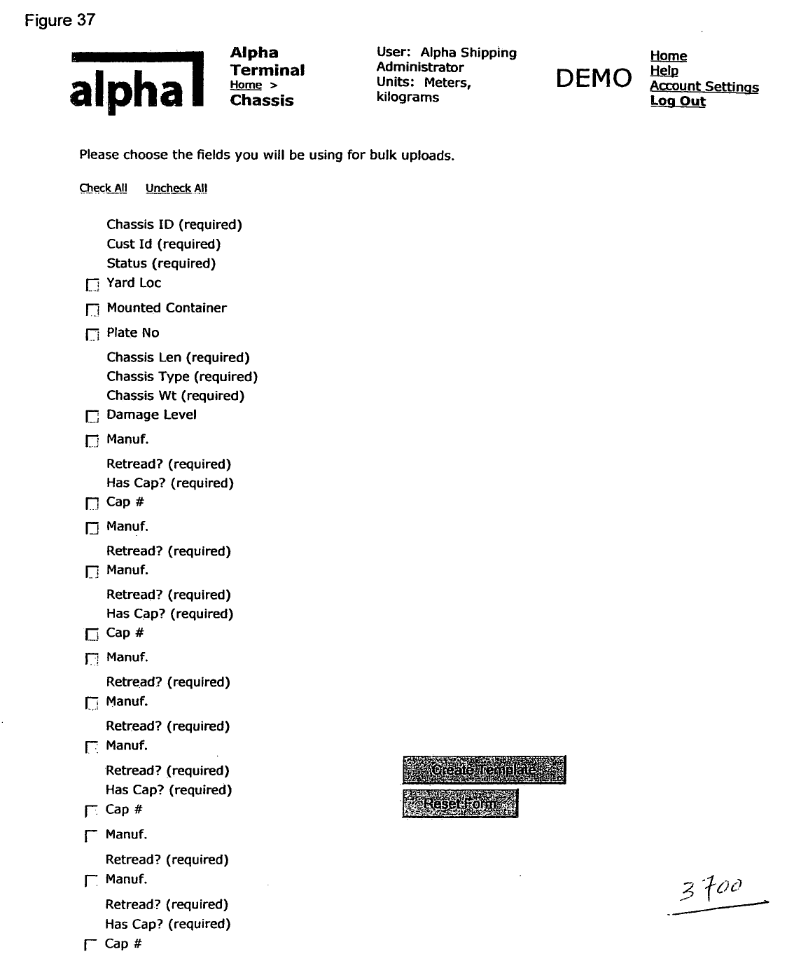

According to another aspect of the present invention, each user may be assigned a role, and each role may have associated therewith one or more permissions. For example, a user may be an administrator, such as a terminal administrator, and may have a permission, such as the ability to upload Gensets. Such a user may engage in a task, such as entering the system via the general entry and reaching the “Genset List” request screen, as illustrated in FIG. 37. The Upload-Templates section may be used to download a Tab Delimited Text File, which may be imported into a spreadsheet if desired by the user, to speed up the process of adding information to system through bulk upload. The Genset Upload Template may provide a template to speed the process of adding Gensets into the system.

To Upload Gensets, the user may select “Genset List” from the Upload-Templates section of the Main Menu.

Required fields may appear on the Template for Upload. The user may select fields to include in the Upload Template. To select optional fields, the user may indicate in the box next to the optional field name that the user may like to include. Once the user has identified the fields the user would like to include on the Upload Template, the user may select “Create Template”.

The user may select “Download File” to download the Upload Template. On most systems, the user may right-click on the link, and may select “Save Target As . . . ” to save the template to the user's local computer.

When working with the Upload Template, the user may remove optional field columns, but the user may not try to add or change any columns on the Upload Template. It is advised that rather than try to edit the columns on the Upload Template, the user may create and download a new template with the system instead. The top line with column names must stay intact or the template may be rejected upon Upload. Some columns may have size limits. If the user exceeds these limits, the user may be warned when the user uploads the file.

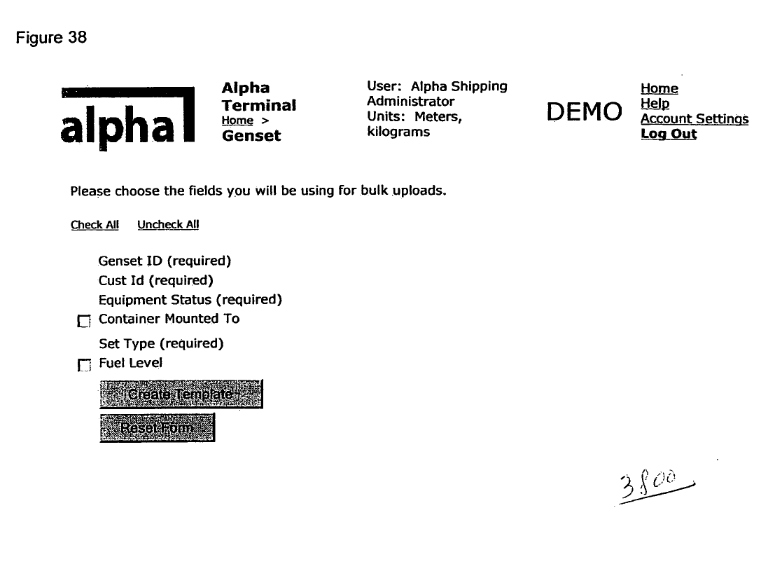

According to another aspect of the present invention, each user may be assigned a role, and each role may have associated therewith one or more permissions. For example, a user may be an administrator, such as a terminal administrator, and may have a permission, such as the ability to upload Truckers. Such a user may engage in a task, such as entering the system via the general entry and reaching the “Truckers” request screen, as illustrated in FIG. 38. The Upload-Templates section may be used to download a Tab Delimited Text File, which may be imported into a spreadsheet if desired by the user, to speed up the process of adding information to system through bulk upload. The Trucker Upload Template may provide a template to speed the process of adding Truckers into the system.

To Upload Truckers, the user may select “Truckers” from the Upload-Templates section of the Main Menu.

The user may select “Create Template” to create the Trucker Upload Template.

The user may select “Download File” to download the Upload Template. On most systems, the user may right-click on the link, and may select “Save Target As . . . ” to save the template to the user's local computer.

The user may not try to add, edit or delete any columns on the Upload Template. It may be required to keep the top line with the column names intact or the template may not work. Some columns may have size limits. If the user exceeds these limits, the user may be warned when the user uploads the file.

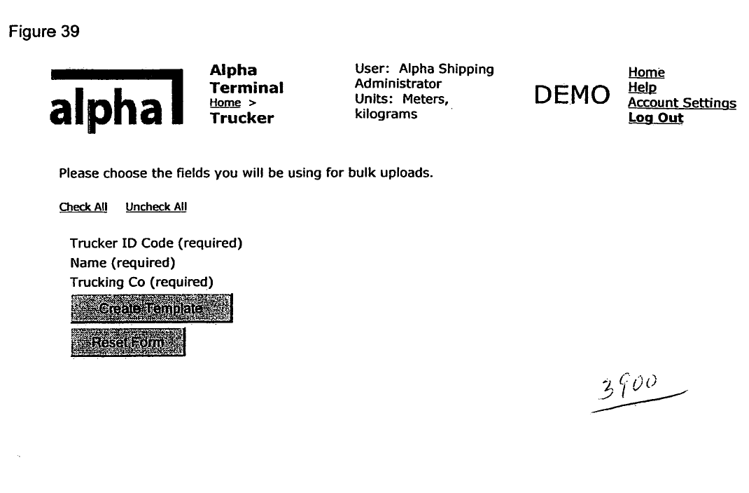

According to another aspect of the present invention, each user may be assigned a role, and each role may have associated therewith one or more permissions. Further, each user role may be further subdivided, as may be each permission. For example, a user may be an administrator, such as a user administrator, and may have a permission, such as the ability to manage customers. Such a user may engage in a task, such as entering the system via the general entry and reaching the “Customers” request screen, as illustrated in FIG. 39. The Customer Administration function may allow the user to add and edit Customers. Customers may be the Shipping Lines that use Terminal services. This area also may allow the user to add and edit Customer Users.

To select Customers, the user may select “Customers” from the Administration section of the Main Menu. From this screen the user may have the ability to add a New Customer to the system or view an existing Customer.

To add a New Customer to the system, the user may provide information, such as Customer Code and Name, to be added to the system.

The user may select “Customer Code” and enter a Customer Code for the customer that the user would like add to the system. Customer Codes must be a unique combination of letters, and optionally, numbers. The Customer Code information may be required by the system.

The user may select “Name” and enter the name of the customer that the user would like to add to the system. The Name may be any alphanumeric combination. The Name information may be required by the system.

The user may select “Add” to add the New Customer to the system.

The user may view a Customer through the Customer Info screen by selecting either “Customer Code” or “Customer Name”. The Customer Info screen may display information, such as Customer Code, Name, and Edit, that may be on the system.

The field “Customer Code” may display the Customer Code for the customer that the user may select.

The field “Name” may display the Customer Name for the customer that the user may have selected.

The user may select “Edit” to edit the Customer Information.

The Customer Users screen may display information, such as New User, User ID, Name, Active, and Manage, that may be on the system.

The user may select “New User” to create a new Customer User. A Customer User may be someone from the shipping line that needs access to the system to perform various functions.

The field “User ID” may display the User IDs of Customer Users currently in the system.

The field “Name” may display the Names of Customer Users currently in the system.

The field “Active” may display the status as Active or Inactive for the Customer Users currently in the system. If the user is an Active Customer User, the user may have access to the system. If the user is an Inactive Customer User, the user may not have access to the system.

The Manage column may allow the user to select “Edit Account” and “Edit Permissions”.

To Edit Customer Information, the user may select “Edit” from below the Customer Info section. The Edit Customer screen may display information, such as Customer Code and Name, and allow the user to edit them in to the system.

The field “Customer Code” may display the Customer Code for the customer that the user may have selected.

The user may select “Name” to edit the name of the customer. The Name may be any alphanumeric combination. The Name information may be required by the system. The user may select “Update” to record the changes to the system.

To create a New Customer User, the user may select “New User” from the Customer Info screen. The user may provide information, such as User ID, Password, First Name, Last Name, Active, Can View All Columns, Preferred Language, and Preferred Weight Units that may be entered into the system.

The user may select “User ID” and enter a User ID for the New Customer User to be added to the system. The User ID may be used by the Customer User to gain access to the system via the login screen. User IDs may be a unique combination of letters, and optionally, numbers. The User ID information may be required by the system.

The user may select “Password” and enter a Password for the New Customer User to be added to the system. The Password may be used by the Customer User to gain access to the system via the login screen. Passwords may be any alphanumeric combination that contains at least one numeric digit that is not the first or last character. No spaces or special characters may be allowed. Passwords do not have to be unique, but it is suggested that they are made to be as unique as possible and changed frequently. The Password information may be required by the system. The system may provide a unique and secure password for the user. However, the user creating the account may have the option to change it to something easier for the new User to memorize. It is strongly recommend that passwords be changed every thirty days.

The user may select “First Name” and enter the First Name of the New Customer User to be added to the system. The First Name information may be required by the system.

The user may select “Last Name” and enter the Last Name of the New Customer User to be added to the system. The Last Name information may be required by the user.

The user may select “Active” and indicate the status as “Active” or “Inactive” for the Customer User to be added to the system. If the user is an Active Customer User, the user may have access to the system. If the user is an Inactive Customer User, the user may not have access to the system.

The user may select “Can View All Columns” and indicate the status as “Can” or “Cannot” View All Columns for the Customer User to be added to the system. Customer Users that may view all columns may be able to view all information available in any of the reports available on the system. Customer Users that may not view all columns may be forced to select a Report Type when accessing Reports available on the system. The Customer User must have permission to a Report Type to be able to view a specified report.

The user may select “Preferred Language” and enter the preferred language for the Customer User.

The user may select “Preferred Linear Weights” and enter the preferred linear weights for the Customer User.

The user may select “Preferred Weight Units” and enter the preferred weight units for the Customer User.

The user may select “Add” to add the Customer User to the system.

To edit a Customer User account, the user may select “Edit Account” from the Customer Info screen in the Customer Users section. The Edit Account screen may display and allow the user to edit information, such as User ID, Password, First Name, Last Name, Active, Can View All Columns, Preferred Language, and Preferred Weight Units, for example.

For example, the field “User ID” may display the User ID for the Customer User being edited.

The user may select “Password” to edit the Password for the Customer User being edited. The Password may be used by the Customer User to gain access to the system via the login screen. The Password may be any alphanumeric combination that contains at least one numeric digit that is not the first or last character. No spaces or special characters may be allowed. Passwords do not have to be unique, but it is suggested that they are made to be as unique as possible and changed frequently. The Password information may be required by the system.

The system may provide a unique and secure password for the user. However, the User creating the account may have the option to change it to something easier for the new User to memorize. It is strongly recommend that passwords be changed every thirty days.

The user may select “First Name” to edit the First Name of the New Customer User to be added to the system. The First Name information may be required by the system.

The user may select “Last Name” to edit the Last Name of the New Customer User to be added to the system. The Last Name information may be required by the system.

The user may select “Active” to edit the Active or Inactive status of Customer User to be added to the system. If the user is an Active Customer User, the user may have access to the system. If the user is an Inactive Customer User, the user may not have access to the system.

The user may select “Can View All Columns” to edit the “Can” or “Cannot” View All Columns status of Customer User to be added to the system. Customer Users that may view all columns may be able to view all information available in any of the reports available on the system. Customer Users that may not view all columns may be forced to select a Report Type when accessing Reports available on the system. The Customer User must have permission to a Report Type to be able to view a specified report.

The user may select “Preferred Language” to edit the preferred language for the Customer User.

The user may select “Preferred Linear Weights” to edit the preferred linear weights for the Customer User.

The user may select “Preferred Weight Units” to edit the preferred weight units for the Customer User.

The user may select “Update” to record the changes to the Customer User account in to the system.

To edit the permission settings for a Customer User account, the user may select “Edit Permissions” from the Customer Info screen in the Customer Users section. The Edit Permissions screen may allow the user to edit permissions, such as Reports and Forms, in to the system.

The field “Reports” may allow the user to give Customer Users permissions to various Customized Reports. These reports may be created by processes under the Customize section of the Main Menu.

The user may select “Forms” to enter the Forms that the user would like the Customer User to have the ability to use.

The user may select “Update Permissions” to record the changes to the Customer User Account Permissions in to the system.

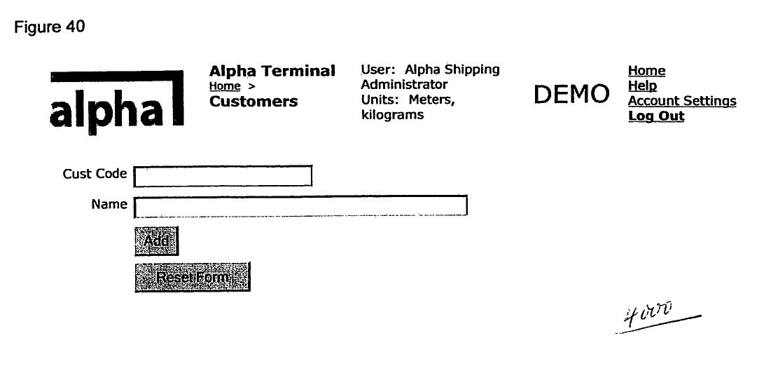

According to another aspect of the present invention, each user may be assigned a role, and each role may have associated therewith one or more permissions. Further, each user role may be further subdivided, as may be each permission. For example, a user may be an administrator, such as a user administrator, and may have a permission, such as the ability to manage internal user accounts. Such a user may engage in a task, such as entering the system via the general entry and reaching the “Internal User Accounts” request screen, as illustrated in FIG. 40. The Internal User Accounts Administration function may allow the user to add and edit Terminal Users.

To manage Internal User Accounts, the user may select “Internal User Accounts” from the Administration section of the Main Menu. This may bring the user to the Terminal User Admin screen. From this screen the user may have the ability to add a New Terminal User to the system, edit existing User Accounts, and edit existing User Permissions.

To create a New User, the user may select “New User” from the Terminal User Admin screen. The user may provide information, such as User ID, Password, First Name, Last Name, Active, Can Manage Report Definitions, Can Customize Forms, Can Manage Internal User Accounts, Can Manage Customer User Accounts, Can Manage Customers, Can View All Columns, Preferred Language, Preferred Linear Weights, and Preferred Weight Units, for example, that may be entered into the system.

The user may select “User ID” and enter a User ID for the New User to be added to the system. The User ID may be used by the User to gain access to the system via the login screen. User IDs may be a unique combination of letters, and optionally, numbers. The User ID information may be required by the system.

The user may select “Password” and enter a Password for the New User to be added to the system. The Password may be used by the User to gain access to the system via the login screen. Passwords may be any alphanumeric combination that contains at least one numeric digit that is not the first or last character. No spaces or special characters may be allowed. Passwords do not have to be unique, but it is suggested that they are made to be as unique as possible and changed frequently. The Password information may be required by the system. The system may provide a unique and secure password for the user. However, the user creating the account may have the option to change it to something easier for the new User to memorize. It is strongly recommend that passwords be changed every thirty days.

The user may select “First Name” and enter the First Name of the New User to be added to the system. The First Name information may be required by the system.

The user may select “Last Name” and enter the Last Name of the New User to be added to the system. The Last Name information may be required by the user.

The user may select “Active” and indicate the status as “Active” or “Inactive” for the User to be added to the system. If the user is an Active User, the user may have access to the system. If the user is an Inactive User, the user may not have access to the system.

The user may select “Can Manage Report Definitions” and enter the “Can” or “Cannot” Manage Report Definitions status of the User to be added to the system. Users that may manage report definitions may have the ability to create Customized Reports in the system. Users that may not manage report definitions may not have the ability to create Customized Reports in the system.

The user may select “Can Customize Forms” and enter the “Can” or “Cannot” Customize Forms status of the User to be added to the system. Users that may customize forms may have the ability to create Customized Forms in the system. Users that may not customize forms may not have the ability to create Customized Forms in the system.

The user may select “Can Manage Internal User Accounts” and enter the “Can” or “Cannot” Manage Internal User Accounts status of the User to be added to the system. Users that may manage Internal User Accounts may have the ability to add and edit User Accounts in the system. Users that may not manage Internal User Accounts may not have the ability to add and edit User Accounts in the system.

The user may select “Can Manage Customer User Accounts” and enter the “Can” or “Cannot” Manage Customer User Accounts status of the User to be added to the system. Users that may manage Customer User Accounts may have the ability to add and edit Customer User Accounts in the system. Users that may not manage Customer User Accounts may not have the ability to add and edit Customer User Accounts in the system.

The user may select “Can Manage Customers” and enter the “Can” or “Cannot” Manage Customers status of User to be added to the system. Users that may manage Customers may have the ability to add and edit Customer Accounts in the. Users that may not manage Customers may not have the ability to add and edit Customer Accounts in the system.

The user may select “Can View All Columns” and indicate the status as “Can” or “Cannot” View All Columns for the User to be added to the system. Users that may view all columns may be able to view all information available in any of the reports available on the system. Users that may not view all columns may be forced to select a Report Type when accessing Reports available on the system. The User must have permission to a Report Type to be able to view a specified report.

The user may select “Preferred Language” and enter the preferred language for the User.

The user may select “Preferred Linear Weights” and enter the preferred linear weights for the User.

The user may select “Preferred Weight Units” and enter the preferred weight units for the User.

The user may select “Add” to add the New User to the system.

To edit a Customer User account, the user may select “Edit Account” from the Terminal User Admin screen in the Customer Users section. The Edit Account screen may display and allow the user to edit information, such as User ID, Password, First Name, Last Name, Active, Can Manage Report Definitions, Can Customize Forms, Can Manage Internal User Accounts, Can Manage Customer User Accounts, Can Manage Customers, Can View All Columns, Preferred Language, Preferred Linear Weights, and Preferred Weight Units.

The field “User ID” may display the User ID for the User being edited.

The user may select “Password” to edit the Password for the User being edited. The Password may be used by the User to gain access to the system via the login screen. The Password may be any alphanumeric combination that contains at least one numeric digit that is not the first or last character. No spaces or special characters may be allowed. Passwords do not have to be unique, but it is suggested that they are made to be as unique as possible and changed frequently. The Password information may be required by the system. The system may provide a unique and secure password for the user. However, the User creating the account may have the option to change it to something easier for the new User to memorize. It is strongly recommended that passwords be changed every thirty days.

The user may select “First Name” to edit the First Name of the User to be added to the system. The First Name information may be required by the system.

The user may select “Last Name” to edit the Last Name of the User to be added to the system. The Last Name information may be required by the system.

The user may select “Active” to edit the Active or Inactive status of User to be added to the system. If the user is an Active User, the user may have access to the system. If the user is an Inactive User, the user may not have access to the system.

The user may select “Can Manage Report Definitions” and enter the “Can” or “Cannot” Manage Report Definitions status of User to be added to the system. Users that may manage report definitions may have the ability to create Customized Reports in the system. Users that may not manage report definitions may not have the ability to create Customized Reports in the system.

The user may select “Can Customize Forms” and enter the “Can” or “Cannot” Customize Forms status of User to be added to the system. Users that may customize forms may have the ability to create Customized Forms in the system. Users that may not customize forms may not have the ability to create Customized Forms in the system.

The user may select “Can Manage Internal User Accounts” and enter the “Can” or “Cannot” Manage Internal User Accounts status of the User to be added to the system. Users that may manage Internal User Accounts may have the ability to add and edit User Accounts in the system. Users that may not manage Internal User Accounts may not have the ability to add and edit User Accounts in the system.

The user may select “Can Manage Customer User Accounts” and enter the “Can” or “Cannot” Manage Customer User Accounts status of User to be added to the system. Users that may manage Customer User Accounts may have the ability to add and edit Customer User Accounts in the system. Users that may not manage Customer User Accounts may not have the ability to add and edit Customer User Accounts in the system.

The user may select “Can Manage Customers” and enter the “Can” or “Cannot” Manage Customers status of the User to be added to the system. Users that may manage Customers may have the ability to add and edit Customer Accounts in the. Users that may not manage Customers may not have the ability to add and edit Customer Accounts in the system.

The user may select “Can View All Columns” to edit the “Can” or “Cannot” View All Columns status of the User to be added to the system. Users that may view all columns may be able to view all information available in any of the reports available on the system. Users that may not view all columns may be forced to select a Report Type when accessing Reports available on the system. The User must have permission to a Report Type to be able to view a specified report.

The user may select “Preferred Language” to edit the preferred language for the User.

The user may select “Preferred Linear Weights” to edit the preferred linear weights for the User. The user may select “Preferred Weight Units” to edit the preferred weight units for the User.

The user may select “Update” to record the changes to the User account in to the system.

To edit the permission settings for a User account, the user may select “Edit Permissions” from the Terminal User Admin screen. The Edit Permissions screen may allow the user to edit permissions, such as Reports and Forms, in to the system.

The field “Reports” may allow the user to give Users permissions to various Customized Reports. These reports may be created by processes under the Customize section of the Main Menu.

The user may select “Forms” to enter the Forms that the user would like the User to have the ability to use.

The user may select “Update Permissions” to record the changes to the User Account Permissions in to the system.

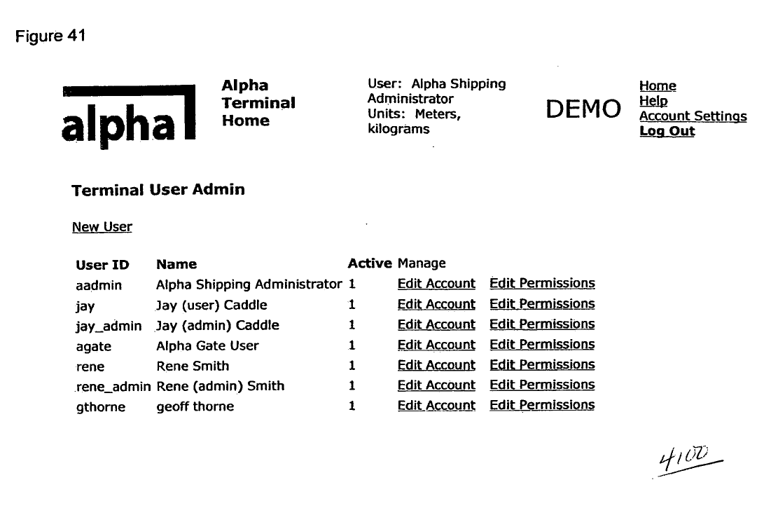

According to another aspect of the present invention, each user may be assigned a role, and each role may have associated therewith one or more permissions. Further, each user role may be further subdivided, as may be each permission. For example, a user may be an administrator, such as a user administrator, and may have a permission, such as the ability to manage customer user accounts. Such a user may engage in a task, such as entering the system via the general entry and reaching the “Customer User Accounts” request screen, as illustrated in FIG. 41. The Customer User Accounts Administration function may allow the user to add and edit Customers. Customers may be the Shipping Lines that use Terminal services. This area also may allow the user to add and edit Customer Users.

To select Customer User Accounts, the user may select “Customer User Accounts” from the Administration section of the Main Menu. From this screen the user may have the ability to add a New Customer to the system or view an existing Customer.

To add a New Customer to the system, the user may select “New Customer” and provide information, such as Customer Code and Name, to be added to the system.

The user may select “Customer Code” and enter a Customer Code for the customer that the user would like add to the system. Customer Codes must be a unique combination of letters, and optionally, numbers. The Customer Code information may be required by the system.

The user may select “Name” and enter the name of the customer that the user would like to add to the system. The Name may be any alphanumeric combination. The Name information may be required by the system.

The user may select “Add” to add the New Customer to the system.

The user may view a Customer through the Customer Info screen by selecting either “Customer Code” or “Customer Name”. The Customer Info screen may display information, such as Customer Code, Name, and Edit, that may be on the system.

The field “Customer Code” may display the Customer Code for the customer that the user may select.

The field “Name” may display the Customer Name for the customer that the user may have selected.

The user may select “Edit” to edit the Customer Information.

The Customer Users screen may display information, such as New User, User ID, Name, Active, and Manage, that may be on the system.

The user may select “New User” to create a new Customer User. A Customer User may be someone from the shipping line that needs access to the system to perform various functions.

The field “User ID” may display the User IDs of Customer Users currently in the system.

The field “Name” may display the Names of Customer Users currently in the system.

The field “Active” may display the status as Active or Inactive for the Customer Users currently in the system. If the user is an Active Customer User, the user may have access to the system. If the user is an Inactive Customer User, the user may not have access to the system.

The Manage column may allow the user to select “Edit Account” and “Edit Permissions”.

To Edit Customer Information, the user may select “Edit” from below the Customer Info section. The Edit Customer screen may display information, such as Customer Code and Name, and allow the user to edit them in to the system.

The field “Customer Code” may display the Customer Code for the customer that the user may have selected.

The user may select “Name” to edit the name of the customer. The Name may be any alphanumeric combination. The Name information may be required by the system. The user may select “Update” to record the changes to the system.

To create a New Customer User, the user may select “New User” from the Customer Info screen. The user may provide information, such as User ID, Password, First Name, Last Name, Active, Can View All Columns, Preferred Language, Preferred Linear Weights, and Preferred Weight Units that may be entered into the system.

The user may select “User ID” and enter a User ID for the New Customer User to be added to the system. The User ID may be used by the Customer User to gain access to the system via the login screen. User IDs may be a unique combination of letters, and optionally, numbers. The User ID information may be required by the system.

The user may select “Password” and enter a Password for the New Customer User to be added to the system. The Password may be used by the Customer User to gain access to the system via the login screen. Passwords may be any alphanumeric combination that contains at least one numeric digit that is not the first or last character. No spaces or special characters may be allowed. Passwords do not have to be unique, but it is suggested that they are made to be as unique as possible and changed frequently. The Password information may be required by the system. The system may provide a unique and secure password for the user. However, the user creating the account may have the option to change it to something easier for the new User to memorize. It is strongly recommend that passwords be changed every thirty days.

The user may select “First Name” and enter the First Name of the New Customer User to be added to the system. The First Name information may be required by the system.

The user may select “Last Name” and enter the Last Name of the New Customer User to be added to the system. The Last Name information may be required by the user.

The user may select “Active” and indicate the status as “Active” or “Inactive” for the Customer User to be added to the system. If the user is an Active Customer User, the user may have access to the system. If the user is an Inactive Customer User, the user may not have access to the system.

The user may select “Can View All Columns” and indicate the status as “Can” or “Cannot” View All Columns for the Customer User to be added to the system. Customer Users that may view all columns may be able to view all information available in any of the reports available on the system. Customer Users that may not view all columns may be forced to select a Report Type when accessing Reports available on the system. The Customer User must have permission to a Report Type to be able to view a specified report.

The user may select “Preferred Language” and enter the preferred language for the Customer User.

The user may select “Preferred Linear Weights” and enter the preferred linear weights for the Customer User.

The user may select “Preferred Weight Units” and enter the preferred weight units for the Customer User.

The user may select “Add” to add the Customer User to the system.

To edit a Customer User account, the user may select “Edit Account” from the Customer Info screen in the Customer Users section. The Edit Account screen may display and allow the user to edit information, such as User ID, Password, First Name, Last Name, Active, Can View All Columns, Preferred Language, and Preferred Weight Units.

The field “User ID” may display the User ID for the Customer User being edited.

The user may select “Password” to edit the Password for the Customer User being edited. The Password may be used by the Customer User to gain access to the system via the login screen. The Password may be any alphanumeric combination that contains at least one numeric digit that is not the first or last character. No spaces or special characters may be allowed. Passwords do not have to be unique, but it is suggested that they are made to be as unique as possible and changed frequently. The Password information may be required by the system.

The system may provide a unique and secure password for the user. However, the User creating the account may have the option to change it to something easier for the new User to memorize. It is strongly recommended that passwords be changed every thirty days.

The user may select “First Name” to edit the First Name of the New Customer User to be added to the system. The First Name information may be required by the system.

The user may select “Last Name” to edit the Last Name of the New Customer User to be added to the system. The Last Name information may be required by the system.

The user may select “Active” to edit the Active or Inactive status of Customer User to be added to the system. If the user is an Active Customer User, the user may have access to the system. If the user is an Inactive Customer User, the user may not have access to the system.

The user may select “Can View All Columns” to edit the “Can” or “Cannot” View All Columns status of Customer User to be added to the system. Customer Users that may view all columns may be able to view all information available in any of the reports available on the system. Customer Users that may not view all columns may be forced to select a Report Type when accessing Reports available on the system. The Customer User must have permission to a Report Type to be able to view a specified report.

The user may select “Preferred Language” to edit the preferred language for the Customer User.

The user may select “Preferred Linear Weights” to edit the preferred linear weights for the Customer User.

The user may select “Preferred Weight Units” to edit the preferred weight units for the Customer User.

The user may select “Update” to record the changes to the Customer User account in to the system.

To edit the permission settings for a Customer User account, the user may select “Edit Permissions” from the Customer Info screen in the Customer Users section. The Edit Permissions screen may allow the user to edit permissions, such as Reports and Forms, in to the system.

The field “Reports” may allow the user to give Customer Users permissions to various Customized Reports. These reports may be created by processes under the Customize section of the Main Menu.

The user may select “Forms” to enter the Forms that the user would like the Customer User to have the ability to use.

The user may select “Update Permissions” to record the changes to the Customer User Account Permissions in to the system.

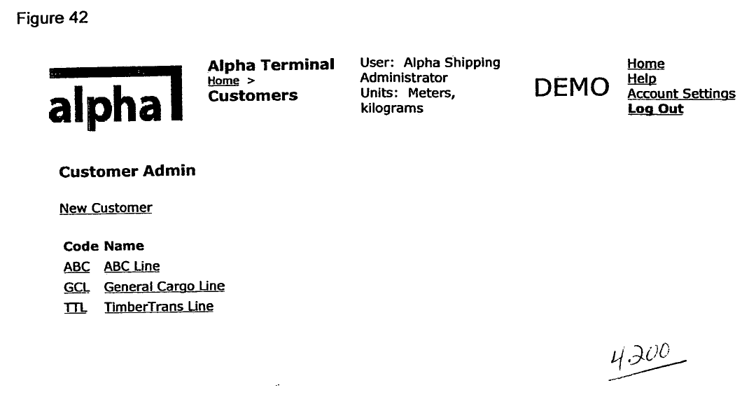

According to another aspect of the present invention, each user may be assigned a role, and each role may or may not have associated therewith one or more permissions. For example, a user may be an administrator, and may not be required to have a permission. Such a user may engage in a task, such as entering the system via the general entry and reaching the “Cargo Report Fields” request screen, as illustrated in FIG. 42. The Customize Cargo Report Fields, New Report Definition function may be used to add customized search results templates to the system.

To Customize Cargo Fields, the user may select “Cargo Report Fields” from the Administration-Customize Fields section of the Main Menu. The user may select “New Report Definition” and further select “Report Name” where the user may enter a name for the report.

The user may then select “Edit Cargo” from the “Edit Form” drop-down menu. To select the Column Headers that the user would like to appear in the customized Report, the user may place the mouse over the Column Heading the user may want to select. Next, the user may hold down the left-click button and drag the Column Heading from the left side of the page, with the light gray background, to the right side of the page, with the dark gray background. The user may then release the mouse button. The Column Heading may now appear in the right column, indicating that it has been selected to be included on the customized Report. The user may repeat this process until the user has all the Column Headings the user would like to appear on the customized Report.

The user may reorder the Column Headings in any way the user may like. To reorder the list, the user may place the mouse over the Column Heading the user would like to reorder. Next, the user may hold down the left-click button and drag the Column Heading up or down in the list as the user desires. The user must then release the mouse button when the Column Heading is in the correct order. The user may repeat this process until the user has all the Column Headings in the order the user would like them to appear on the customized Report. Column Headings listed from Top to Bottom may be listed from Left to Right on the Report.

The user may select “Create Report” to add the customized Report to the system.

Further, the Customize Cargo Report Fields, Edit/Delete Report Definition function may be used to edit or delete customized search results templates in the system.

To Customize Cargo Fields, the user may select “Cargo Report Fields” from the Administration-Customize Fields section of the Main Menu.

The user may select and edit a Report Definition by selecting the name of the Report from the Name column on the Report Admin Page. The user may edit the name for the report by selecting “Report Name” where the user may enter a name for the report.

The “Edit Form” drop-down menu may be set to Edit Cargo. The user may edit the Column Headings and their Order by dragging the Column Headings into the configuration the user may desire. The Column Headings that appear in the right column, which may have a dark gray background, indicate that they are selected to be included on the customized Report. The Column Headings that may appear in the left column, which may have a light gray background, indicate that they may be available to be included on the customized Report. Column Headings listed from Top to Bottom may be listed from Left to Right on the Report.

To drag a Column Heading, the user may place the mouse over the Column Heading the user may want to move. The user may then hold down the left-click button and drag the Column Heading to its desired location (left to deselect the Column Heading, right to select the Column Heading, up or down in the right column to order the Column Heading). The user may release the mouse button once the Column Heading is in the desired location. This process may be repeated by the user until all the Column Headings the user would like to appear on the customized Report may be in the right column and ordered correctly.

The user may select “Update Report” to update the customized Report in the system. To delete the report from the system, the user may select “Delete Report”.

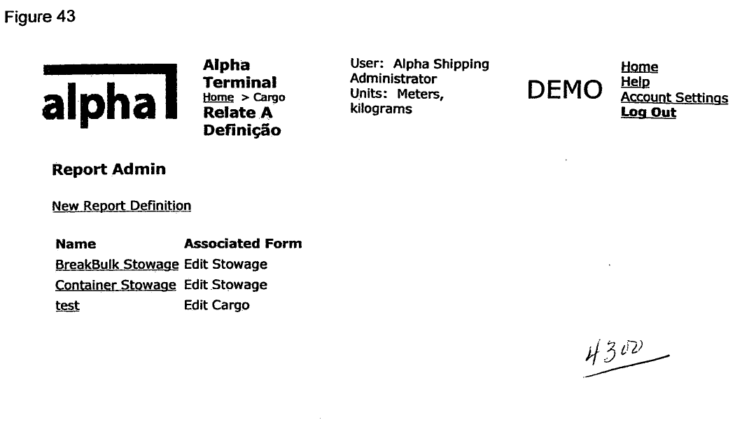

According to another aspect of the present invention, each user may be assigned a role, and each role may or may not have associated therewith one or more permissions. For example, a user may be an administrator, and may not be required to have a permission. Such a user may engage in a task, such as entering the system via the general entry and reaching the “Cargo Form Fields” request screen, as illustrated in FIG. 43. The Customize Cargo Form Fields function may be used to select the Cargo form fields that the Terminal will use to track Cargo attributes.

The user may select “Cargo Form Fields” from the Administration-Customize Fields section of the Main Menu. The user may then select the form fields that the Terminal would like to use to track Cargo attributes. The user may then select “Update Customization” to record the changes to the system.

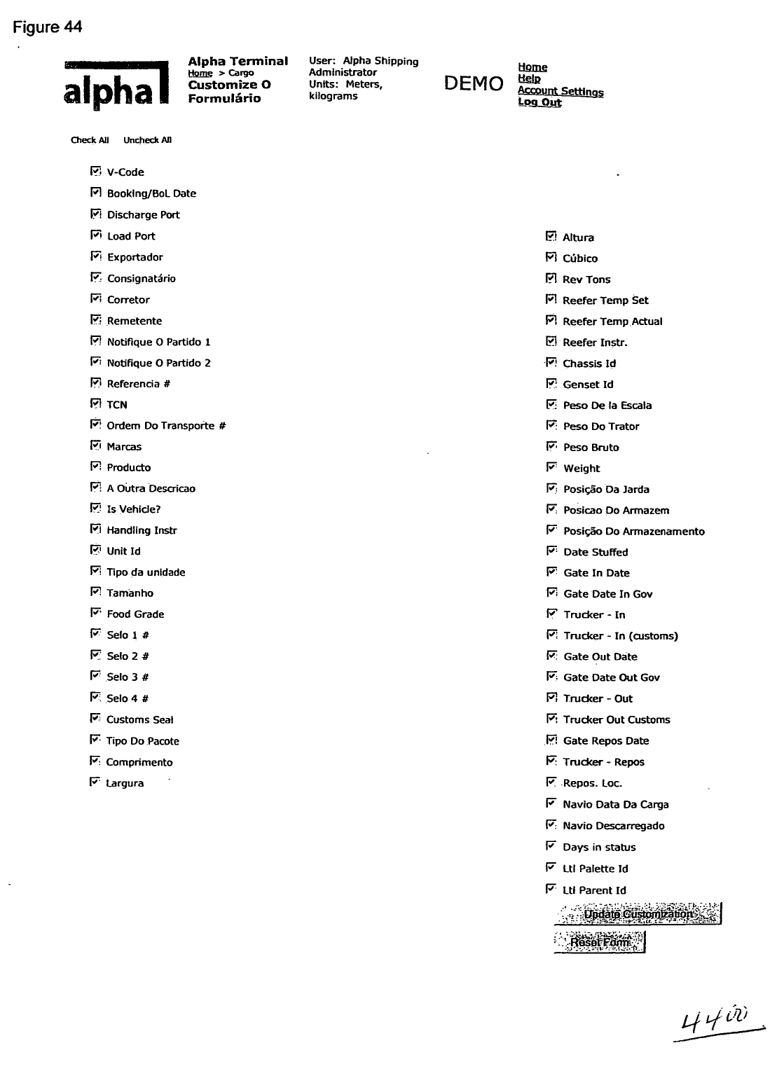

According to another aspect of the present invention, each user may be assigned a role, and each role may or may not have associated therewith one or more permissions. For example, a user may be an administrator, and may not be required to have a permission. Such a user may engage in a task, such as entering the system via the general entry and reaching the “Container Report Fields” request screen, as illustrated in FIG. 44. The Customize Container Report Fields, New Report Definition function may be used to add customized search results templates to the system.

To Customize Container Fields, the user may select “Container Report Fields” from the Administration-Customize Fields section of the Main Menu.

The user may select “New Report Definition” and further select “Report Name” where the user may enter a name for the report.

To select the Column Headers that the user would like to appear in the customized Report, the user may place the mouse over the Column Heading the user may want to select. Next, the user may hold down the left-click button and drag the Column Heading from the left side of the page, with the light gray background, to the right side of the page, with the dark gray background. The user may then release the mouse button. The Column Heading may now appear in the right column, indicating that it has been selected to be included on the customized Report. The user may repeat this process until the user has all the Column Headings the user would like to appear on the customized Report.

The user may reorder the Column Headings in any way the user may like. To reorder the list, the user may place the mouse over the Column Heading the user would like to reorder. Next, the user may hold down the left-click button and drag the Column Heading up or down in the list as the user desires. The user must then release the mouse button when the Column Heading is in the correct order. The user may repeat this process until the user has all the Column Headings in the order the user would like them to appear on the customized Report. Column Headings listed from Top to Bottom may be listed from Left to Right on the Report. The user may select “Create Report” to add the customized Report to the system.

Further, to Customize Container Fields, the user may select “Container Report Fields” from the Administration-Customize Fields section of the Main Menu.

The user may select and edit a Report Definition by selecting the name of the Report from the Name column on the Report Admin Page. The user may edit the name for the report by selecting “Report Name” where the user may enter a name for the report.

The user may edit the Column Headings and their Order by dragging the Column Headings into the configuration the user may desire. The Column Headings that appear in the right column, which may have a dark gray background, indicate that they are selected to be included on the customized Report. The Column Headings that may appear in the left column, which may have a light gray background, indicate that they may be available to be included on the customized Report. Column Headings listed from Top to Bottom may be listed from Left to Right on the Report.

To drag a Column Heading, the user may place the mouse over the Column Heading the user may want to move. The user may then hold down the left-click button and drag the Column Heading to its desired location (left to deselect the Column Heading, right to select the Column Heading, up or down in the right column to order the Column Heading). The user may release the mouse button once the Column Heading is in the desired location. This process may be repeated by the user until all the Column Headings the user would like to appear on the customized Report may be in the right column and ordered correctly.

The user may select “Update Report” to update the customized Report in the system. To delete the report from the system, the user may select “Delete Report”.

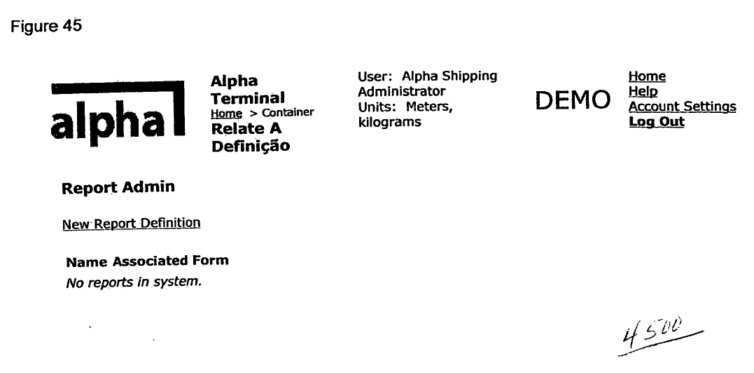

According to another aspect of the present invention, each user may be assigned a role, and each role may or may not have associated therewith one or more permissions. For example, a user may be an administrator, and may not be required to have a permission. Such a user may engage in a task, such as entering the system via the general entry and reaching the “Chassis Report Fields” request screen, as illustrated in FIG. 45. The Customize Chassis Report Fields, New Report Definition function may be used to add customized search results templates to the system.

To Customize Chassis Fields, the user may select “Chassis Report Fields” from the Administration-Customize Fields section of the Main Menu.

The user may select “New Report Definition” and further select “Report Name” where the user may enter a name for the report.

To select the Column Headers that the user would like to appear in the customized Report, the user may place the mouse over the Column Heading the user may want to select. Next, the user may hold down the left-click button and drag the Column Heading from the left side of the page, with the light gray background, to the right side of the page, with the dark gray background. The user may then release the mouse button. The Column Heading may now appear in the right column, indicating that it has been selected to be included on the customized Report. The user may repeat this process until the user has all the Column Headings the user would like to appear on the customized Report.

The user may reorder the Column Headings in any way the user may like. To reorder the list, the user may place the mouse over the Column Heading the user would like to reorder. Next, the user may hold down the left-click button and drag the Column Heading up or down in the list as the user desires. The user must then release the mouse button when the Column Heading is in the correct order. The user may repeat this process until the user has all the Column Headings in the order the user would like them to appear on the customized Report. Column Headings listed from Top to Bottom may be listed from Left to Right on the Report.

The user may select “Create Report” to add the customized Report to the system.

Further, to Customize Chassis Fields, the user may select “Chassis Report Fields” from the Administration-Customize Fields section of the Main Menu.

The user may select and edit a Report Definition by selecting the name of the Report from the Name column on the Report Admin Page. The user may edit the name for the report by selecting “Report Name” where the user may enter a name for the report.

The user may edit the Column Headings and their Order by dragging the Column Headings into the configuration the user may desire. The Column Headings that appear in the right column, which may have a dark gray background, indicate that they are selected to be included on the customized Report. The Column Headings that may appear in the left column, which may have a light gray background, indicate that they may be available to be included on the customized Report. Column Headings listed from Top to Bottom may be listed from Left to Right on the Report.

To drag a Column Heading, the user may place the mouse over the Column Heading the user may want to move. The user may then hold down the left-click button and drag the Column Heading to its desired location (left to deselect the Column Heading, right to select the Column Heading, up or down in the right column to order the Column Heading). The user may release the mouse button once the Column Heading is in the desired location. This process may be repeated by the user until all the Column Headings the user would like to appear on the customized Report may be in the right column and ordered correctly.

The user may select “Update Report” to update the customized Report in the system. To delete the report from the system, the user may select “Delete Report”.

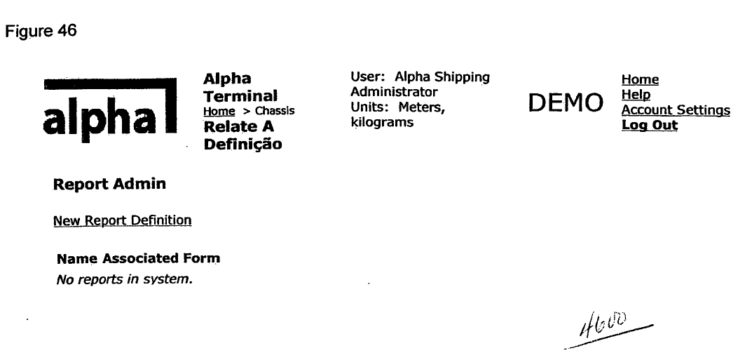

According to another aspect of the present invention, a user may be assigned a role, such as an administrator, and such a user may engage in a task, such as entering the system via the general entry and reaching the “Gate Report Fields” request screen, as illustrated in FIG. 46. To Customize Gate Fields, the user may select “Gate Report Fields” from the Administration-Customize Fields section of the Main Menu.

The user may select “New Report Definition” and further select “Report Name” where the user may enter a name for the report.

To select the Column Headers that the user would like to appear in the customized Report, the user may place the mouse over the Column Heading the user may want to select. Next, the user may hold down the left-click button and drag the Column Heading from the left side of the page, with the light gray background, to the right side of the page, with the dark gray background. The user may then release the mouse button. The Column Heading may now appear in the right column, indicating that it has been selected to be included on the customized Report. The user may repeat this process until the user has all the Column Headings the user would like to appear on the customized Report.

The user may reorder the Column Headings in any way the user may like. To reorder the list, the user may place the mouse over the Column Heading the user would like to reorder. Next, the user may hold down the left-click button and drag the Column Heading up or down in the list as the user desires. The user must then release the mouse button when the Column Heading is in the correct order. The user may repeat this process until the user has all the Column Headings in the order the user would like them to appear on the customized Report. Column Headings listed from Top to Bottom may be listed from Left to Right on the Report.

The user may select “Create Report” to add the customized Report to the system.

Further, to Customize Gate Fields, the user may select “Gate Report Fields” from the Administration-Customize Fields section of the Main Menu.

The user may select and edit a Report Definition by selecting the name of the Report from the Name column on the Report Admin Page. The user may edit the name for the report by selecting “Report Name” where the user may enter a name for the report.

The user may edit the Column Headings and their Order by dragging the Column Headings into the configuration the user may desire. The Column Headings that appear in the right column, which may have a dark gray background, indicate that they are selected to be included on the customized Report. The Column Headings that may appear in the left column, which may have a light gray background, indicate that they may be available to be included on the customized Report. Column Headings listed from Top to Bottom may be listed from Left to Right on the Report.

To drag a Column Heading, the user may place the mouse over the Column Heading the user may want to move. The user may then hold down the left-click button and drag the Column Heading to its desired location (left to deselect the Column Heading, right to select the Column Heading, up or down in the right column to order the Column Heading). The user may release the mouse button once the Column Heading is in the desired location. This process may be repeated by the user until all the Column Headings the user would like to appear on the customized Report may be in the right column and ordered correctly.

The user may select “Update Report” to update the customized Report in the system. To delete the report from the system, the user may select “Delete Report”.

According to another aspect of the present invention, the system may include a maintenance and repair system. Such a system may include features such as record keeping, categorization of damage, assignment, and the like.

For example, when a cargo item or container enters the system and given a unique identifier, an initial review of the item may made and a record created noting any preexisting damage to the item. This record will be linked to the item's unique identifier, and thus may be accessible by any user as needed. The maintenance and repair record may be continuously accessed and updated or edited in real-time, allowing the record to highlight where damage may occur at any point throughout the shipping system, including exiting status.

In another example, the cargo item or container may, after assessment by a user, be assigned or tagged to a certain status, such as “out of service”, “hold”, “send to repair”, “in progress”, and the like. Such assignments allow a user and laborers in the shipping system to alter or change the course of flow for that particular item until the deterring issue is resolved. Additionally, when a mechanic may be handling a cargo item or container, the mechanic may assign the item to another mechanic, as well as assign any needed repair according to time, status and/or cost. The system may also allow for time and cost estimates to be made, which may further provide administrators or other managerial personnel the ability to verify those estimates with clientele or other applicable sources. Determination of applicable time and cost functions will be apparent to those skilled in the pertinent arts.

In yet another example, categorization of damage to a cargo item may be quantified via a predetermined grading system, such as by color or numerical damage level. Such a grading system may allow a user to select a damage category in the creation or updating of the maintenance and repair record for a particular item. Additionally, a user may customize or create specific notations of particular damage to an item, in the event that the applicable grading system does not provide sufficient detail or such notation might be considered beneficial.

It an exemplary embodiment of the present invention, real-time access and updating to the maintenance and repair reports may allow a mobile or roving supply truck to be alerted and called for spot maintenance and repair work, or allow maintenance and repair sights to request more labor or supplies, according to their current usage. The present invention may also provide a link between existing inventory systems directly with maintenance and repair reports, which may allow users to be alerted in real-time whether current inventory can handle the requirements for any maintenance and repair request or assignment. Additionally, this would allow a user, mechanic or other administrator to accept or veto repairs, either in whole or any part thereof.

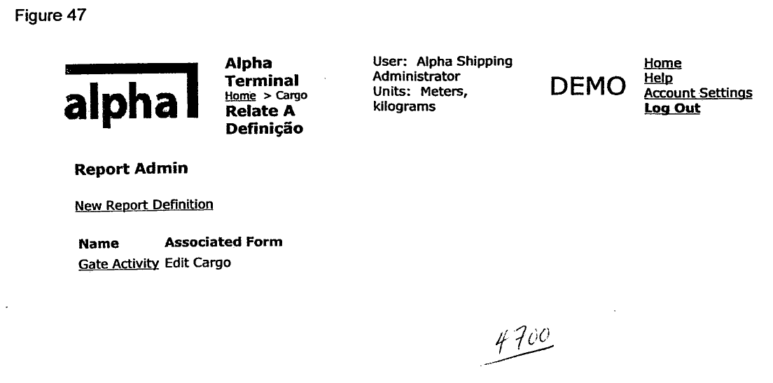

According to another aspect of the present invention, a user may be assigned a role, such as an administrator, and such a user may engage in a task, such as entering the system via the general entry and reaching the “View Pending” request screen, as illustrated in FIG. 47.

To view pending equipment, the user may select “View Pending” from the Repair (M&R) section of the Main Menu.

The system may display information, such as Unit ID, Type, Owner, Damage Level, and Damage/Notes, related to the pending equipment.

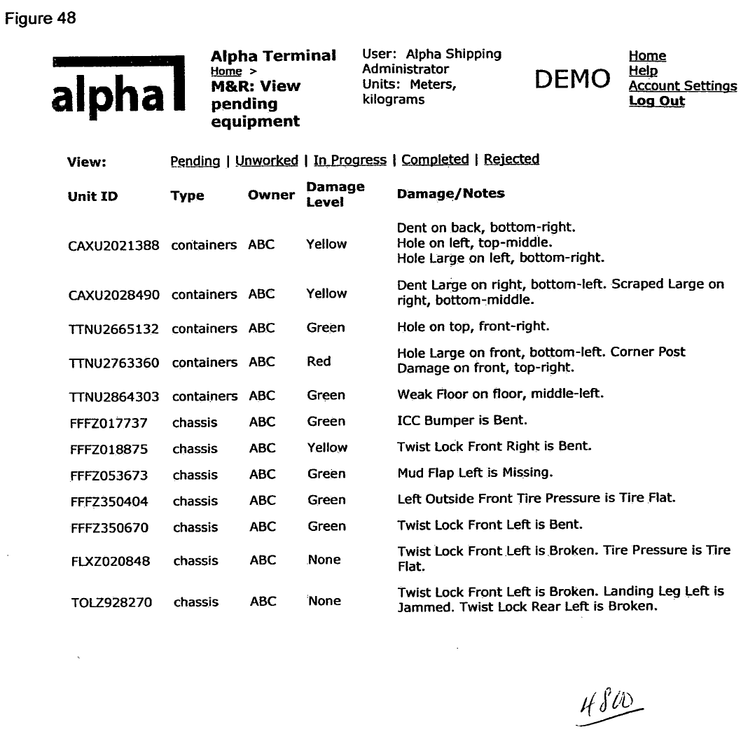

According to another aspect of the present invention, a user may be assigned a role, such as an administrator, and such a user may engage in a task, such as entering the system via the general entry and reaching the “View Unworked” request screen, as illustrated in FIG. 48.

To view unworked equipment, the user may select “View Unworked” from the Repair (M&R) section of the Main Menu.

The system may display information, such as Dates, M&R ID, Unit ID, Type, Owner, Damage Level, Damage/Notes, Opened, Opened By, and Assigned To, related to the unworked equipment.

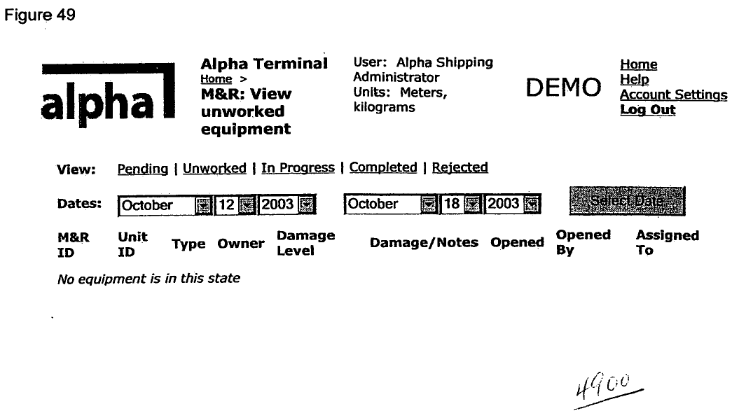

According to another aspect of the present invention, a user may be assigned a role, such as an administrator, and such a user may engage in a task, such as entering the system via the general entry and reaching the “View Worked” request screen, as illustrated in FIG. 49.

To view Worked equipment, the user may select “View Worked” from the Repair (M&R) section of the Main Menu.

The system may display information, such as Dates, M&R ID, Unit ID, Type, Owner, Damage Level, Damage/Notes, Opened, Opened By, and Assigned To, related to the worked equipment.

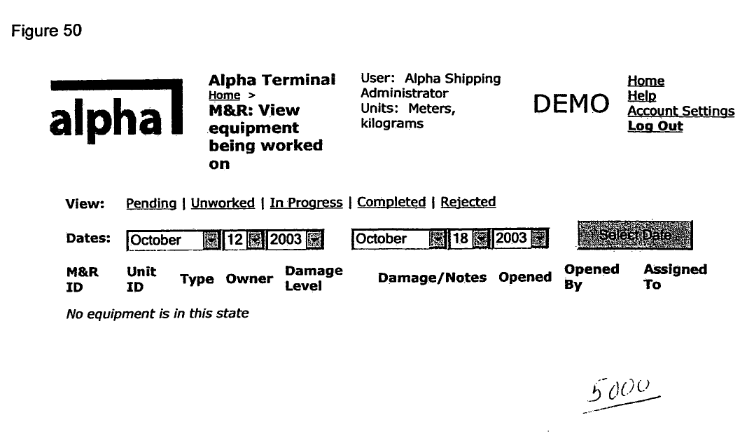

According to another aspect of the present invention, a user may be assigned a role, such as an administrator, and such a user may engage in a task, such as entering the system via the general entry and reaching the “View Completed” request screen, as illustrated in FIG. 50.

To view Completed equipment, the user may select “View Completed” from the Repair (M&R) section of the Main Menu.

The system may display information, such as Dates, M&R ID, Unit ID, Type, Owner, Damage Level, Damage/Notes, Opened, Opened By, and Assigned To, related to the completed equipment.

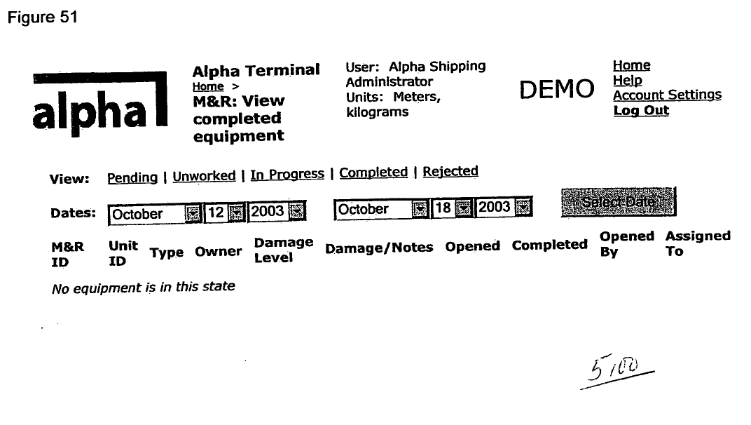

According to another aspect of the present invention, a user may be assigned a role, such as an administrator, and such a user may engage in a task, such as entering the system via the general entry and reaching the “View Rejected” request screen, as illustrated in FIG. 51.

To view rejected equipment, the user may select “View rejected” from the Repair (M&R) section of the Main Menu.

The system may display information, such as Dates, M&R ID, Unit ID, Type, Owner, Damage Level, Damage/Notes, Rejected, and Rejected By, related to the rejected equipment.

While a user may be viewing equipment in maintenance and repair, the user may review repair definitions that may be used or found in M&R reports.

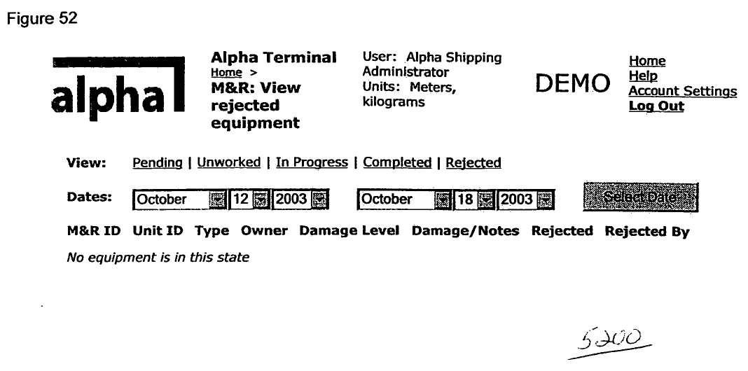

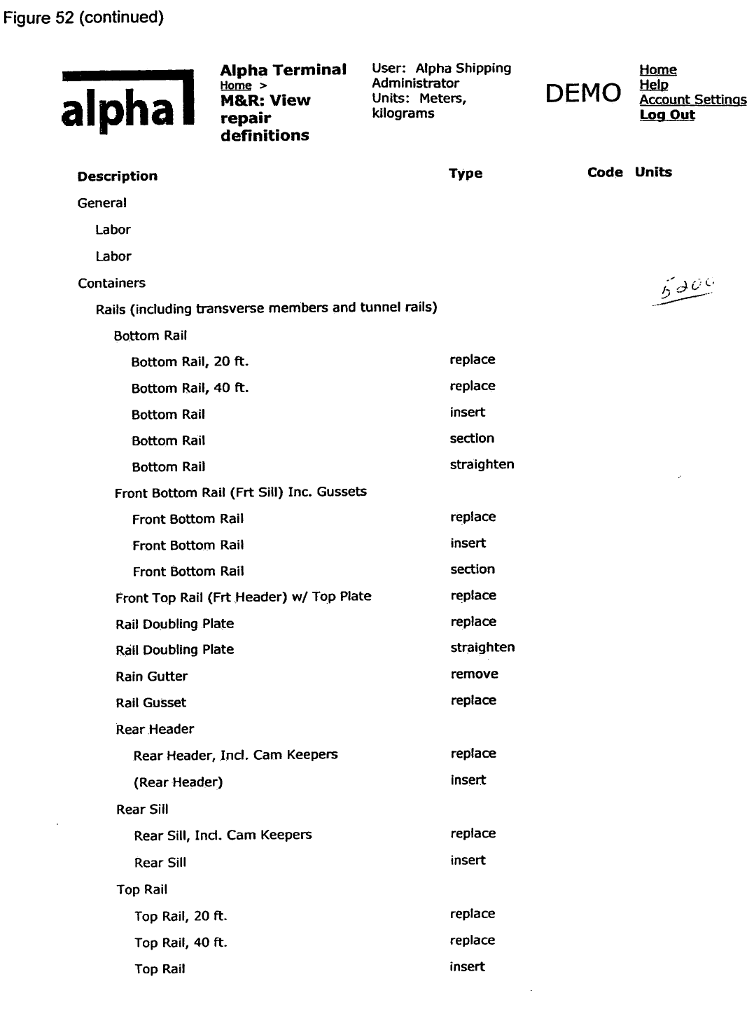

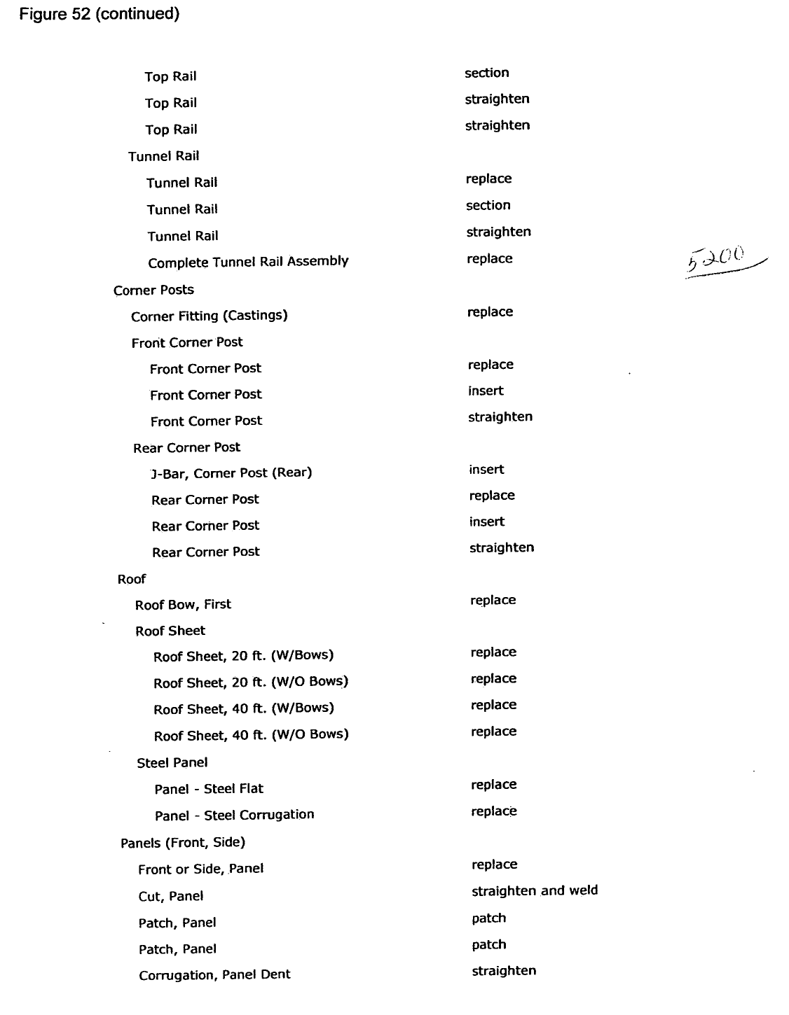

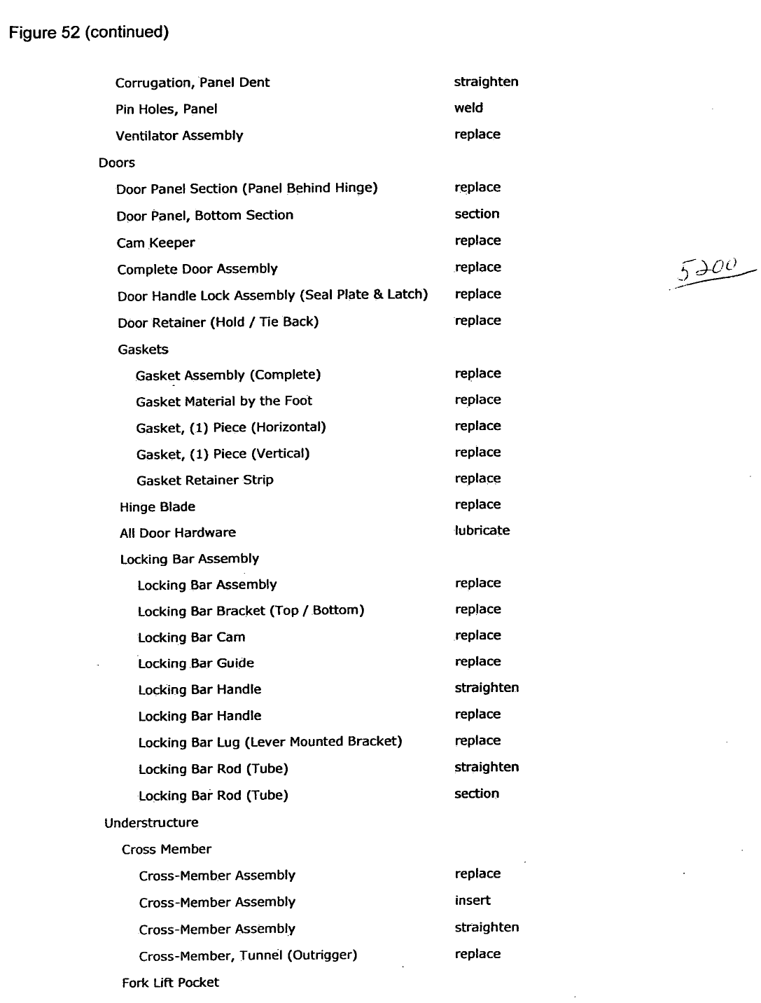

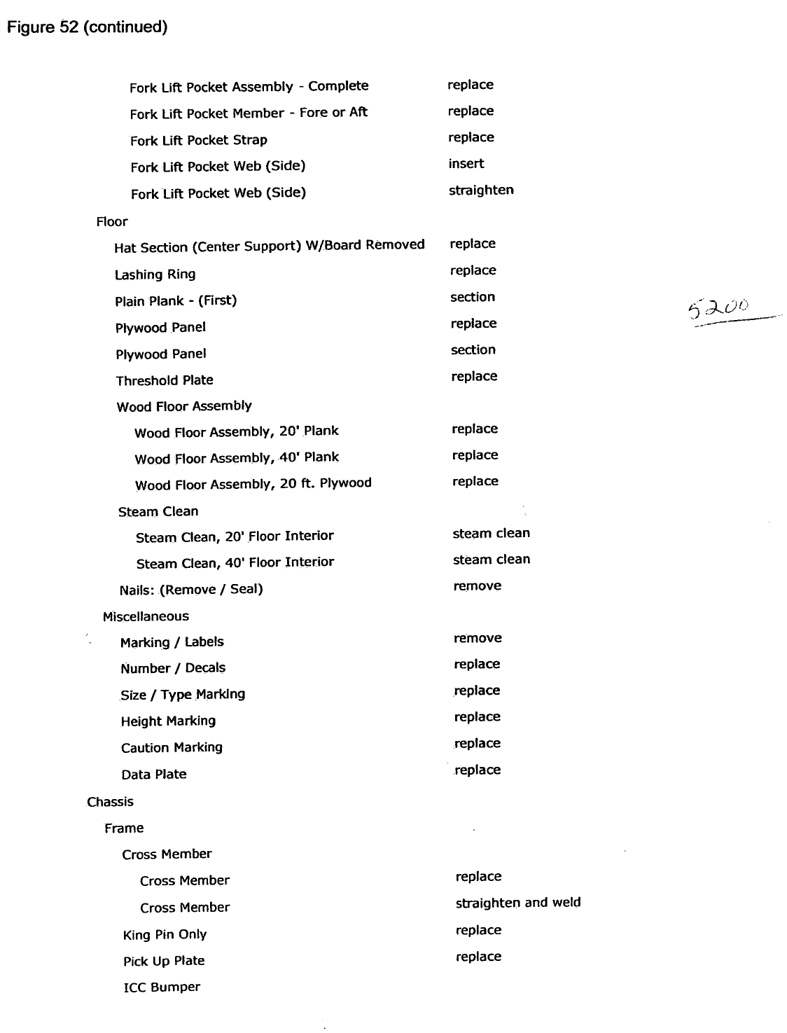

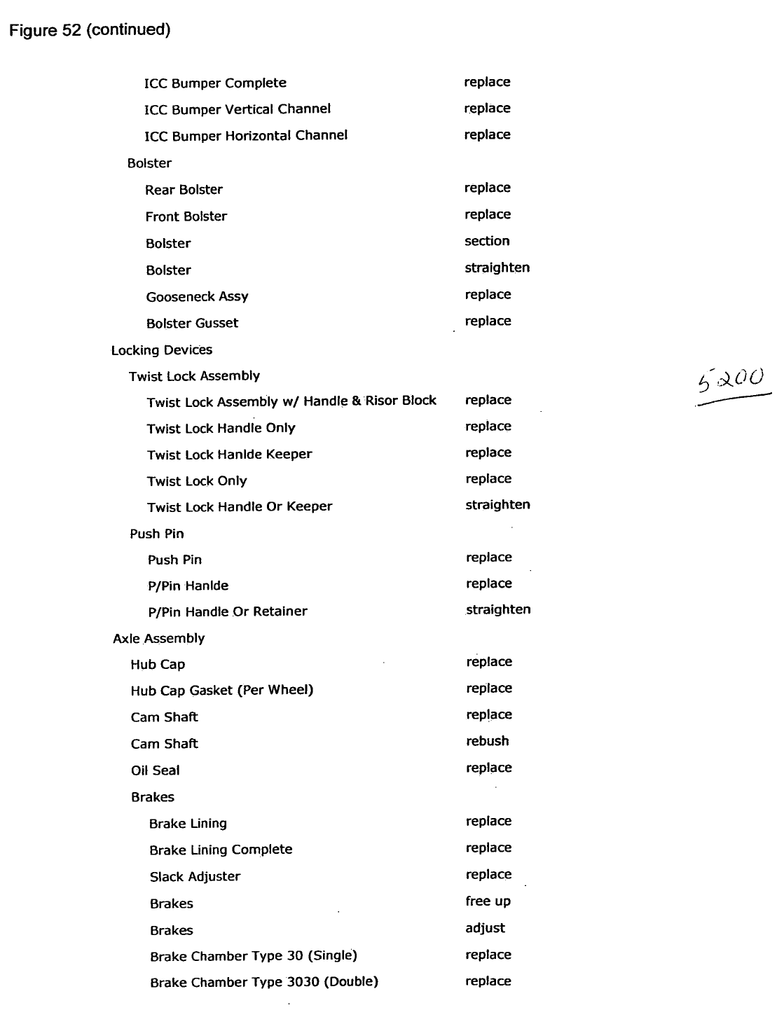

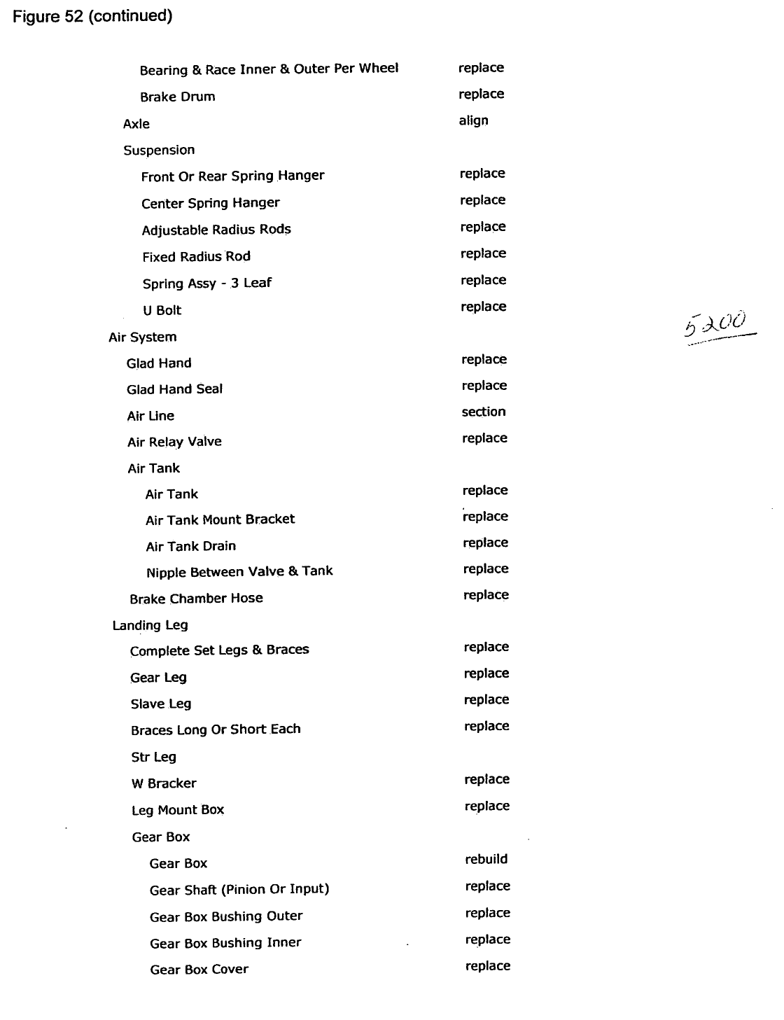

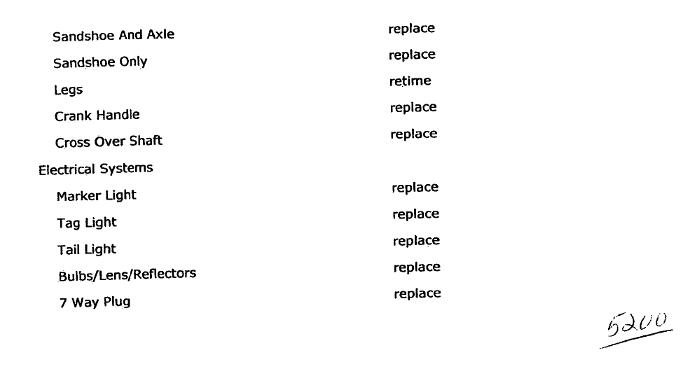

To reach the View Repair Definitions screen, as illustrated in FIG. 52, the user may select “View Repair Definitions” from the Repair (M&R) section of the Main Menu. The Repair Definitions screen may define terminology utilized in the M&R reports in the system.

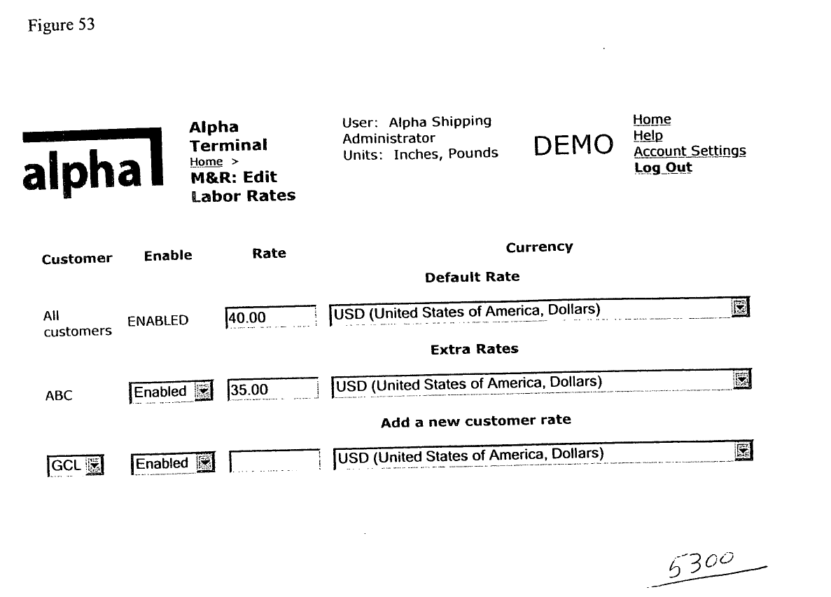

In another embodiment of the present invention, a user may be assigned a role, such as a M&R administrator, and may further be required to have a permission, such as a M&R Rates Definition permission. The user may engage in a task, such as entering the system via the general entry and reaching the “Edit Rates” request screen, as illustrated on FIG. 53. The Edit Rates function may be used to update the invoicing system, which may keep track of various information, such as repairs, users, and billable hours per repair, for example, in a flexible and concise manner.

To set up the Rates, a user may select “M&R Edit Rates” from the Main Menu. This may allow the terminal to select the currency and amount to charge per hour on a per client basis. For example, a terminal may charge ABC line 120 French Francs per hour of labor, while charging another line $50 U.S. Dollars.

The user may also place other users pertinent to M&R into the “M&R Users” permission group. Such a designation of other users may allow those users with new permissions to be available for performing M&R work as well as assigning equipment to them as it might come into the repair yard.

The user may also Review the hourly rate charges listed by selecting “Edit Repair Definitions” from the Main Menu screen. This may display a hierarchical list of all possible repairs with their associated units and hour amount.

Each repair may be defined in three modes: Simple, which may list a repair with a specified number of hours; Double, which may list the first several units at a first determined rate, and each additional unit thereafter may be at a second determined rate; and Complex, which may allow for an unlimited number of unit and hour combinations. With each repair, hours may range from zero, and up to, but not including, 14 months in length.

In another embodiment, the user may perform M&R tasks with a handheld computing device. When the user is using a handheld, hourly charges may be computed automatically. To do this a user may be required to have a “M&R View” permission. A permitted user may then select “View Completed” from the Main Menu screen, and further select “Printable”. This may make an invoice available to the user.

It will be apparent to those skilled in the art that various modifications and variations may be made in the system and method of the present invention without departing from the spirit or scope of the invention. Thus, it is intended that the present invention cover the modification and variations of this invention provided they come within the scope of the appended claims and the equivalents thereof.

1. A system of tracking a flow of goods through commerce, comprising:
a computer software associated with a computer-readable medium that provides a graphical user interface;
at least one database, wherein at least one information item associated with at least one of said goods is relationally present in said at least one database; and
at least one computerized device capable of entering and accessing the at least one information item in said at least one database via the graphical user interface over a communicatively connected network in real time, wherein the communicative connected network comprises at least one wireless connection.

2. The system of claim 1, wherein said at least one database is tabular.

3. The system of claim 1, wherein a type of said at least one computerized device is selected from the group consisting of a desktop, laptop, notebook, tablet, handheld, and phone.

4. The system of claim 3, wherein said computer software modifies the graphical user interface in accordance with the type of said computerized device.

5. The system of claim 4, wherein said computerized device is capable of communicative connection to said network wirelessly.

6. The system of claim 1, further comprising a point of import wherein said goods enter into said system at said point of import to be accessed by said at least one computerized device.

7. The system of claim 6, further comprising a point of export wherefrom said goods exit said system from said point of export for transport to one of said points of import.

8. The system of claim 1, wherein said at least one information item includes at least one unique identification code.

9. The system of claim 1, wherein said at least one information item has associated with it at least one report accessible from said at least one database via said computer software.

10. The system of claim 9, wherein said at least one report is uploaded through said computer software.

11. The system of claim 9, wherein said report includes at least one unique identification code associated with one of said goods.

12. The system of claim 8, wherein said identification code includes an E-Code.

13. The system of claim 11, wherein said at least one report is searchable in said at least one database at least by said at least one unique identification code.

14. The system of claim 9, wherein said at least one report is printable from said at least one device to a printer communicatively connected to said network.

15. The system of claim 8, wherein said at least one information item relates to said goods.

16. The system of claim 15, wherein said at least one information item relates to equipment associated with said goods.

17. The system of claim 1, wherein said at least one information item relates to a user of said system.

18. The system of claim 1, wherein said at least one information item relates to a customer of said system.

19. The system of claim 1, wherein said at least one information item relates to a transportation vehicle of said goods in said system.

20. The system of claim 1, wherein a user of said system requires a unique identifier and permission password to utilize said computer software.

21. The system of claim 1, wherein said at least one information item is edited by a user of said computer software via said at least one device.

22. A method of managing a goods tracking system, comprising:
providing a graphical user interface via a computer software associated with a computer-readable medium;
associating at least one database with the graphical user interface, wherein at least one information item associated with at least one of said goods is relationally present in said at least one database; and
communicatively connecting, in real time and via a network comprising at least one wireless connection, at least one computerized device capable of entering and accessing the at least one information item in said at least one database to the graphical user interface.

23. The method of claim 22, wherein said at least one database is tabular.

24. The method of claim 22, wherein a type of said at least one computerized device is selected from the group consisting of a desktop, laptop, notebook, tablet, handheld, and phone.

25. The method of claim 24, further comprising modifying, via the computer software, the graphical user interface in accordance with the type of said computerized device.

26. The method of claim 25, wherein said computerized device is capable of communicative connection to said network wirelessly.

27. The method of claim 22, further comprising importing to the system via a point of import, wherein said goods enter into said system at said point of import to be accessed by said at least one computerized device.

28. The method of claim 27, further comprising exporting via a point of export, wherefrom said goods exit said system from said point of export for transport to one of said points of import.

29. The method of claim 22, wherein said at least one information item includes at least one unique identification code.

30. The method of claim 22, wherein said at least one information item has associated with it at least one report accessible from said at least one database via said computer software.

31. The method of claim 30, further comprising uploading said at least one report through said computer software.

32. The method of claim 30, wherein said report includes at least one unique identification code associated with one of said goods.

33. The method of claim 29, wherein said identification code includes an E-Code.

34. The method of claim 32, wherein said at least one report is searchable in said at least one database at least by said at least one unique identification code.

35. The method of claim 30, wherein said at least one report is printable from said at least one device to a printer communicatively connected to said network.
